(19) United States
(12) Patent Application Publication
(10) Pub. No.: US 2005/0176270 A1
(43) Pub. Date: Aug. 11, 2005

(54) Methods and structures for the production of electrically treated items and electrical connections

(76) Inventor: Daniel Luch, Morgan Hill, CA (US)

Correspondence Address: Daniel Luch, 17161 Copper Hill Drive, Morgan Hill, CA, 95037, US

(21) Appl. No.: 10/776,359

(22) Filed: Feb. 11, 2004

(51) Int. Cl. H01R 12/00

(52) U.S. Cl. 439/67

(57) ABSTRACT

This invention involves unique electroplated items comprising electrically conductive polymers. In addition, continuous production of electrically treated items is facilitated using electrically conductive resins. Many embodiments employ directly electroplateable resins for particular advantage. Unique methods of establishing electroplated electrical connections are taught.

### BACKGROUND OF THE INVENTION

Polymers (also referred to as plastics or resins) are normally electrically insulating. However, there a numerous applications where it is desired to impart a metallic property such as conductivity, rigidity etc. to a polymer. For the present invention, it is understood that polymers include any of the group of synthetic or natural organic materials that may be shaped when soft and then hardened. This includes thermoplastics and three-dimensional curing materials such as epoxies and thermosets. In addition, certain silicon based materials such as silicones can be considered as polymers or resins. Polymers also include any coating, ink, or paint fabricated using a polymer binder or film forming material.

Techniques have been developed to impart a metallic property to a polymer. One way is to add a filler to the polymer matrix to impart a metallic property such as conductivity. An example of such a filler is particulate silver. A second technique is to apply a metal coating to the surface of the polymer.

One way to apply a metal coating to the surface of a polymer is through simple lamination of a metal foil to a polymeric substrate a process which is well known in the art. A well-established application of this approach is the starting laminate structure for manufacture of many printed circuit boards. This approach can be design limited to essentially two-dimensional surfaces. Furthermore, if it is desired to have selective placement of metal on the final article, the metal foil must be selectively etched.

Another way to apply a metal coating to the surface of a polymer is by physically depositing metal onto a plastic substrate. Physical deposition can be achieved by arc spraying or vacuum deposition. These processes are well known in the art.

Yet another way to apply a metal coating to the surface of a polymer is through chemical deposition (for example, electroless plating). Chemical deposition is conventionally achieved by a multi-step process which is well know in the art. The plastic substrate is normally first chemically etched to microscopically roughen the surface. This etching promotes adhesion between the plastic substrate and the subsequently deposited metal. Further steps catalyze the plastic surface in preparation for metal deposition by chemical reduction of metal from solution. Nickel and copper are typical metals employed for “electroless plating”.

The “electroless plating” process employed with conventional plating on plastics comprises many steps involving expensive and harsh chemicals. This increases costs dramatically and involves environmental difficulties. The process is also sensitive to processing variables used to fabricate the plastic substrate, limiting the applications to carefully fabricated parts and designs.

The conventional technology for electroless plating has been extensively documented and discussed in the public and commercial literature. See, for example, Saubestre, Transactions of the Institute of Metal Finishing, 1969, Vol. 47, or Arcilesi et al., Products Finishing, March 1984.

There are a number of limitations associated with conventional vacuum deposition and chemical deposition. One is the relatively thin metallic thickness typically achieved with these techniques. Deposition speed, equipment utilization, deposit integrity and chemical cost often restrict deposits to these relatively small thicknesses. Another limitation is the restricted types of metals that can be applied with these processes.

In many cases it is desired to have increased thickness or variety of the metal deposit. In these cases, a particularly advantageous way to apply metal to a surface is electroplating. Electroplating builds metallic thickness relatively quickly and a wide variety of metals can be electroplated in conventional manner. Regarding plastics however, one will recognize that the surface of the plastic substrate must be conductive in order to permit electroplating. Surfaces of plastic articles can be rendered suitably conductive via a processing such as described above. In most conventional cases, electrodeposition is practiced in conjunction with “electroless plating” or lamination since the materials and process flow associated with such initial metal layering is somewhat compatible with subsequent electroplating.

In many instances the electroplating process is applied to individual articles arrayed on a positioning rack. The rack is rendered cathodic and all of the articles positioned on the rack are electroplated simultaneously. While the rack may be transported in a sequential fashion through multiple steps it can be considered as a discrete array of parts all processed together as a batch. In this process parts are normally individually positioned to form the array of each individual rack. This often entails manual labor and added cost.

It is a common practice to electroplate metal articles in an essentially continuous fashion (often referred to as roll-to-roll or reel-to-reel). Articles such as a metal wire or a metal strip are suitable for such continuous electroplating. With such continuous electroplating handling requirements for the metal articles are reduced and thus the processing cost can be reduced. Furthermore, the continuous electroplating allows for careful control of the manufacturing process (metal thickness etc.) which again results in reduced costs as well as consistent output. To achieve similar benefits it would be desirable to electroplate certain plastic forms in a continuous manner. Continuous electroplating could be particularly suitable for articles produced by certain plastic fabrication processes characterized by a continuous or semi-continuous output. These may include extrusion, thermoforming, printing of inks comprising plastic binders, indexed injection molding etc.

However, the inventor is not aware of the continuous electroplating of plastics having achieved any significant commercial success to date. One of the primary reasons for this is the complexity and cost associated with conventional electroplating of plastic. The “electroless plating” process employed with conventional plating on plastics comprises many steps involving expensive and harsh chemicals. This increases costs dramatically and involves environmental difficulties. The process is also very sensitive to processing variables used to fabricate the plastic substrate, limiting the applications to carefully fabricated parts and designs. Furthermore, the multiple process steps are often not conducive to a continuous processing environment. For example, transporting a web or film through multiple baths increases problems associated with cross contamination etc. Yet another problem is that the electroless process tends to be relatively slow in nature.

A number of attempts have been made to simplify the electroplating of plastics. If successful such efforts could result in significant cost reductions for electroplated plastics and could allow facile continuous electroplating of plastics to be practically employed. Some simplification attempts involve special chemical techniques, other than conventional electroless metal deposition, to produce an electrically conductive film on the surface. Typical examples of the approach are taught by U.S. Pat. No. 3,523,875 to Minklei, U.S. Pat. No. 3,682,786 to Brown et al., and U.S. Pat. No. 3,619,382 to Lupinski. The electrically conductive surface film produced was intended to be electroplated. Multiple performance problems thwarted these attempts.

Other approaches contemplate making the plastic surface itself conductive enough to allow it to be electroplated directly thereby avoiding the “electroless plating” or lamination processes. Efforts have been made to advance systems contemplating metal electrodeposition directly onto the surface of polymers made conductive through incorporating conductive fillers. When considering polymers rendered electrically conductive by loading with electrically conductive fillers, it may be important to distinguish between “microscopic resistivity” and “bulk” or macroscopic resistivity”. “Microscopic resistivity” refers to a characteristic of a polymer/filler mix considered at a relatively small linear dimension of for example 1 micrometer or less. “Bulk” or “macroscopic resistivity” refers to a characteristic determined over larger linear dimensions. To illustrate the difference between “microscopic” and “bulk, macroscopic” resistivities, one can consider a polymer loaded with conductive fibers at a fiber loading of 10 weight percent. Such a material might show a low “bulk, macroscopic” resistivity when the measurement is made over a relatively large distance. However, because of fiber separation (holes) such a composite might not exhibit consistent “microscopic” resistivity. When producing an electrically conductive polymer intended to be electroplated, one should consider “microscopic resistivity” in order to achieve uniform, “hole-free” deposit coverage. Thus, it may be advantageous to consider conductive fillers comprising those that are relatively small, but with loadings sufficient to supply the required conductive contacting. Such fillers include metal powders and flake, metal coated mica or spheres, conductive carbon black and the like.

Efforts to produce electrically conductive polymers suitable for direct electroplating have encountered a number of obstacles. The first is the combination of fabrication difficulty and material property deterioration brought about by the heavy filler loadings often required. A second is the high cost of many conductive fillers employed such as silver flake.

Another obstacle involved in the electroplating of electrically conductive polymers is a consideration of adhesion between the electrodeposited metal and polymeric substrate (metal/polymer adhesion). In some cases such as electroforming, where the electrodeposited metal is eventually removed from the substrate, metal/polymer adhesion may actually be detrimental. However, in most cases sufficient adhesion is required to prevent metal/polymer separation during extended environmental and use cycles.

A number of methods to enhance adhesion have been employed. For example, etching of the surface prior to plating can be considered. Etching can be achieved by immersion in vigorous solutions such as chromic/sulfuric acid. Alternatively, or in addition, an etchable species can be incorporated into the conductive polymeric compound. The etchable species at exposed surfaces is removed by immersion in an etchant prior to electroplating. Oxidizing surface treatments can also be considered to improve metal/plastic adhesion. These include processes such as flame or plasma treatments or immersion in oxidizing acids.

In the case of conductive polymers containing finely divided metal, one can propose achieving direct metal-to-metal adhesion between electrodeposit and filler. However, here the metal particles are generally encapsulated by the resin binder, often resulting in a resin rich “skin”. To overcome this effect, one could propose methods to remove the “skin”, exposing active metal filler to bond to subsequently electrodeposited metal.

Another approach to impart adhesion between conductive resin substrates and electrodeposits is incorporation of an “adhesion promoter” at the surface of the electrically conductive resin substrate. This approach was taught by Chien et al. in U.S. Pat. No. 4,278,510 where maleic anhydride modified propylene polymers were taught as an adhesion promoter. Luch, in U.S. Pat. No. 3,865,699 taught that certain sulfur bearing chemicals could function to improve adhesion of initially electrodeposited Group VIII metals.

An additional major obstacle confronting development of electrically conductive polymeric resin compositions capable of being directly electroplated is the initial “bridge” of electrodeposit on the surface of the electrically conductive resin. In electrodeposition, the substrate to be plated is often made cathodic through a pressure contact to a metal rack tip, itself under cathodic potential. However, if the contact resistance is excessive or the substrate is insufficiently conductive, the electrodeposit current favors the rack tip to the point where the electrodeposit will have difficulty bridging to the substrate.

Moreover, a further problem is encountered even if specialized racking successfully achieves electrodeposit bridging to the substrate. Many of the electrically conductive polymeric resins have resistivities far higher than those of typical metal substrates. The polymeric substrate can be relatively limited in the amount of electrodeposition current which it alone can convey. Thus, the conductive polymeric substrate does not cover almost instantly with electrodeposit as is typical with metallic substrates. Rather the electrodeposit coverage occurs by lateral growth over the surface. Except for the most heavily loaded and highly conductive polymer substrates, a significant portion of the electrodeposition current, including that associated with the lateral electrodeposit growth, must pass through the previously electrodeposited metal. In a fashion similar to the bridging problem discussed above, the electrodeposition current favors the electrodeposited metal and the lateral growth can be extremely slow and erratic. This restricts the size and “growth length” of the substrate conductive pattern, increases plating costs, and can also result in large non-uniformities in electrodeposit integrity and thickness over the pattern.

This lateral growth is dependent on the ability of the substrate to convey current. Thus, the thickness and resistivity of the conductive polymeric substrate can be defining factors in the ability to achieve satisfactory electrodeposit coverage rates. When dealing with continuously electroplated patterns long thin metal traces are often desired, deposited on relatively thin electrically conductive polymers. These factors of course work against achieving the desired result.

This coverage rate problem likely can be characterized by a continuum, being dependent on many factors such as the nature of the initially electrodeposited metal, electroplating bath chemistry, the nature of the polymeric binder and the resistivity of the electrically conductive polymeric substrate. As a “rule of thumb”, the instant inventor estimates that coverage rate problems would demand attention if the resistivity of the conductive polymeric substrate rose above about 0.001 ohm-cm.

Beset with the problems of achieving adhesion and satisfactory electrodeposit coverage rates, investigators have attempted to produce directly electroplateable polymers by heavily loading polymers with relatively small metal containing fillers. Such heavy loadings are sufficient to reduce both microscopic and macroscopic resistivity to a level where the coverage rate phenomenon may be manageable. However, attempts to make an acceptable directly electroplateable resin using the relatively small metal containing fillers alone encounter a number of barriers. First, the fine metal containing fillers are relatively expensive. The loadings required to achieve the particle-to-particle proximity to achieve acceptable conductivity increases the cost of the polymer/filler blend dramatically. The metal containing fillers are accompanied by further problems. They tend to cause deterioration of the mechanical properties and processing characteristics of many resins. This significantly limits options in resin selection. All polymer processing is best achieved by formulating resins with processing characteristics specifically tailored to the specific process (injection molding, extrusion, blow molding etc.). A required heavy loading of metal filler severely restricts ability to manipulate processing properties in this way. A further problem is that metal fillers can be abrasive to processing machinery and may require specialized screws, barrels, and the like. Finally, despite being electrically conductive, a simple metal-filled polymer still offers no mechanism to produce adhesion of an electrodeposit since the metal particles are generally encapsulated by the resin binder, often resulting in a non-conductive resin-rich “skin”. For the above reasons, fine metal particle containing plastics have not been widely used as substrates for directly electroplateable articles. Rather, they have found applications in production of conductive adhesives, pastes, and paints.

The least expensive (and least conductive) of the readily available conductive fillers for plastics are carbon blacks. Attempts have been made to produce electrically conductive polymers based on carbon black loading intended to be subsequently electroplated. Examples of this approach are the teachings of U.S. Pat. Nos. 4,038,042, 3,865,699, and 4,278,510 to Adelman, Luch, and Chien et al. respectively.

Adelman taught incorporation of conductive carbon black into a polymeric matrix to achieve electrical conductivity required for electroplating. The substrate was pre-etched in chromic/sulfuric acid to achieve adhesion of the subsequently electroplated metal. However, the rates of electrodeposit coverage reported by Adelman may be insufficient for many applications.

Luch in U.S. Pat. No. 3,865,699 and Chien et al. in U.S. Pat. No. 4,278,510 also chose carbon black as a filler to provide an electrically conductive surface for the polymeric compounds to be electroplated. The Luch Patent 3,865,699 and the Chien Patent 4,278,510 are hereby incorporated in their entirety by this reference. However, these inventors further taught inclusion of an electrodeposit coverage or growth rate accelerator to overcome the galvanic bridging and lateral electrodeposit growth rate problems described above. An electrodeposit coverage rate accelerator is an additive whose primary function is to increase the electrodeposition coverage rate independent of any affect it may have on the conductivity of an electrically conductive polymer. In the embodiments, examples and teachings of U.S. Pat. Nos. 3,865,699 and 4,278,510, it was shown that certain sulfur bearing materials, including elemental sulfur, can function as electrodeposit coverage or growth rate accelerators to overcome those problems associated with electrically conductive polymeric substrates having relatively high resistivity.

In addition to elemental sulfur, sulfur in the form of sulfur donors such as sulfur chloride, 2-mercapto-benzothiazole, N-cyclohexyle-2-benzothiaozole sulfonomide, dibutyl xanthogen disulfide, and tetramethyl thiuram disulfide or combinations of these and sulfur were identified. Those skilled in the art will recognize that these sulfur donors are the materials which have been used or have been proposed for use as vulcanizing agents or accelerators. Since the polymer-based compositions taught by Luch and Chien et al. could be electroplated directly they could be accurately defined as directly electroplateable resins (DER). These DER materials can be generally described as electrically conductive polymers characterized by having an electrically conductive surface with the inclusion of an electrodeposit coverage rate accelerator. In the following, the acronym “DER” will be used to designate a directly electroplateable resin as defined in this specification.

Specifically for the present invention, directly electroplateable resins, (DER), are characterized by the following features.
(a) presence of an electrically conductive polymer characterized by having an electrically conductive surface;
(b) presence of an electrodeposit coverage rate accelerator;
(c) presence of the electrically conductive polymer characterized by having an electrically conductive surface and the electrodeposit coverage rate accelerator in the directly electroplateable composition in cooperative amounts required to achieve direct coverage of the composition with an electrodeposited metal or metal-based alloy.

In his Patents, Luch specifically identified elastomers such as natural rubber, polychloroprene, butyl rubber, chlorinated butyl rubber, polybutadiene rubber, acrylonitrile-butadiene rubber, styrene-butadiene rubber etc. as suitable for the matrix polymer of a directly electroplateable resin. Other polymers identified by Luch as useful included polyvinyls, polyolefins, polystyrenes, polyamides, polyesters and polyurethanes.

In his Patents, Luch identified carbon black as a means to render a polymer and its surface electrically conductive. As is known in the art, other conductive fillers can be used to impart conductivity to a polymer. These include metallic flakes or powders such as those comprising nickel or silver. Other fillers such as metal coated minerals may also suffice. Furthermore, one might expect that compositions comprising intrinsically conductive polymers may be suitable.

Regarding electrodeposit coverage rate accelerators, both Luch and Chien et al. in the above discussed U.S. Patents demonstrated that sulfur and other sulfur bearing materials such as sulfur donors and accelerators served this purpose when using an initial Group VIII “strike” layer. One might expect that other elements of Group 6A nonmetals, such as oxygen, selenium and tellurium, could function in a way similar to sulfur. In addition, other combinations of electrodeposited metals and nonmetal coverage rate accelerators may be identified. It is important to recognize that such an electrodeposit coverage rate accelerator is extremely important in order to achieve direct electrodeposition in a practical way onto polymeric substrates having low conductivity or very thin electrically conductive polymeric substrates having restricted current carrying ability.

Furthermore, it has been found that Group VIII or Group VIII metal-based alloys are particularly suitable as the initial electrodeposit on the DER surface.

Despite the multiple attempts identified above to dramatically simplify the plastics plating process, the current inventor is not aware of any such attempt having achieved recognizable commercial success.

In order to eliminate ambiguity in terminology, for the present invention the following definitions are supplied:

“Metal-based” refers to a material or structure having at least one metallic property and comprising one or more components at least one of which is a metal or metal-containing alloy.

“Alloy” refers to a substance composed of two or more intimately mixed materials.

“Group VIII metal-based” refers to a substance containing by weight 50% to 100% metal from Group VIII of the Periodic Table of Elements.

“Electroplateable material” refers to a material that exhibits a surface that can be exposed to an electroplating process to cause the surface to cover with electrodeposited material.

### OBJECTS OF THE INVENTION

An object of the invention is to provide novel methods of facile continuous manufacture of electrochemically or electrophysically treated items.

A further object of the invention is to expand permissible options for the continuous production of electroplated items.

A further object of the invention is to expand options for the electrochemical or electrophysical treatment of objects in a continuous fashion.

A further object of the invention is to teach novel and facile methods for achieving electrical connections via electrodeposition.

### SUMMARY OF THE INVENTION

The current invention involves continuous production of electrochemically treated objects. In many embodiments the electrochemical treatments comprise electrodeposition. In many embodiments the continuous production involves the electroplating of electrically conductive polymers. In many embodiments the electrically conductive polymer comprises a directly electroplateable resin.

### BRIEF DESCRIPTION OF THE DRAWINGS

The various factors and details of the structures and manufacturing methods of the present invention are hereinafter more fully set forth with reference to the accompanying drawings wherein:

FIG. 1 is a top plan view of an object used to understand the continuous processing nature of the disclosed invention.

FIG. 2 is a perspective view of a processing tank useful in describing the continuous processing of the invention.

FIG. 3 is a top plan view of an object processed according to the teachings of the current invention.

FIG. 4 is a sectional view taken substantially from the perspective of line 4-4 of FIG. 3.

FIG. 5 is a view similar to FIG. 4 following an additional processing step according to the invention.

FIG. 6 is a schematic representation of one form of process according to the present disclosure.

FIG. 7 is a schematic representation of the process of FIG. 6 augmented with a subsequent additional process.

FIG. 8 is a schematic representation of another form of process according to the present invention.

FIG. 9 is a sectional view of a structure taken substantially from the perspective of lines 9-9 of FIG. 6.

FIG. 9A is a is a sectional view taken substantially from the perspective of lines 9A-9A of FIG. 6 showing the laminate structure present at that point in the process depicted in FIG. 6.

FIG. 9B is a sectional view taken substantially from the perspective of line 9B-9B of FIG. 6 showing the laminate structure produced by the process depicted in FIG. 6.

FIG. 9C is a sectional view taken substantially from the perspective of lines 9C-9C of FIG. 7 showing the resultant product produced by the complete process depicted in FIG. 7.

FIG. 10 is a top plan view of a structure intended to be processed according to the process depicted in FIG. 6.

FIG. 11 is a sectional view taken substantially from the perspective of lines 11-11 of FIG. 10.

FIG. 12 is a sectional view taken substantially from the perspective of lines 12-12 of FIG. 10.

FIG. 13 is a sectional view similar to FIG. 11 showing the resulting structure produced by the process of FIG. 6.

FIG. 14 is a sectional view taken from a perspective similar to that of FIG. 11 but of a different embodiment.

FIG. 15 is a sectional view similar to FIG. 14 showing the resulting structure produced by the process of FIG. 6.

FIG. 16 is a sectional view of the structure shown in FIG. 15 after an additional processing step.

FIG. 17 is a top plan view of another embodiment intended to be processed according to the process depicted in FIG. 6.

FIG. 18 is a sectional view taken substantially from the perspective of lines 18-18 of FIG. 17.

FIG. 19 is a sectional view showing the result of subjecting the structure depicted in FIGS. 17 and 18 to the process of FIG. 6.

FIG. 20 is a sectional view showing the structure resulting from subjecting the embodiment shown in FIG. 19 to the additional processing shown in FIG. 9.

FIG. 21 is a sectional view taken substantially from the perspective of lines 21-21 of FIG. 8.

FIG. 21A is a top plan view taken substantially from the perspective of lines 21A-21A of FIG. 21.

FIG. 21B is a sectional view taken substantially from the perspective of lines 21B-21B of FIG. 8.

FIG. 21C is a top plan view taken substantially from the perspective of lines 21C-21C of FIG. 21B.

FIG. 22 is a schematic depiction of another form of process according to the present invention and disclosure.

FIG. 22A is a schematic depiction of another form of process according to the present invention and disclosure.

FIG. 22B is a schematic depiction of another form of process according to the present invention and disclosure.

FIG. 22C is a schematic depiction of another form of process according to the present invention and disclosure.

FIG. 22D is a schematic depiction of another form of process according to the present invention and disclosure.

FIG. 23 is a top plan view of another embodiment of a starting structure useful in manufacture of the articles of the current disclosure and invention.

FIG. 24 is a sectional view taken substantially from the perspective of lines 24-24 of FIG. 22D showing a manufacturing arrangement useful in the process of the current invention.

FIG. 25 is a sectional view similar to that of FIG. 24 but taken from the perspective of lines 25-25 of FIG. 22D.

FIG. 26 is a sectional view taken substantially from the perspective of lines 26-26 of FIG. 22D.

FIG. 27 is a top plan view of another embodiment of a starting structure useful in manufacture of the articles of the current disclosure and invention.

FIG. 28 is a sectional view taken substantially from the perspective of lines 28-28 of FIG. 27.

FIG. 29 is a sectional view of the article of FIG. 28 following an optional processing step.

FIG. 30 is a top plan view of an intermediate article of manufacture according to the current invention utilizing the structure depicted in FIG. 29.

FIG. 30A is a sectional view similar to FIG. 29 employing the structure of FIG. 30 rather than the structure of FIG. 27.

FIG. 31 is a sectional view similar to FIG. 30A but following an additional processing step.

FIG. 32 is a sectional view similar to FIG. 28 but employing additional structure.

FIG. 33 is a sectional view of the article shown in FIG. 32 following an additional processing step.

FIG. 34 is a sectional view taken substantially from the perspective of lines 34-34 of FIG. 23.

FIG. 35 is a sectional view taken substantially from the perspective of lines 35-35 of FIG. 23.

FIG. 36 is a sectional view of the article of FIG. 35 following an optional processing step.

FIG. 37 is a sectional view similar to FIG. 35 showing the additional structure resulting from the FIG. 22 process.

FIG. 38 is a sectional view taken substantially from the perspective of lines 38-38 of FIG. 36.

FIG. 39 is a greatly simplified depiction of the roll-to-roll processing made possible using the current invention.

FIG. 40 is a top plan view showing an additional process which can optionally be performed on the electroplated article depicted in FIGS. 36 to 38.

FIG. 41 is a top plan view of yet another embodiment of the current disclosure and invention.

FIG. 42 is a bottom plan view of the article which was depicted in the top plan view of FIG. 41.

FIG. 43 is a sectional view taken substantially from the perspective of lines 43-43 of FIG. 41.

FIG. 44 is a greatly expanded view of the section contained within circle “N” of FIG. 43.

FIG. 45 is a sectional view similar to FIG. 44 of an alternate structure.

FIG. 46 is a sectional view similar to FIGS. 44 and 45 of another alternate structure.

FIG. 47 is a sectional view of yet another alternate structure similar to FIGS. 44 through 46.

FIG. 48 is a sectional view similar to FIG. 43 following a processing step according to the present invention.

FIG. 49 is a greatly expanded view of the section contained within the circle “M” of FIG. 48.

FIG. 50 is a sectional view similar to FIG. 48 but illustrating an optional processing step according to the present invention.

FIG. 51 is a sectional view showing a structure resulting from the processing step of FIG. 50.

FIG. 52 is a top plan view of yet another embodiment of the current invention.

FIG. 53 is a bottom plan view of the structure depicted in FIG. 52.

FIG. 54 is a sectional view taken substantially from the perspective of lines 54-54 of FIG. 52.

FIG. 55 is a greatly expanded sectional view of the structure depicted within circle “H” of FIG. 54.

FIG. 56 is a sectional view similar to FIG. 54 following a processing step according to the present invention.

FIG. 57 is a greatly expanded sectional view of the structure contained within circle “I” of FIG. 56.

FIG. 58 is a sectional view similar to FIG. 56 but illustrating an optional processing step according to the present invention.

FIG. 59 is a bottom plan view similar to FIG. 53 illustrating the resultant structure from the process steps taught in FIGS. 52-58 according to the present invention.

FIG. 60 is a top plan view of yet another embodiment of the current disclosure and invention.

FIG. 61 is a top plan view of the article of FIG. 60 but following a processing step.

FIG. 62 is a sectional view taken substantially from the perspective of lines 62-62 of FIG. 61.

FIG. 63 is a top plan view of an article capable of being processed according to the present invention.

FIG. 64 is a greatly magnified top plan view of the structure represented in FIG. 63.

FIG. 65 is a sectional view taken substantially from the perspective of line 65-65 of FIG. 64.

FIG. 66 is a sectional view taken substantially from the perspective of line 66-66 of FIG. 64.

FIG. 67 is a top plan view similar to FIG. 63 but following a processing step.

FIG. 67A is a top plan view similar to FIG. 67 but showing additional structure.

FIG. 68 is a greatly expanded top plan view of the structure of FIG. 67.

FIG. 68A is a top plan view similar to FIG. 68 but showing additional structure as identified by that contained within circle “U” of FIG. 67A.

FIG. 69 is a sectional view taken substantially from the perspective of line 69-69 of FIG. 68.

FIG. 69A is a sectional view similar to FIG. 69 but showing additional structure.

FIG. 70 is a view similar to FIG. 69 following an additional processing step according to the invention.

FIG. 70A is a view similar to FIG. 70 but showing additional structure.

FIG. 71 is a top plan view of yet another structure useful in the present invention.

FIG. 72 is a sectional view taken substantially from the perspective of lines 72-72 of FIG. 71.

FIG. 73 is a top plan view of the material shown in FIGS. 71 and 72 but following a processing step.

FIG. 74 is a sectional view taken substantially from the perspective of lines 74-74 of FIG. 73.

FIG. 75 is a sectional view similar to FIG. 74 following a process step according to the present invention.

FIG. 76 is a simplified schematic depiction of yet another process made possible by the teachings of the current invention.

FIG. 77 is a sectional view of an embodiment taken substantially from the perspective of lines 77-77 of FIG. 76.

FIG. 78 is a sectional view also taken from the perspective of lines 78-78 of FIG. 76 but of an alternate possible structure.

FIG. 79 is a sectional view taken from the perspective of lines 79-79 of FIG. 76 of yet another alternate possible structure.

FIG. 80 is a sectional view, taken substantially from the perspective of lines 80-80 of FIG. 76, of the article depicted in FIG. 77 but following a processing step according to the current invention.

FIG. 81 is a sectional view, taken substantially from the perspective of lines 80-80 of FIG. 76, of the article depicted in FIG. 78 but following a processing step according to the current invention.

FIG. 82 is a sectional view, taken substantially from the perspective of lines 80-80 of FIG. 76, of the article depicted in FIG. 79 but following a processing step according to the current invention.

FIG. 83 is a schematic view of yet another process made possible by the teachings of the present invention.

FIG. 84 is a sectional view taken substantially from the perspective of lines 84-84 of FIG. 83.

FIG. 84A is a top plan view of the structure shown in the sectional view of FIG. 84.

FIG. 84B is a top plan view similar to FIG. 84A but of an additional embodiment.

FIG. 84C is a top plan view similar to those of FIGS. 84A and 84B of yet another additional embodiment.

FIG. 85 is a sectional view taken substantially from the same perspective as FIG. 84 but of an alternate structure.

FIG. 85A is a sectional view taken substantially from the same perspective as FIG. 84 but of yet another alternate structure.

FIG. 85B is a sectional view, taken substantially from the perspective of lines 85B-85B of FIG. 85C.

FIG. 85C is a top plan view of the structure depicted in section in FIG. 85B useful in explaining the indexing of a process step shown in FIG. 83.

FIG. 86 is a sectional view taken substantially from the perspective of lines 86-86 of FIG. 83 and lines 86-86 of FIG. 86A illustrating the results of a process step employing the structure of FIG. 84.

FIG. 86A is a top plan view of the structure depicted in section in FIG. 86.

FIG. 87 is a sectional view similar to FIG. 86 but taken substantially from the perspective of lines 87-87 of FIG. 83 and lines 87-87 of FIG. 87A which illustrates the results of a processing step according to the current invention.

FIG. 87A is a top plan view of the structure depicted in FIG. 87 which also illustrates an additional optional processing step.

FIG. 88 is a top plan view of yet another embodiment appropriate for use in the process depicted in FIG. 83.

FIG. 89 is a top plan view similar to FIG. 88 showing additional structure produced by a processing step depicted in FIG. 83.

FIG. 90 is a sectional view taken substantially from the perspective of lines 90-90 of FIG. 89.

FIG. 90A is a sectional view similar to FIG. 90 showing additional structure produced by a processing step.

FIG. 91 is a sectional view taken substantially from the perspective of lines 91-91 of FIG. 89.

FIG. 91A is a sectional view similar to FIG. 91 showing additional structure produced by a processing step.

FIG. 92 is a top plan view of yet another embodiment according to the current invention.

FIG. 93 is a sectional view taken substantially from the perspective of lines 93-93 of FIG. 92

FIG. 94 is a view similar to FIG. 93 showing additional structure produced by a processing step.

FIG. 95 is a sectional view of an intermediate article of manufacture associated with the current disclosure and invention.

FIG. 96 is a view similar to FIG. 95 showing the structure depicted in FIG. 95 plus additional structure produced by a processing step.

FIG. 97 is a sectional view showing the structure depicted in FIG. 96 plus additional structure resulting from a processing step.

FIG. 98 is a sectional view of an embodiment of an intermediate article of manufacture according to current disclosure and invention.

FIG. 99 is a view similar to FIG. 98 showing the structure depicted in FIG. 98 plus additional structure produced by a processing step.

FIG. 100 is a sectional view showing the structure depicted in FIG. 99 plus additional structure resulting from a processing step.

FIG. 101 is a sectional view similar to that of FIG. 99 but of a slightly different structural arrangement.

FIG. 102 is a view similar to FIG. 101 showing the structure depicted in FIG. 101 plus additional structure produced by a processing step.

FIG. 103 is a sectional view of a portion of the structure shown in FIG. 102 combined with additional structure.

FIG. 104 is a sectional view similar to FIG. 103 of an alternate structure.

FIG. 105 is a side view of another embodiment according to the current disclosure and invention.

FIG. 106 is a sectional view taken substantially from the perspective of lines 106-106 of FIG. 105.

FIG. 107 is a view similar to that of FIG. 106 showing additional structure produced by a processing step.

FIG. 108 is a sectional view of another embodiment of the invention.

FIG. 109 is a view similar to that of 108 showing the results of a processing step on the FIG. 108 structure.

FIG. 110 is a top plan view of yet another embodiment according to the current disclosure and invention.

FIG. 111 is a sectional view taken substantially from the perspective of lines 111-111 of FIG. 110.

FIG. 112 is a sectional view similar to FIG. 111 following a process step.

FIG. 113 is a sectional view similar to FIG. 112 of the structure following an additional process step.

FIG. 114 is a top plan view of yet another embodiment according to the current disclosure and invention.

FIG. 114A is a sectional view taken substantially from the perspective of lines 114A-114A of FIG. 114.

FIG. 115 is a top plan view of the article depicted in FIG. 114 but following a processing step.

FIG. 115A is a sectional view taken substantially from the perspective of lines 115A-115A of FIG. 115.

FIG. 116 is a sectional view similar to FIG. 115A showing additional structure resulting from a processing step.

FIG. 117 is a view similar to FIG. 116 showing structure in addition to the structure depicted in FIG. 116.

FIG. 118 is a top plan view of yet another embodiment according to the current disclosure and invention.

FIG. 119 is a sectional view taken substantially from the perspective of lines 119-119 of FIG. 118.

FIG. 120 is a top plan view of the structure depicted in FIG. 118 plus additional structure produced by a process step.

FIG. 121 is a sectional view taken substantially from the perspective of lines 121-121 of FIG. 120.

FIG. 122 is a view similar to FIG. 121 showing the FIG. 121 structure plus additional structure produced by a processing step.

FIG. 123 is a view similar to FIG. 122 showing the FIG. 122 structure plus additional structure produced by a processing step.

FIG. 124 is a sectional view similar to that of FIG. 123 but useful in explaining an alternate structure to that shown in FIG. 123.

FIG. 125 is a top plan view of yet another embodiment of a continuously electroplated article according to the invention.

FIG. 126 is a sectional view taken substantially from the perspective of 126-126 of FIG. 125.

FIG. 127 is a sectional view similar to 126 but following an additional processing step.

FIG. 128 is a depiction of another process according to the current disclosure and invention.

FIG. 129 is an embodiment of a possible article as seen substantially from the perspective of lines 129-129 of FIG. 128.

FIG. 130 is a top plan view as seen from the perspective of lines 130-130 of FIG. 129.

### DESCRIPTION OF PREFERRED EMBODIMENTS

Many applications of the current invention will employ a generally planar, sheet-like structure having thickness much smaller than its length or width. This sheet like structure may also have a length far greater than its width, in which case it is commonly referred to as a “web”. Because of its extensive length, a web can be conveyed through one or more processing steps in a way that can be described as “continuous”. “Continuous” web processing is well known in the paper and packaging industries. It is often accomplished by supplying web material from a feed roll to the process steps and retrieving the web onto a takeup roll following processing (roll-to-roll or reel-to-reel processing).

Web processing of metal forms is known in the electrochemical art. For example, “continuous” anodizing or electroplating of metal sheet or strip is practiced. In these cases the metal dimensions are as described above characterizing a “web”. Use of web processing for electrochemical processing polymeric materials is more difficult, at least in part because of the insulating characteristics of most polymers. Nevertheless, the instant inventor has recognized that web processing can be practiced with many advantages in the electrochemical or electrophysical processing of polymers.

A first advantage is that an insulating web can serve as a permanent or surrogate positioning or support structure for articles intended for electrochemical processing. Electrochemical processes are normally immersion processes. Electrochemical baths are often heavily agitated. Many forms would not be self-supporting in such an environment. Forms of thin metal foil or conductive polymer ink patterns are examples. Conductive inks or paints such as particulate metal filled inks or paints can be considered for electrochemical treatment when supported on a web. Another advantage is many electrochemical and electrophysical processes may require certain positioning or placement among the items to be treated. Size or structural constraints might permit certain items from being adequately positioned using a classic batch electrical processing rack. Positioning of such items onto a conveyance web could facilitate such processing and reduce labor burden in racking.

Another advantage of web processing using polymeric based webs is that the web can remain as a permanent support for the treated items or can be removed, in which case it would serve as a surrogate support during processing.

Another advantage of web processing is that it can be accomplished in an essentially continuous operation thereby achieving the advantages of continuous processing.

Another advantage of web process is that the web can comprise many different materials, surface characteristics and forms. For example, the web can constitute a nonporous film or may be a fabric. Combinations of such differences over the expansive surface of the web can be achieved. Indeed, as will be shown, the web itself can comprise materials such as conductive polymers or even metal fibers which will allow the web itself to undergo electrochemical processing.

Because the surface area of web being processed at any one time in an individual electrochemical operation can be relatively expansive and moving, it may be inconvenient to bring an electrical characteristic such as current or voltage to a myriad of different points simultaneously using discrete individual contact. Thus another characteristic of web processing is that it allows the desired electrical characteristic (current, voltage, etc.) to be conveyed to a large number of points over an expansive surface using simplified buss structures, as will become clear in the discussion of embodiments to follow. Because the items being electrochemically treated may have complex structure, it may be difficult to specify a direction of electrical flow at any one point on the surface of an item being treated. However, normally web processing will be characterized as having a conductive path, or buss, intended to convey the electrical characteristic (current, voltage etc.) in a direction parallel to the length direction of the web to a source of the electrical characteristic contacting the conductive path. A buss may comprise structure in the form of extending arms or fingers to electrically connect remote points to a main buss artery. Thus, a buss structure supplies a conductive path between a source of electrical characteristic and a removed structure intended to be exposed to the electrical process. For example, a buss used for electroplating is a conductive path extending from a source of potential to a point proximal or contacting a surface intended to be electroplated. In typical practice a buss may supply electrical communication between one or more items or structures and the source of the electrical characteristic. Thus in many cases the buss will electrically connect multiple structures undergoing treatment. However, this is not necessarily the case. As will be seen, buss structure can be used to effectively promote treatment of the entire web itself or to form a convenient surface to facilitate a sliding contact.

As will be taught herein, in many cases it is advantageous to form a buss from electrically conductive resins positioned on the web prior to electrochemical processing. This takes advantage of the ease of application, adhesive characteristics, and flexibility of conductive resins. In these cases an electrodeposit may augment the current carrying ability of the conductive polymeric buss.

The following teaching of preferred embodiments, taken along with the descriptive figures, will reveal and teach the eminently suitable characteristics of electrically conductive polymers in the production of continuously electroplated articles. In many embodiments, an electrically conductive polymer formulated as a directly electroplateable resin is particularly suitable.

As pointed out above in this specification, attempts to dramatically simplify the process of electroplating on plastics have met with commercial difficulties. Nevertheless, the current inventor has persisted in personal efforts to overcome certain performance deficiencies associated with the initial DER technology. Along with these efforts has come a recognition of unique and eminently suitable applications employing electrically conductive polymers and specifically the DER technology especially for those applications employing the continuous electroplating of plastics. Some examples of these unique applications for continuously electroplated items include electrical circuits, electrical traces, circuit boards, antennas, capacitors, induction heaters, connectors, switches, resistors, inductors, batteries, fuel cells, coils, signal lines, power lines, radiation reflectors, coolers, diodes, transistors, piezoelectric elements, photovoltaic cells, emi shields, biosensors and sensors.

A first recognition, is that the “microscopic” material resistivity generally is not reduced below about 1 ohm-cm by using conductive carbon black alone. This is several orders of magnitude larger than typical metal resistivities. Other well known finely divided conductive fillers (such as metal flake or powder, metal coated minerals, graphite, or other forms of conductive carbon) can be considered in DER applications requiring lower “microscopic” resistivity. In these cases the more highly conductive fillers can be considered to augment or even replace the conductive carbon black.

Moreover, the “bulk, macroscopic” resistivity of conductive carbon black filled polymers can be further reduced by augmenting the carbon black filler with additional highly conductive, high aspect ratio fillers such as metal containing fibers. This can be an important consideration in the success of certain applications. Furthermore, one should realize that incorporation of non-conductive fillers may increase the “bulk, macroscopic” resistivity of conductive polymers loaded with finely divided conductive fillers without significantly altering the “microscopic resistivity” of the conductive polymer. This is an important recognition regarding DER's in that electrodeposit coverage speed depends not only on the presence of an electrodeposit coverage rate accelerator but also on the “microscopic resistivity” and less so on the “macroscopic resistivity” of the DER formulation. Thus, large additional loadings of functional non-conductive fillers can be tolerated in DER formulations without undue sacrifice in electrodeposit coverage rates or adhesion. These additional non-conductive loadings do not greatly affect the “microscopic resistivity” associated with the polymer/conductive filler/electrodeposit coverage rate accelerator “matrix” since the non-conductive filler is essentially encapsulated by “matrix” material. Conventional “electroless” plating technology does not permit this compositional flexibility.

Yet another recognition regarding the DER technology is its ability to employ polymer resins generally chosen in recognition of the fabrication process envisioned and the intended end use requirements. Thus DER's can be produced in material forms that are often suitable for continuous electroplating. In order to provide clarity, examples of some such fabrication processes are presented immediately below in subparagraphs 1 through 5.
(1) Should it be desired to electroplate an ink, paint, coating, or paste which may be printed or formed on a substrate, a good film forming polymer, for example a soluble resin such as an elastomer, can be chosen to fabricate a DER ink (paint, coating, paste etc.).
(2) Should it be desired to electroplate a fabric, a DER ink can be used to coat all or a portion of the fabric intended to be electroplated. Furthermore, since DER's can be fabricated out of the thermoplastic materials commonly used to create fabrics, the fabric itself could completely or partially comprise a DER. This would obviously eliminate the need to coat the fabric.
(3) Should one desire to electroplate a thermoformed article or structure, DER's would represent an eminently suitable material choice. DER's can be easily formulated using olefinic materials which are often a preferred material for the thermoforming process. Furthermore, DER's can be easily and inexpensively extruded into the sheet like structure necessary for the thermoforming process.
(4) Should one desire to electroplate an extruded article or structure, for example a sheet or film, DER's can be formulated to possess the necessary melt strength advantageous for the extrusion process.
(5) Should one desire to injection mold an article or structure having thin walls, broad surface areas etc. a DER composition comprising a high flow polymer can be chosen.
(6) Should one desire to vary adhesion between an electrodeposited DER structure supported by a substrate the DER material can be formulated to supply the required adhesive characteristics to the substrate.

All polymer fabrication processes require specific resin processing characteristics for success. The ability to “custom formulate” DER's to comply with these changing processing and end use requirements while still allowing facile, quality electroplating is a significant factor in the continuous electroplating teachings of the current invention. Conventional plastic electroplating technology does not permit great flexibility to “custom formulate”.

Another important recognition regarding the suitability of DER's for continuous electroplating is the simplicity of the electroplating process. Unlike many conventional electroplated plastics, DER's do not require a significant number of process steps during the manufacturing process. This allows for simplified manufacturing and improved process control. It also reduces the risk of cross contamination such as solution dragout from one process bath being transported to another process bath. The simplified manufacturing process will also result in reduced manufacturing costs.

Yet another recognition of the benefit of DER's for continuous electroplating is the ability they offer to selectively electroplate an article or structure. As will be shown in later embodiments, it is often desired to continuously electroplate a polymer or polymer-based structure in a selective manner. DER's are eminently suitable for such continuous yet selective electroplating.

Yet another recognition of the benefit of DER's for continuous electroplating is their ability to withstand the pre-treatments often required to prepare other materials for plating. For example, were a DER to be combined with a metal, the DER material would be resistant to many of the pre-treatments which may be necessary to electroplate the metal.

Yet another recognition of the benefit of DER's for continuous electroplating is that the desired plated structure often requires the plating of long and/or broad surface areas. As discussed previously, the coverage rate accelerators included in DER formulations allow for such extended surfaces to be covered in a relatively rapid manner thus allowing one to consider the use of continuous electroplating of conductive polymers.

These and other attributes of DER's in the production of continuously and sequentially electroplated articles will become clear through the following remaining specification, accompanying figures and claims.

Reference will now be made in detail to the preferred embodiments of the invention, examples of which are illustrated in the accompanying drawings. In some of the drawings, like reference numerals designate identical or corresponding parts throughout several views and an additional letter designation is characteristic of a particular embodiment.

Referring to FIG. 1, there is shown in top plan view an article useful in teaching the current invention. Article 10 shown in FIG. 1 has a width W-1 and a length L-1. Article 10 is intended to be exposed to an electroplating process. It will be noted that many of the embodiments of the current invention will be described in conjunction with the electroplating or electrodeposition process. However, one skilled in the art will readily realize that many of the teachings apply to additional electrochemical or electrophysical processing such as anodizing, electroetching, electrocleaning, electrostatic spraying etc. and that the scope of the invention may cover such additional processing despite the embodiments being specifically described in conjunction with electroplating or electrodeposition. Furthermore, electrodeposition can envision depositing a wide variety of materials. These can vary from conductive (such as a metal) to semi-conductive to even non-conductive (such as an electrodeposited paint coating). In the embodiments of this specification electrodeposition will normally refer to a process of depositing a conductive material. Of course one skilled in the art will readily recognize the suitability of any particular embodiment regarding deposition of other materials.

Article 10 has a surface 11 at least a portion of which is to be exposed to an electrochemical process such as electroplating. It may be desirable for example, to coat the entire Article 10 surface 11 with an electrodeposit. Alternatively, Article 10 could constitute a supporting substrate for a surface pattern intended to be electroplated. For the teachings of this invention, an article may be described as having structural characteristics such as planar, film, web-like etc.

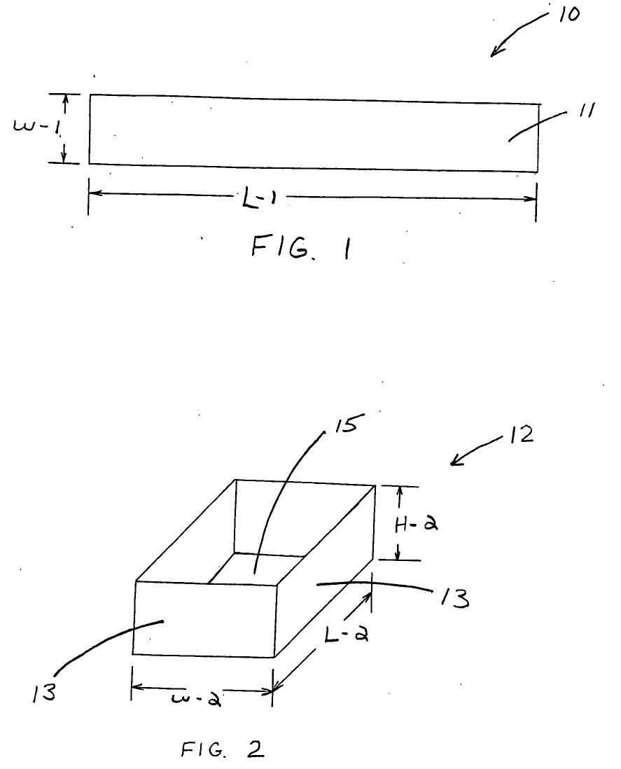

FIG. 2 is a perspective view of an electrochemical bath such as an electroplating bath generally designated by numeral 12. Bath 12 has sidewalls 13 and bottom 15. Bath 12 also has width W-2, length L-2, and height H-2. As may often be the case for convenience, practicality, performance or simple dimensional constraints, the entirety of Article 10 can't be exposed to the electroplating process represented in bath 12 simultaneously. In such cases, simultaneous plating of all portions of Article 10 intended to be plated is prevented. Thus, Article 10 must be electroplated in a sequential or continuous manner whereby at any one time a first portion of Article 10 will be exposed to the plating process, while a second portion remains unexposed to the plating process.

For purposes of this instant specification and claims, continuous or sequential electroplating will be construed as a process wherein at least a first portion of an article is exposed to the electroplating process while at least a second portion of the article remains unexposed to the electroplating process. In order to provide clarity, examples of processing which can be considered within the scope of the definition of continuous or sequential electroplating are presented immediately below in subparagraphs 1 through 3.
(1) Classic roll-to-roll (sometimes referred to as reel-to-reel) electroplating of metal wire or strip. Here, a first portion of the article, now plated, is exiting the bath while a second portion of the article is being plated while yet a third unplated portion of the article is entering the plating process.
(2) A roll-to-roll web process wherein an article is continuously processed by passing the article such as a film or web sequentially or continuously through a plating bath.
(3) A process wherein either the entirety or a portion of the article can be immersed in the plating bath but the article is exposed to or removed from the electroplating process gradually, continuously, or sequentially during the plating cycle. Such a process might be envisioned for example in a case where a gradient of electrodeposit thickness is desired over a distance. Alternatively, in the case of a DER where there is an identifiable growth rate of initial electrodeposit over the surface, such sequential removal could be used to promote uniformity of deposit thickness over an expansive surface.

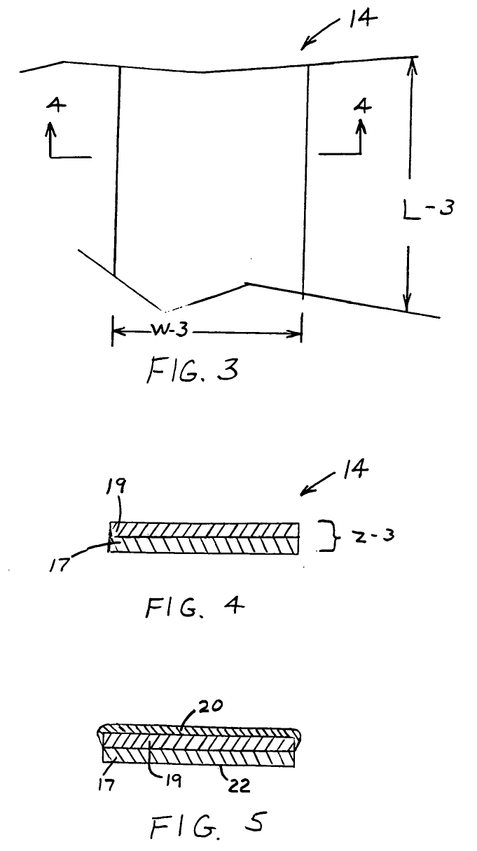

Referring now to FIG. 3, there is shown a top plan view of an article generally designated by numeral 14, having length L-3 and width W-3. In many cases, length L-3 would be considerably greater than width W-3. In addition, length L-3 is often considerably greater than a maximum dimension of an electroplating bath through which it is intended to be processed.

Referring now to FIG. 4, article 14 is shown to have thickness Z-3. Z-3 is often much smaller than either W-3 or L-3 such that article 14 can generally be characterized as a web or film. Such a web or film can be produced by many processes as is know in the art. Examples may include blown film or roll casting techniques, fabric processing techniques and extrusion. It is seen in FIG. 4 that in this embodiment article 14 comprises a laminate of layers 17 and 19. Layer 19 is an electrically conductive material capable of being electroplated (such as a DER). Layer 17 shown can be for example an insulating support layer chosen for any number of functional reasons. One will realize that layer 17 may be omitted depending on the desired result of the subsequent electroplating process.

FIG. 5 shows the FIG. 4 sectional structure following the process step of exposing the FIG. 4 sectional structure to an electroplating process. In FIG. 5, electrodeposit 20 covers the originally exposed surface of material 19. In this and in other embodiments of the present invention the electrodeposit is understood to be either a single layer or multiple layers of material as is understood in the electroplating art. In most embodiments the electrodeposit will be metal-based and conductive. However, it is understood that these multiple layer may comprise non-metallic materials such as an anodized layer. In this embodiment, layer 17 is composed of insulating material so that bottom surface 22 is not coated with electrodeposit. Should it be desired to coat all surfaces of Article 14 with conductive electrodeposit one will understand that insulating layer 17 could be eliminated or replaced with another material capable of being plated, or layer 17 could be sandwiched between top and bottom layers of electroplateable material.

In some cases, it may be desirable to electrodeposit material on only a single side of web 14 but achieve thru web conductivity of the final article. The current invention anticipates that this can be accomplished in one of two ways. First using a layered structure as depicted in FIGS. 4 and 5 one can understand that insulating film 17 could serve as a surrogate support/insulating member during electrodeposition of electrodeposit 20. Following the electrodeposition processing, material layer 17 could be removed to expose conductive material layer 19.

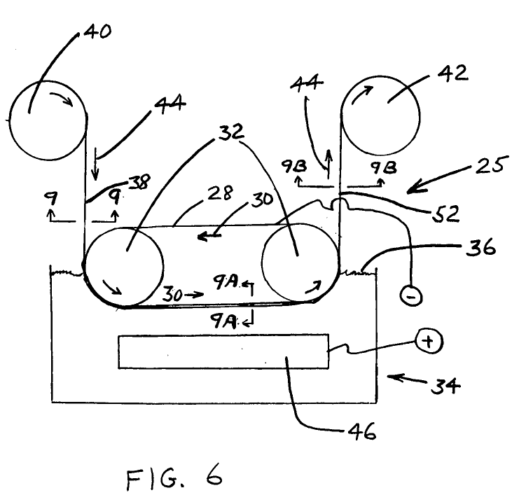

One specific process to achieve single sided electroplating is depicted in FIG. 6. The process of FIG. 6 generally indicated by numeral 25 comprises an electrically conductive belt 28 which is moved in the direction shown by arrows 30 by rollers 32. Conductive belt 28 is normally metallic but could comprise alternate or additional materials. Electroplating process 34 has electroplating solution level 36. It is seen that belt 28 is partially immersed below solution level 36. Overlapping a portion of belt 28 is web or film 38. Web or film 38 comprises an electrically conductive polymer. It is understood that web or film 38 differs from article 14 of FIG. 4 in that at least portions of web or film 38 will exhibit through web conductivity. Web or film 38 is fed from roller 40 through electroplating process 34 and back to take up roller 42 in the direction of arrows 44. Web 38 is now labeled 52 to reflect the change during electroplating process 34. In its region of contact various means of maintaining secure communication between belt 28 and web or film 38 such as a vacuum can be proposed. Belt 28 is made cathodic as shown. Anode 46 is positioned in close proximity with that portion of belt 28 and overlapping web or film 38 within the electroplating process. One realizes that belt 28 could be replaced by alternate means of cathodic contacting such as a drum.

The process depicted in FIG. 6 possesses a number of unique and advantageous characteristics. First, the resistance to electroplating current associated with passage through the web 38 is relatively slight. Thus, plating of the web is relatively rapid. Depending on the line speed of web transport this would allow for very precise control and uniformity of electrodeposited metal thicknesses, including very thin metal deposits. For example, a very thin metallic foil can be envisioned.

In those cases where it is desirable to maintain the combination of electrically conductive polymer/electrodeposit in the final article a DER is a preferred embodiment. Alternately, should it be desired to separate the electrodeposited metal foil from the conductive polymer substrate the conductive polymer substrate can be chosen to promote facile separation of the electrodeposit from the conductive polymer substrate.

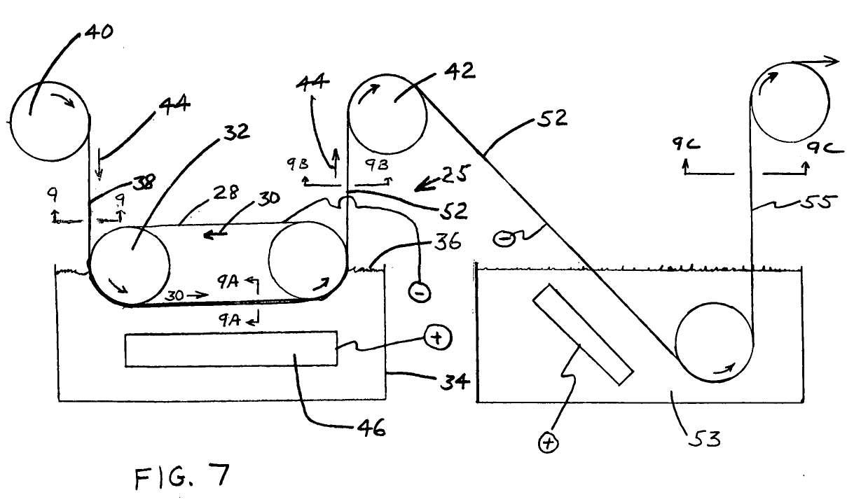

FIG. 7 shows FIG. 6 augmented with an additional electroplating process 53. The purpose of this additional electroplating process will be described below.

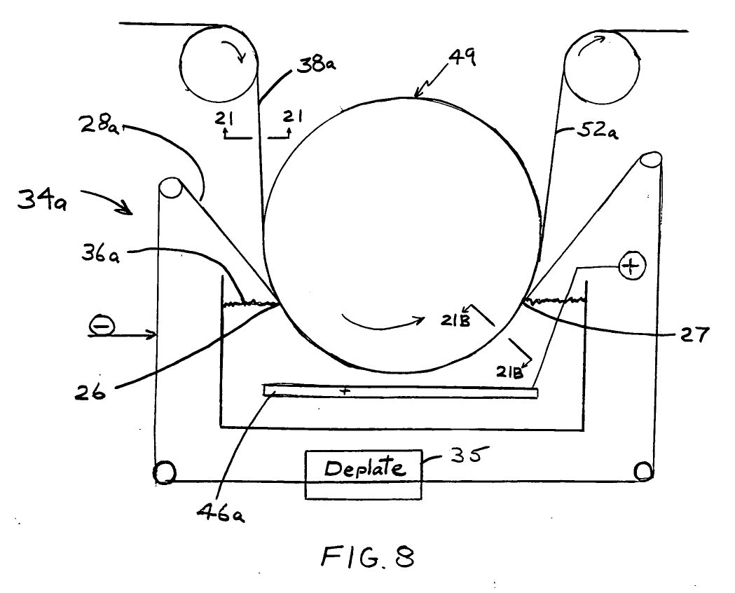

FIG. 8 presents another embodiment of the continuous electroplating of the current invention. In FIG. 8, there is depicted an electroplating process designated as 34a. Electroplating process 34a has solution level 36a and anode 46a. Partially or completely immersed below the level of the solution level is support drum 49. It is understood that drum 49 represents one of a number of transport mechanisms which could be considered to convey an article through an electroplating process as will be known in the art. Drum 49 normally comprises insulating material. Web article 38a is passed into the bath at entry point 26, travels through the electroplating process supported by and around drum 49 and exists the electroplating process at 27. In addition, a continuous conductive wire or strip 28a is caused to pass through the bath around the drum in contact with the exposed surface of web 38a. Wire or strip 28a is at cathodic potential relative to anode 46a. Following the electroplating process 34a, wire or strip 28a is optionally transported through a deplating or stripping process depicted as 35.

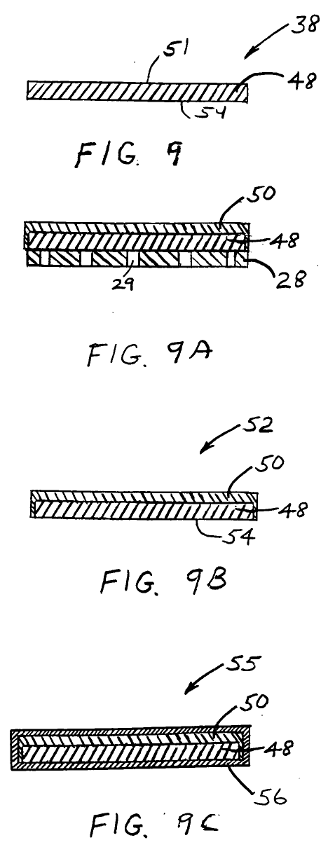

FIG. 9 is a sectional view of web or film 38 prior to its entry into electroplating process 34 of FIG. 6. In FIG. 9 web or film 38 comprises electrically conductive material 48. While shown as a single layer, one will understand that electrically conductive material 48 could consist of multiple layers of differing electrically conductive materials including metals, polymers, etc. In addition, various forms of such materials such as inks, gels, membranes, or foams may be appropriate for use as the electrically conductive material 48. Conductive material 48 comprises a first surface 51 and a second opposite surface 54.

FIG. 9A shows the FIG. 9 structure during the process of FIG. 6. In FIG. 9A it is seen that electrodeposit 50 has coated the exposed surface of electrically conductive material 48. The original web 38 comprising electrically conductive material 48 is securely held to conductive belt 28 by way of vacuum ports 29 as shown in this embodiment.

FIG. 9B is a sectional view of a composite web or film now labeled 52 exiting electroplating process 34. It is seen by comparing FIGS. 9 and 9B that electroplating process 34 accomplishes electrodeposition of electrodeposit 50 onto a single sided surface of original web or film 38 comprising electrically conductive material 48. Surface 54 opposite electrodeposit 50 remains unplated.

The process depicted in conjunction with FIGS. 6, and 9-9B allows for relatively high linear processing speeds of web or film 38. This enables single sided, thin, uniform, electrodeposits on a film which retains through film conductivity. A DER material is particularly advantageous as the exposed surface 51 of web or film 38 intended to be electroplated because it ensures adequate bonding of the rapidly electrodeposited film as well as an electrodeposit which is relatively uniform and hole-free.

Following the electrodeposition process shown in FIG. 6, various additional processing can be considered for the composite web 52. For example, metallic patterns in the form of antennas, circuit traces etc. could then be punched out of composite web 52. This additional processing would allow for the formation of very low-cost circuitry.

It will be clear that if coverage of both sides of web or film 38 were desireable, composite web 52 could be transported to a second electroplating bath instead of takeup onto roll 42 as shown in FIG. 7. In the second electroplating process 53 of FIG. 7, a conductive electrodeposit 50 would serve as an expansive electrical buss to convey the required electroplating current. In this case, the electrically conductive second surface 54 could be rapidly covered with additional electrodeposit 56. This would result in composite web 55 shown in the sectional view of FIG. 9C. FIG. 9C is a sectional view taken substantially from the perspective of lines 9C-9C of FIG. 7. This second operation would not require metal belt 28 shown in FIG. 6. Furthermore, one can appreciate that the electrodeposit 56 can be similar or different in nature than electrodeposit 50. For example, electrodeposit 50 could comprise nickel while electrodeposit 56 could comprise copper.

Should it be desired to fabricate an article having opposite surfaces of different electrodeposits it is understood that during processing in the second electroplating bath the first electroplated surface would need to be prevented from being exposed to the second electroplating solution.

It is understood that while FIG. 7 shows separate plating baths, should the same electrodeposit be desired on both sides a single bath could be considered by combining the two electroplating processes 34 and 53 shown in FIG. 7 into a single bath.

It is also clear that the second electroplating bath shown in FIG. 7 is representative of many alternate processes that may be possible by having the electrodeposit 50 on one surface of composite web 52. For example, electrically conductive surface 54 could allow electrophysical processing such as electrostatic spraying. Electrochemical processing such as electroetching and electrocleaning could be employed using electrodeposit 50 as an electrode. This utilizes the through web conductivity associated with the web or film 38. In addition one will understand that the surface 54 could also be coated with a functional agent that is not electrochemically applied but results in a composite structure employing the electrodeposit 50 as a highly conductive electrode. One will recognize that having a conductive polymeric surface may facilitate the compatibility of the subsequently applied functional agent while still allowing adequate current conveyance from an expansive surface through electrodeposit 50. The ability to combine a highly conductive first surface with a functionally active second surface may be particularly useful for power devices such as batteries, fuel cells, photovoltaic devices etc.

It is also understood that when employing the processes described in conjunction with FIGS. 6-9C the entirety of either the front side or backside surface of web or film 38 does not need to be electrically conductive. Electrodeposition will take place in those areas that are electrically conductive and have through-film/web electrical communication. This is explained further in the following discussion relating to the embodiments of FIGS. 10-20.

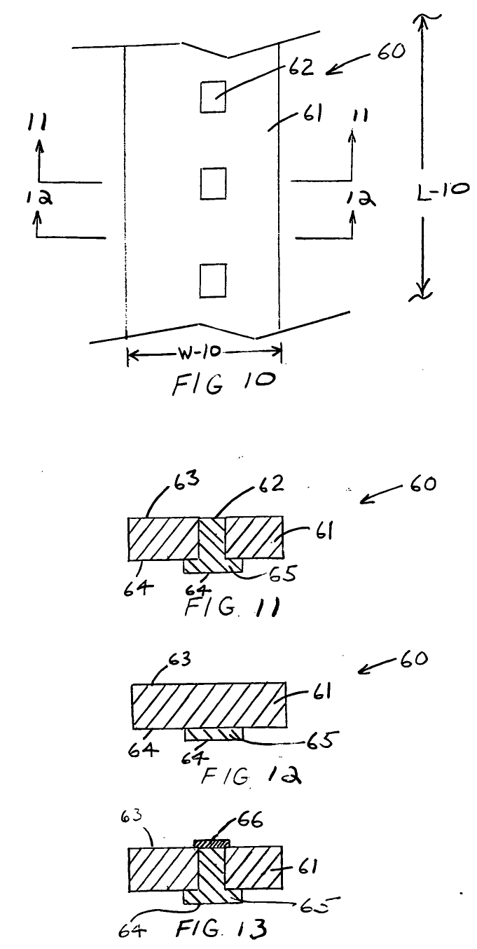

In FIG. 10 there is shown a top plan view of an article generally designated as 60. Article 60 is characterized as having length L-10 and width W-10. Typically L-10 would be greater than W-10 such that article 60 can be processed in an essentially continuous manner. Article 60 comprises insulating web 61 and selective patterns 62. This structural arrangement is further shown in the sectional drawings of FIGS. 11 and 12.

FIG. 11 shows a sectional view substantially from the perspective of lines 11-11 of FIG. 10. FIG. 11 shows that the selective pattern structure 62 is formed by electrically conductive material 65 extending thru insulating web 61 from top surface 63 to bottom surface 64.

FIG. 12, a sectional view taken substantially from the perspective of lines 12-12 of FIG. 10, shows that conductive material 65 extends continuously along length L-10 of Article 60 on bottom surface 64. This continuity of structure associated with bottom surface 64 along length L-10 is optional.

FIG. 13 is a view following exposure of the FIGS. 10-12 structure to an electroplating process such as that depicted in FIG. 6. In this process one recognizes that bottom surface 64 shown in FIGS. 11 and 12 is caused to contact the belt 28 of FIG. 6. This positioning causes the surface of selective patterns 62 exposed on the top surface 63 of article 60 to be rendered cathodic during their exposure to the electroplating solution. Thus, electrodeposit 66 is deposited as shown in FIG. 13. The electroplating current is conveyed thru the insulating web 61 by conductive material 65 in contact with belt 28 on the bottom surface 64 of article 60.

FIGS. 14 through 16 show an alternate embodiment of the process and structure explained in FIGS. 10 thru 13. FIG. 14 is a view similar to FIG. 11 showing a sectional view of an article generally designated as 60a. Article 60a has electrically conductive material 65a extending through insulating web 61a from top surface 63a to bottom surface 64a. Electrically conductive material 67 forms a portion of bottom surface 64a. Material 67 is different from material 65a in the FIG. 14 embodiment.

FIG. 15 is a view similar to FIG. 14 following exposure of the FIG. 14 structure to an electroplating process such as that depicted in FIG. 6. As with the structure in FIG. 13, electrodeposit 66a has coated the exposed surface of material 65A extending to top surface 63a of insulating web 61a. Material 67 remains unplated in the view shown in FIG. 15.

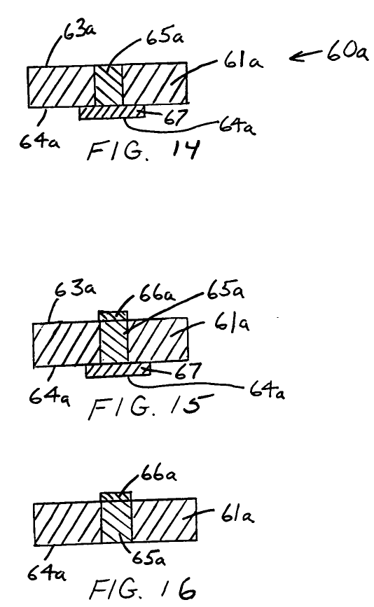

The results of an optional additional process are shown in FIG. 16. Here the material 67 originally extending over a portion of bottom surface 64a along length L-10 has been removed. Proper selection of material 67 would allow facile removal of material 67 as shown.

FIG. 17 shows yet another embodiment of process and structure associated with FIGS. 6 and 7. In FIG. 17 an article generally designated as 68 is shown in top plan view. Article 68 has length L-17 and width W-17. Typically length L-17 would be greater than width W-17. Article 68 comprises insulating web 69 and electrically conductive stripe material 70 extending in the length L-17 dimension.

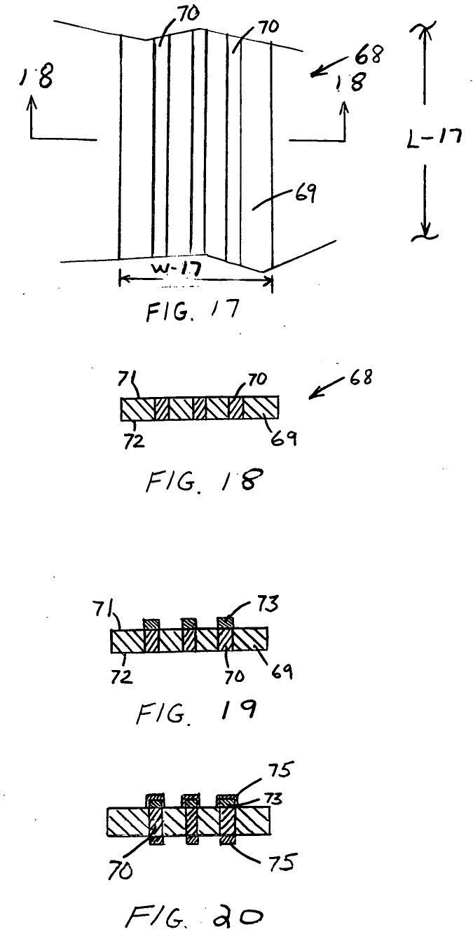

FIG. 18 shows a sectional view of article 68 taken substantially along the lines 18-18 of FIG. 17. FIG. 18 shows that article 68 has top surface 71 and bottom surface 72 and stripes of electrically conductive material 70 extending from top surface 71 to bottom surface 72.

Exposing the structures shown in FIGS. 17 and 18 to an electroplating process such as that depicted in FIG. 6 results in the sectional structure shown in FIG. 19. In FIG. 19, electrodeposit 73 is shown to result from this process step. Electrodeposit 73 forms on the surfaces of stripe material 70 which have been exposed to the electroplating bath. One recognizes that one process employed in achieving the structural change from that shown in FIG. 18 to that shown in FIG. 19 involves positioning of bottom surface 72 of article 68 in contact with belt 28 of FIG. 6. Electroplating current associated with electrodeposit 73 is conveyed from the exposed top surface 71 of conductive stripe 70 of article 68 through insulating web 69 to bottom surface 72 which itself is in contact with belt 28 thereby allowing the electrodeposition shown but preventing electrodeposition of the electrically conductive material 70 on the bottom surface 72 of article 68.

FIG. 20 is a view of the FIG. 19 structure following the additional optional process step of exposing the FIG. 19 structure to a second additional electroplating bath such as that depicted in FIG. 7. In FIG. 20, it is seen that additional conductive electrodeposit 75 now coats the bottom surface of material 70 as well as the surface of conductive electrodeposit 73 originally shown in FIG. 19. It is understood that electrodeposit 75 would not coat initial electrodeposit 73 if electrodeposit 73 is prevented from being exposed to the electroplating solution.

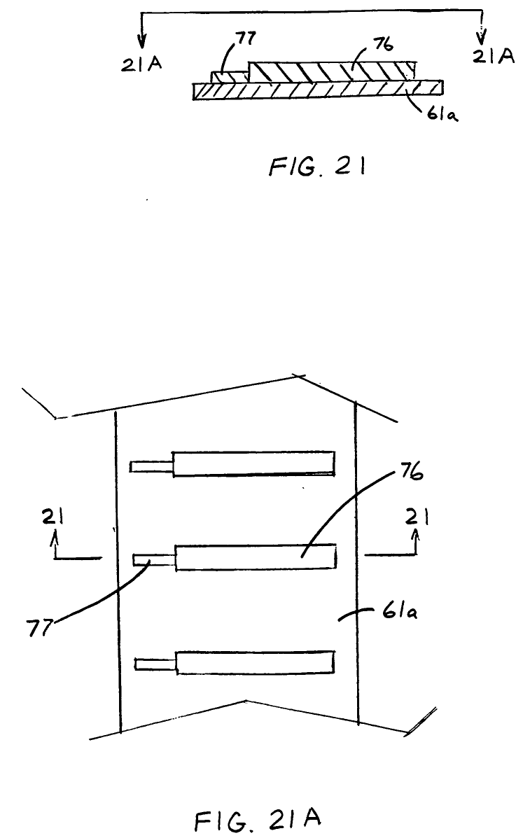

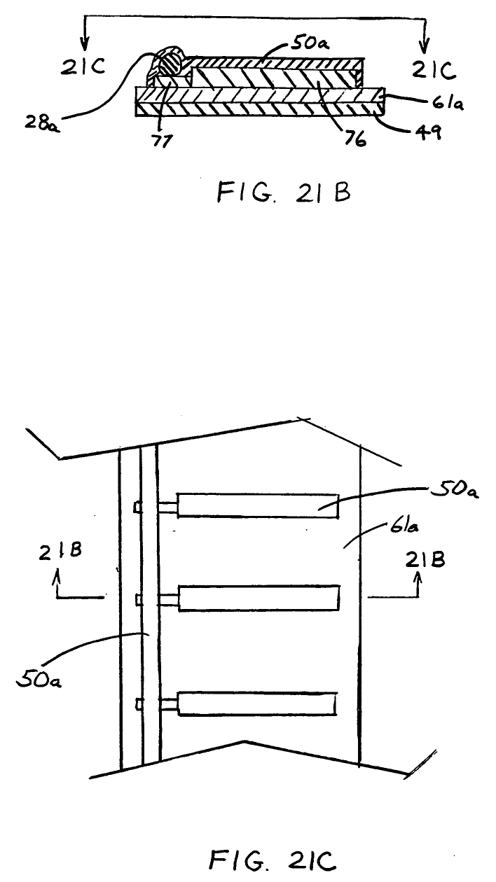

FIG. 21 is a sectional view taken substantially from the perspective of lines 21-21 of FIG. 8. FIG. 21A is a top plan view taken substantially from the perspective of lines 21A-21A of FIG. 21. It is seen from FIGS. 21 and 21A that, prior to entry into electroplating process 34a, web 38a consists of patterned structures 76 supported on insulating support web 61a. In this embodiment, patterned structures 76 comprise electroplateable material. Patterned structures 76 include extensions 77 projecting laterally over the insulating web 61a as shown.

FIG. 21B is a sectional view taken substantially from the perspective of lines 21B-21B of FIG. 8. FIG. 21C is a top plan view taken substantially from the perspective of lines 21C-21C of FIG. 21B. It is seen from FIGS. 21B and 21C that conductive wire or strip 28a overlaps and contacts extensions 77 to supply cathodic potential and convey electroplating current from individual patterned structures 76. Electrodeposit 50a now coats the originally exposed electroplateable surfaces of patterned structures 76 and wire or strip 28a.

Upon exiting the bath, composite web 52a, now having attached electrodeposit 50a is separated from wire or strip 28a. The composite web 52a is then conveyed as appropriate. Wire or strip 28a is optionally conveyed through a “deplating process” 35 to remove electrodeposit and recycled back to the bath. In this way wire or strip 28a acts as a buss to electrically join the individual patterned structures 76 to the source of cathodic potential during the electroplating process.

In the process and structural embodiments of FIGS. 21 through 21C it will be understood that “through-web” conductivity is not required. Also, in these embodiments it may be advantageous to closely match the linear speed of the wire or strip to that of web article 38a as it pass through electroplating process 34a. This is a consideration in those cases where structural patterns 76 comprise electroplateable material having relatively low conductivity. In such cases, slippage between the wire or strip and the extensions 77 may cause difficulty in achieving adequate electrodeposit “bridging” between these items as discussed above. Even in the case where the extensions comprised material of relatively high conductivity, such as a silver based ink, slippage between the wire or strip 28a and extensions 77 may cause problems. In these cases the extension structure may be relatively thin and the slippage may cause the wire or strip to cut through the extension or give erratic contact due to resulting abrasion.

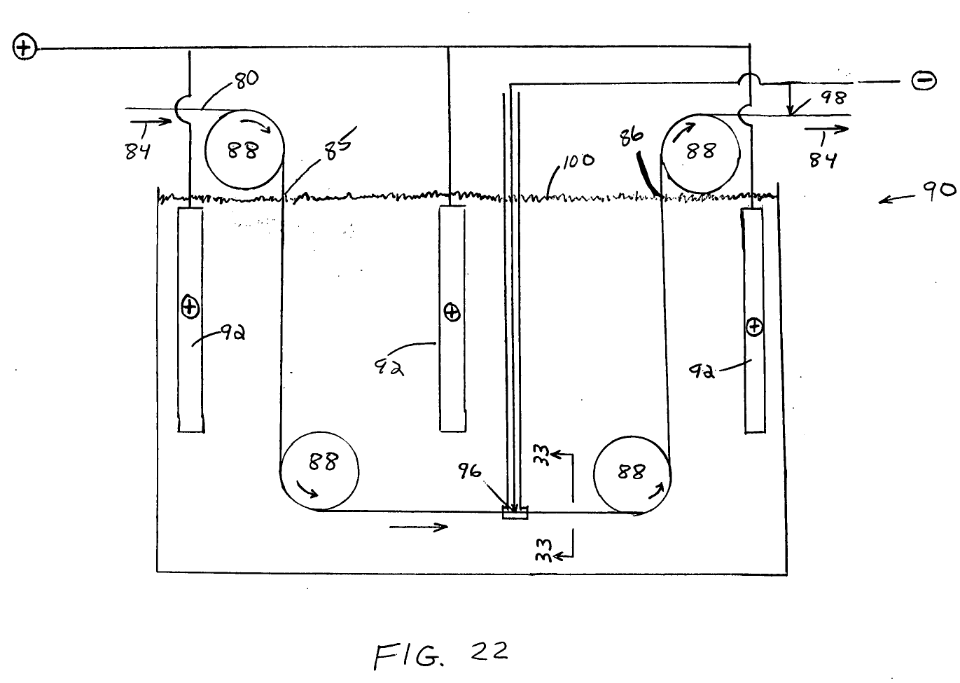

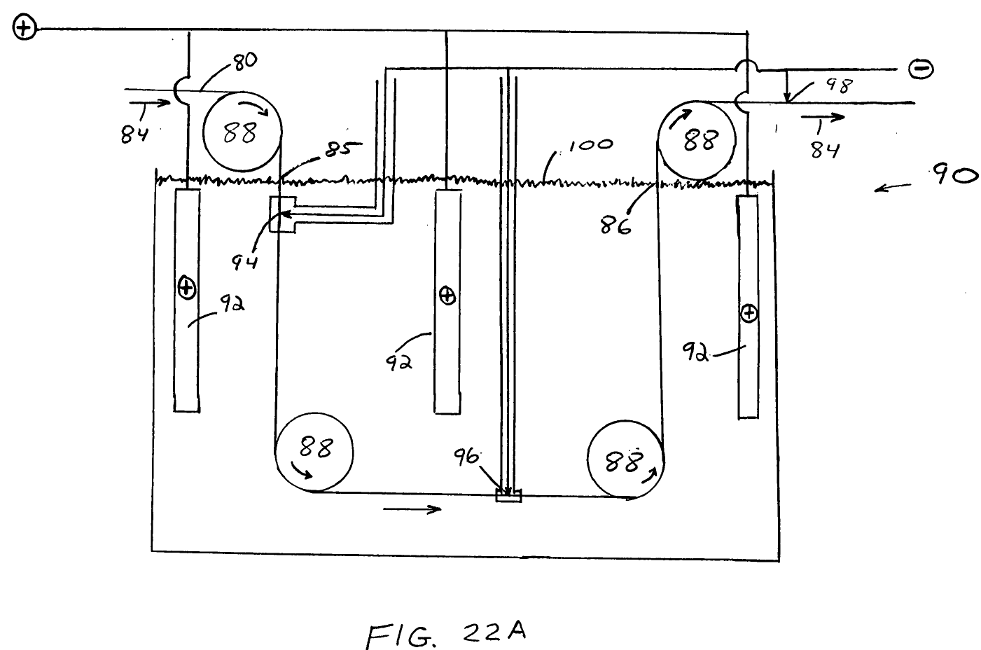

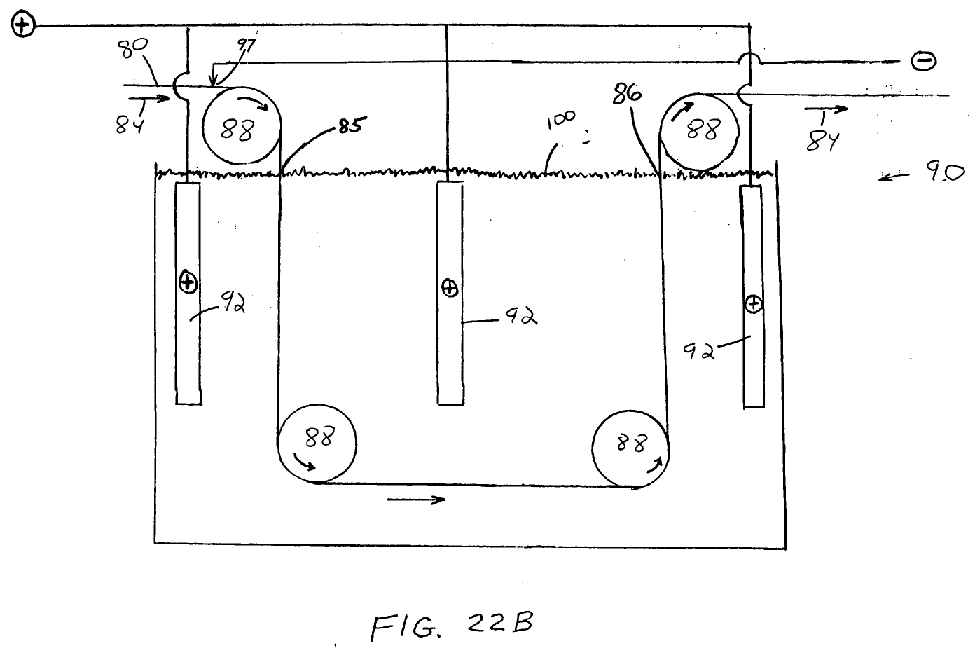

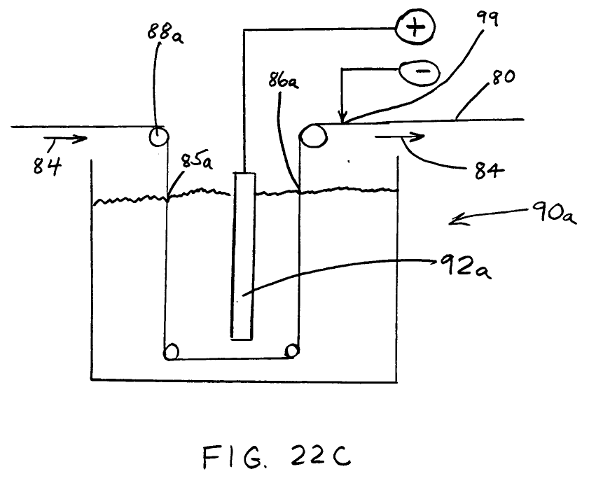

FIG. 22 is a representation of another electroplating bath and process used to process embodiments of the current invention. In FIG. 22 it is seen that article 80 having a film or web like structure is transported through an electroplating process generally designated as 90 in the direction as indicated by arrows 84. Article 80 enters electroplating process 90 at entry point 85 and exits at exit point 86. Rollers 88 serve to transport the web through electroplating process 90 as shown. Electroplating process 90 utilizes anodes 92 as indicated by the positive polarity shown. Cathodic contact in this embodiment is made at two points. The first contact 96 is immersed under the level of the electroplating solution 100. The second cathodic contact 98 is positioned on article 80 following its exit from the electroplating bath. One will appreciate that multiple contacts 96 and 98 may be used to advantage especially in light of the “sliding” or moveable nature of these contacts and the current transport requirements of electroplating process 90 as discussed more fully below.

In FIG. 22 contact 98 if used alone (absent contact 96) may prove incapable of adequately transporting the necessary electroplating current associated with electroplating process 90. First contact 98 may be separated by a relatively extended distance from areas of active electrodeposition. Thus excessive resistive heating losses may occur during the transport of electroplating current from contact 98 thereby disrupting the integrity of the contact. In addition a detrimental voltage difference over the electroplating surface may result. The extent of this problem will depend on a number of factors including line speed, the surface being actively electroplated, and linear distance from the contact to the growth front.

Thus in FIG. 22 additional contact 96 is shown immersed under the level of the plating solution. The function of contact 96 is to convey current associated with the electrodeposition of article 80. Since contact 96 is immersed in the plating solution, it will be easier to maintain the integrity of the contact. It will be understood that contact 96 can be used alone or in conjunction with contact 98.

The electroplating process depicted in FIG. 22 differs from that depicted in FIG. 6. In the process of FIG. 6, cathodic electroplating current must traverse only through the thickness of the relatively thin web 38 as understood from the sectional views of FIGS. 7 through 8. The resistance to current transport over this relatively small distance can be insignificant and the web may cover with electrodeposit relatively quickly. In the case of the FIG. 22 process, it is often necessary that current be conveyed from contacts 96 or 98 over a distance which may be significant as discussed below.

FIG. 22A adds contact 94. As shown, contact 94 is positioned slightly below the solution level of the bath close to the entry point 85 of article 80. Contacts 96 and 98 remain as shown in FIG. 22. The significance of the positioning of contact 94 will be discussed below.

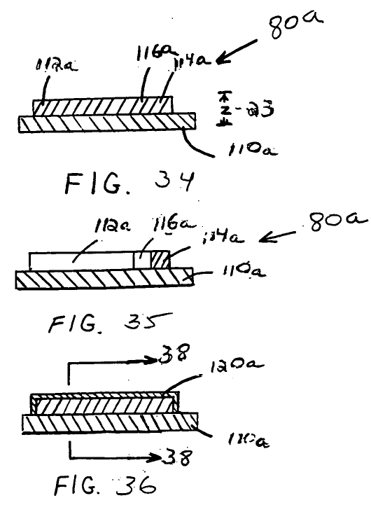

The discussion of the physical electrochemical characteristics of the FIG. 22 process is facilitated by reference to a specific embodiment of the film or web like structure of article 80. One such specific embodiment is identified generally by the article designated by numeral 80a of FIG. 23. FIG. 23 is a top plan view of article 80a. Further clarification of the structural aspects of article 80a can be seen by reference to FIG. 34 a sectional view taken substantially from the perspective of lines 34-34 of FIG. 23 and FIG. 35 a sectional view taken substantially from the perspective of lines 35-25 of FIG. 23. Article 80a is characterized by having length L-23 and width W-23. It is contemplated that length L-23 is greater than width W-23 such that article 80a can be processed in an essentially continuous fashion such as the electroplating process shown in FIG. 22. Article 80a comprises insulating web substrate 110a upon which structural patterns 112a have been selectively positioned. Selective structural patterns 112a may comprise any number of electroplateable materials. For example, patterns formed by electroplateable metal objects, electroplateable polymeric materials, or DER's can be considered.

As one of normal skill in the art will understand, in order for the patterns 112a to be electroplated, there has to be electrical communication between patterns 112a and a source of cathodic potential or contact. In the present embodiment, electrical buss structure 114a and fingers 116a serve to provide electrical communication between the selective patterns 112a and the source of cathodic potential or contact. Electrical buss structure 114a extends along the length of article 80a and connects to individual selective patterns 112a thru fingers 116a. Fingers 116a may not be required if selective patterns 112a are in direct contact with buss 114a. Buss 114a and fingers 116a may comprise electroplateable material. However, they may also comprise any material capable of transporting the necessary current to allow for electroplating such as a coated metal wire or strip. The purpose and use of these buss structures and/or fingers will be discussed in greater detail in further embodiments.

Materials used for 112a, 114a, and 116a do not necessarily need to be the same. Furthermore, 112a, 114a and 116a are shown to have simple rectangular cross sections. This presentation is appropriate to simplify the teachings of the present invention. However, one will recognize that more complex structure can be used.

Considering now the processing of web 80a through electroplating process 90 of FIGS. 22 and 22A, it will be appreciated that cathodic electroplating current may be required to traverse a considerable distance in the length direction L-23 from contact such as identified by 96 or 98. Should the conductive material used for buss 114a of article 80a be highly conductive such as a metal or metal-based material, this distance of current transport may not be significant. In this case the resistance to current transport is slight, perhaps to the point where the potential is essentially constant throughout the length of buss 114a actively transporting current. However, should the conductive material forming buss 114a be less conductive than typical metals, or be very thin, it may not be capable of adequately conveying the electroplating current without large potential differences along length L-23. In this case the conductive electrodeposited metal may be expected to carry a large portion of the cathodic electroplating current through buss 114a to contacts 96 and 98.

Thus, an arrangement such as depicted in FIG. 22B may be improper. FIG. 22B shows a single contact 97 positioned on article 80 prior to its entry into the plating bath. Contacts 94, 96, and 98 shown in FIGS. 22 and 22A have been omitted in the embodiment of FIG. 22B. Electrodeposit is absent at contact point 97 and the material forming buss 114a may be incapable of transporting the required electroplating current to contact 97. Thus contact 97 positioned where there is no electrodeposit may not contribute in any significant way to current transport.

The ability for the conductive electrodeposit to adequately carry the required cathodic electroplating current depends on its thickness as well as the conductivity of the electrodeposited metal employed. The conductive electrodeposit thickness at any particular point in the FIG. 22 processing depends on current density, efficiency and elapsed time under processing. Thus in a process such as depicted in FIG. 22 the conductive electrodeposit thickness is typically very thin to non-existent shortly after entry into the solution at point 85 of FIG. 22 and thickest at the exit point 86. Because of this gradient in conductive electrodeposit thickness, it is possible when using electroplateable materials of relatively low conductivity to define buss 114a of article 80a to experience a significant difference in potential between the plating surfaces immediately adjacent to a contact such as 96 and those remote from the contact, especially in the upstream (opposite of web travel) direction where the conductive electrodeposit may becomes progressively thinner. Again, this is a result of the inability of a low conductivity material of buss 114a to contribute significantly to current transport. A similar situation would occur should the materials used to define buss 114a be of higher conductivity but of reduced cross sectional area perpendicular to the current flow.

Many DER materials can be characterized as relatively low conductivity materials wherein conductive electrodeposit coverage is achieved by lateral electrodeposit growth over the surface with the conductive electrodeposit carrying a large portion of the electroplating current to/from the cathodic contact. This situation could also exist even for relatively higher conductivity materials, such as a particulate metal filled polymer, should the current be required to traverse an extended distance through a restricted cross section. It is currently believed that the speed of this lateral growth is at least partially dependent on the driving potential difference between the solution and the DER surface at the advancing electrodeposit growth front. Typically the higher the driving potential difference, the more rapid the rate of lateral growth. It will be appreciated that in a process such as depicted in FIG. 22, the more rapid the rate of lateral conductive electrodeposit growth upstream (opposite the web travel direction) away from the initial cathodic contact, the more rapidly the web can be conveyed through the bath. The rate of lateral growth would not normally be exceeded by the linear web speed. Thus it is informative and helpful to consider ways in which the driving potential can be maintained at acceptable levels at the electrodeposit growth front.

A first way to maintain an acceptably high driving potential at the electrodeposit growth front is to simply increase the overall rectified potential applied to the bath. This will tend to raise the growth front potential, but is counteracted to some extent by the increased IR drop from the growth front to the initial cathodic contact due to the inevitable increased current densities on surfaces already plated between the growth front and cathodic contact. This method is also restricted in that current densities in those portions where the voltage drop is less of a factor (for example downstream from the initial contact) may be caused to exceed desirable values.

A second way to achieve acceptably high driving potential at the growth front is to reduce the distance between the cathodic contact and the growth front. This decreases the distance over which current must be conveyed thereby reducing potential loss. This often happens in normal practice, wherein a very complicated combination of affecting parameters such as web speed, applied potential, bath and material chemistry, etc. effectively cause the growth front to “find its place” at some distance from the initial contact. Nevertheless, for optimum bath utilization, one may want to consider positioning the first cathodic contact as far “upstream” as practical in the process of FIG. 22. This is shown in FIG. 22A. In FIG. 22A additional contact 94 is positioned slightly below point 85 where article 80 enters the electroplating process 90. In the embodiment of FIG. 22a the article 80 shown is the same as article 80 used to describe the operation of the FIG. 22 embodiment. It is understood that contact 94 is positioned sufficiently distant from entry point 85 such that the electrodeposit growth front on buss structure 114a is upstream (opposite web travel direction) of contact 94. Thus contact 94 is in electrical communication with conductive electrodeposited material. The distance between contact 94 and the electrodeposit growth front can vary depending on a number of factors including applied voltage, web speed, bath chemistry and the material and structure of buss 114a. Typically in order to maintain acceptable manufacturing tolerances regarding the linear growth front speed and to achieve an acceptable thickness of electrodeposit at contact point 94 the linear distance between entry point 85 and contact 94 would be typically of the magnitude of 10 inches.

One will recognize that while the embodiments above of article 80a involve the plating of a buss structure, the teachings could also be applied to plating other structures in a continuous manner such as an entire web or film.

Yet another method to achieve acceptably high driving potential at the growth front is demonstrated in FIG. 22C. In this embodiment electroplating process 90a is intended to accomplish simply an initial electrodeposit “strike” over the surfaces of articles such as that of 80a depicted in FIG. 23. As is known in the art, an electroplating strike bath is not necessarily intended to deposit the thickness of electrodeposit required for the final article but is intended instead to simply cover the article. In this particular case contact 99 is made following exit of web 80 at exit point 86a. The web length immersed in the bath between entry point 85a and exit point 86a is adjusted such that the residence time is sufficient to allow electrodeposition of buss 114a and structures 112a without requiring that electrodeposit thickness be increased in process 90a. Thus the amount of current transport required of buss 114a to contact 99 is manageable. The combination of strike process 90a and subsequent process 90 such as shown in FIG. 22 accomplishes two beneficial results. First, contacting of the buss and current management may be made easier by separating the process associated with the initial strike from that employed to increase thickness of the electrodeposit. Second, using a “strike” bath in combination with a subsequent “buildup” bath allows the strike electrodeposit to be different from the subsequent electrodeposit which may constitute a large portion of the electrodeposited material. For example, the strike deposit may be nickel while the subsequent electrodeposit could comprise copper.

Yet another method to achieve acceptably high driving potential at the growth front is demonstrated in FIGS. 22D and 24-26. These Figures teach the use of a shield to delay the electroplating of a portion of the structure intended to be eventually electroplated. This will reduce IR potential differences along the buss from the growth front to the initial contact by reducing the surface area being electroplated.

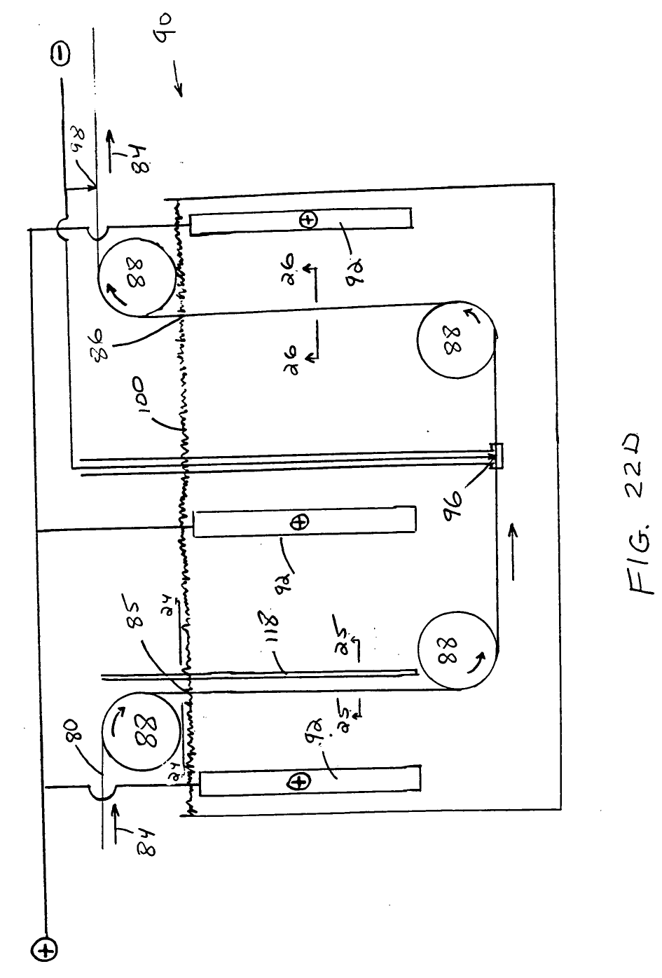

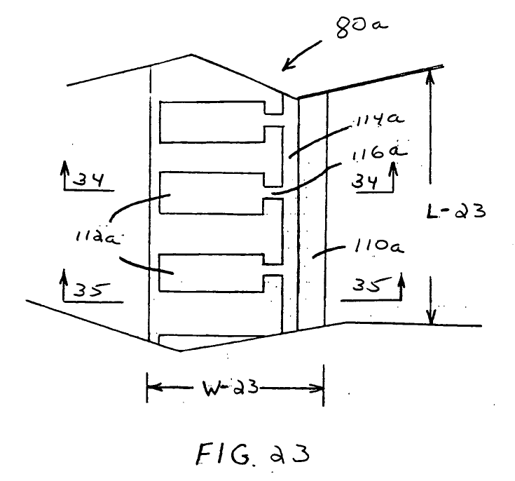

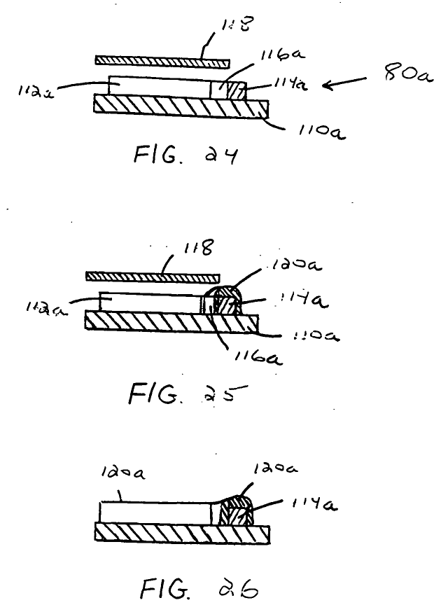

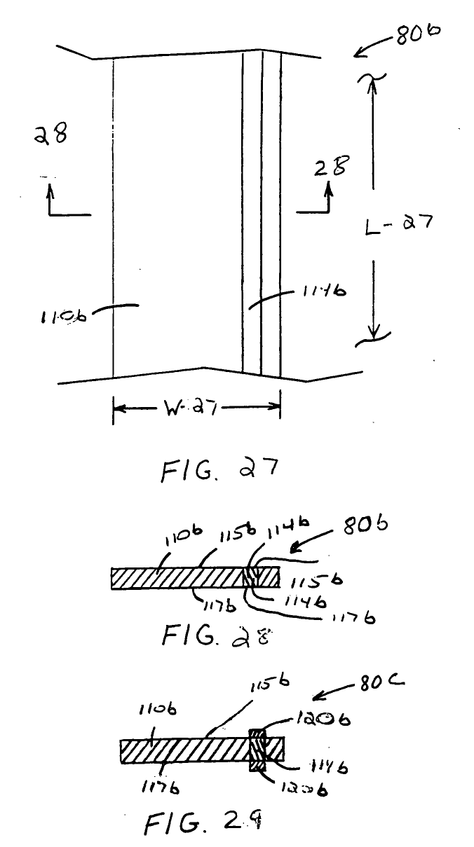

FIG. 24 is a sectional view taken substantially from the perspective of lines 24-24 of FIG. 22D. FIG. 24 shows buss 114a, finger 116a, and selective patterns 112a supported on insulating substrate 110a. FIG. 24 also includes the shield 118 of FIG. 22D. Shield 118 inhibits electrodeposition on pattern 112a and finger 116a but not on buss 114a. This situation exists for some period during transport of article 80a after entering electroplating process 90.

FIG. 25 is a sectional view taken substantially from the perspective of lines 25-25 of FIG. 22D. FIG. 25 shows the preferential deposition of conductive electrodeposit 120a onto buss 114a. In FIG. 25 it is seen that shield 118 still impedes deposition on pattern 112a but that conductive electrodeposit 120a may extend slightly onto finger 116a. However, it is clear that in certain instances conductive electrodeposit 120a may extend onto at least a portion of pattern 112a.

FIG. 26 is a sectional view taken substantially from the perspective of lines 26-26 of FIG. 22D. FIG. 26 shows the condition that develops after transport of article 80a past shield 118. In FIG. 26 conductive electrodeposit 120a is seen to extend over the surface of pattern 112a, fingers 116a, and buss 114a. However, the thickness of conductive electrodeposit 120a is greater on the surface of buss 114a than that on the surface of pattern 112a.

There are a number of reasons why one may consider using the shielding process depicted in FIGS. 24 through 26. First, it is often desired that the metal thickness across structural pattern 112a be as uniform as possible. In some instances this may be difficult using certain DER compositions or other materials of low conductivity, especially if structural pattern 112a is characterized by a relatively expansive surface. Many materials, including many DER's, are relatively resistive without any conductive electrodeposit 120a. Furthermore, after a short period of electrodeposition the conductive electrodeposit is still relatively thin and incapable of transporting large amounts of electroplating current. For the best quality of electrodeposit the current density should be held within an optimal range. Should the structural pattern 112a be separated from the electrical cathodic contact through a relatively long length of relatively resistive buss existing immediately after electrodeposit coverage, a large voltage could be required to maintain the optimal current density on that particular pattern. However, the same overall potential setting could cause an unacceptable increase in current density on those patterns positioned closer to or downstream from the cathodic contact. This lack of control of current density could be detrimental to the optimal production of the plated pattern. If structural pattern 112a is allowed to cover simultaneously with buss 114a a significant voltage drop could be required to transport the total electroplating current to/from the cathodic contact. This could result in reduced lateral growth of the initial electrodeposit, reduced electroplating current densities, extension of plating times, and loss of electrodeposit thickness control over the patterned articles. The prior preferential electroplating and consequent thickness increase of the buss compared to the pattern structure alleviates this problem.

As discussed in FIG. 23, in order for a structure to be electroplated there must be electrical communication between the structure and a source of cathodic potential. The embodiments shown in FIGS. 27-59 will further teach the use of buss structures which are an eminently suitable means of achieving the electrical communication necessary for continuous electroplating. In preferred embodiments it will be shown that DER's often offer a uniquely suitable material choice from which to fabricate such busses. As is well know in the art, a buss can take many forms or shapes. In the following embodiments it will be recognized that structures referred to as “fingers” are simply further components of the buss structure.

FIG. 27 is a top plan view of an article generally designated as 80b. Article 80b has length L-27 and width W-27. In this embodiment L-27 is greater than W-27 such that article 80b can be processed in a continuous “roll-to-roll” process such as that depicted in the embodiments of FIGS. 22-22D. Article 80b comprises buss structure 114b positioned in conjunction with insulating web 110b. Buss 114b comprises conductive material. Examples of conductive material include metals and conductive polymers. In a preferred embodiment buss 114b comprises a DER. One will recognize that buss 114b differs from buss 114a in that buss 114b extends through insulating web substrate 110b.

FIG. 28 is a sectional view taken substantially from the perspective of lines 28-28 of FIG. 27. As indicated in FIG. 28, article 80b can be characterized as having a substantially flat, planar structure. Buss 114b extends from top surface 115b to bottom surface 117b. One way of producing such a structure as depicted in FIGS. 27 and 28 is by well known “striping” technology employed with co-extrusion of plastic resins.

While the embodiments of FIGS. 27 and 28 have buss 114b extending from top surface 115b to bottom surface 117b of article 80b, this need not necessarily be the case. In other embodiments appropriate for the processing as depicted in FIG. 22, either one or both surfaces of web 80b could comprise electroplateable material. Other methods to form the electroplateable material associated with web 80b include printing, coating, laminating, extrusion and injection molding.

FIG. 29 is a sectional depiction of the article 80b following processing according to the embodiments of FIGS. 22-22D. It is seen in FIG. 29 that conductive electrodeposit 120b has now coated buss 114b on both the top and bottom surfaces of the article now referred to as n to reflect this change. FIG. 29 represents a preferred example of a pre-formed buss structure.

It is understood that article 80b could also be processed according to the process set forth in FIGS. 6-7 to achieve a result similar to that shown in FIG. 29. This is because article 80b has through web conductivity. Other embodiments of continuously electroplated articles of the invention, discussed below, do not exhibit through web conductivity and can be processed by the approaches such as those described in the embodiments of FIGS. 22-22D.

As will become clear in light of the teachings to follow, a preformed, essentially continuous buss can serve as an important feature for certain embodiments of the current invention. It will be clear in light of the teachings to follow that the buss structures taught may also serve as a continuous “rack” for electrical positioning of discrete articles for continuous processing. Separating the fabrication of the buss from the subsequent articles to be plated has certain advantages. For example, the buss can be made much more conductive than the subsequent articles to be plated. The buss can be a highly conductive material such as a metal or a conductive particulate metal filled ink. The buss could also be fabricated using an electroplateable material that plates more readily than the appended structure intended for plating. The buss can also be plated prior to application of appended plateable structure thus resulting in a high conductivity for the buss. The use of a buss comprising material more conductive than the appended plateable structure would help alleviate some of the processing issues related to plating a relatively resistive material which were discussed in FIGS. 22-22D. A pre-plated buss can be initially plated with a different material than that intended for the appended plateable structure. Finally, in many cases since the buss is intended to be separated and discarded, inexpensive materials can be chosen for the buss.

FIGS. 30-33 show one application for the preformed buss discussed in FIGS. 27-29. FIG. 30 is a plan view of an article designated as 80d suitable for processing according to the FIG. 22 process embodiment. FIG. 30 shows buss 114d, and additional structural patterns 112d supported by insulating web 110d.

FIG. 30A is a sectional view taken substantially from the perspective of lines 30A-30A of FIG. 30. FIG. 30A shows article 80d to comprise a generally planar structure similar to that depicted as 80b in FIG. 27. Article 80d comprises insulating web portion 110d and a buss 114d comprising electroplateable material coated with conductive electrodeposit 120d. Article 80d also comprises additional structural patterns 112d extending to overlap a portion of conductive electrodeposit 120d of buss 114d. Structural patterns 112d comprise electroplateable material such as a metal or conductive polymer. However, it is clear that the electroplateable material associated with structural patterns 112d does not have to be the same as the material forming buss 114d. The overlap of structural patterns 112d onto conductive electrodeposit 120d allows for electrical communication between conductive electrodeposit 120d and the electroplateable material of structural patterns 112d. While article 80d is specifically directed towards an electroplating process one recognizes that the preformed buss structure as shown in FIGS. 27-29 may be effectively employed for many continuous electrical processes. For example, buss structure 114d could be employed to subject structural patterns 112d to an anodizing process. Alternatively electropainting, electrocleaning, or electroetching would be typical processes within the scope of the current invention.

Passing an article which contains a buss such as article 80d through an electrical process while maintaining potential on the conductive electrodeposit 120d will cause an electrically induced change of the structural patterns 112d. For example, passing article 80d through the electroplating process of FIG. 22 while maintaining potential on the conductive electrodeposit 120d at contacts 96 and/or 98 will result in the electroplating of the electroplateable material associated with structural patterns 112d. This results in the structure shown in section in FIG. 31. In FIG. 31 it is seen that at least a portion of structural patterns 112d originally formed from electroplateable material has been coated with electrodeposit 121d. It is noted that since conductive electrodeposit 120d is essentially pure metal and highly conductive, from a practical standpoint the potential at every structural pattern 112d at its point of contact with buss 114d will be effectively the same throughout the processing. Thus potential variations along the web length discussed above will likely not be a concern with this embodiment. The result may be more rapid throughput and more precise electrodeposit properties on structural patterns 112d.

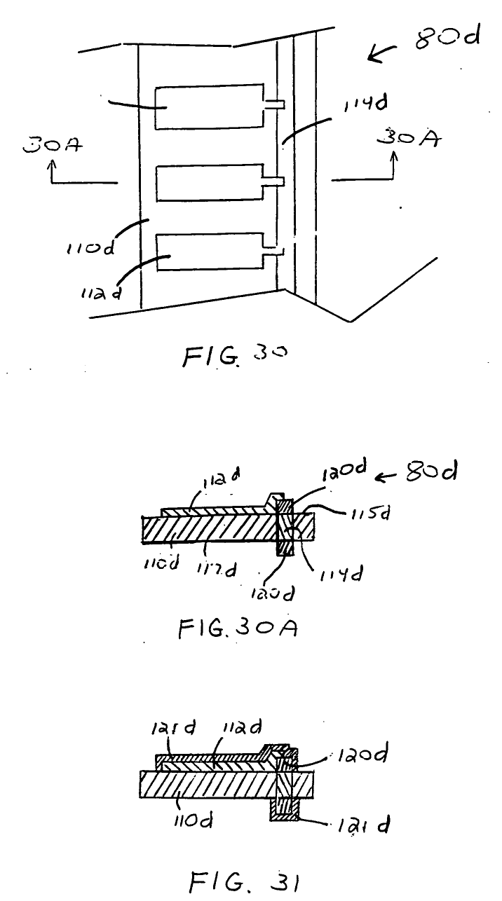

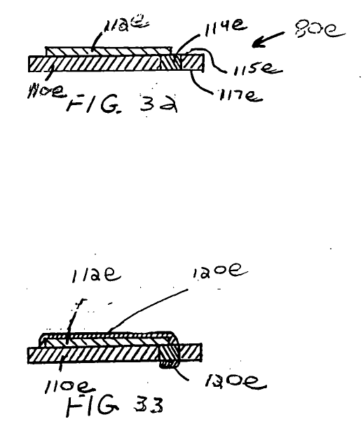

FIGS. 32 and 33 depict an alternate embodiment. FIG. 32 is a sectional view of an article 80e comprising a structure similar to that of FIG. 28. In a fashion similar to article 80b of FIG. 28, article 80e can be processed continuously in a process such as depicted in FIG. 22. Article 80e comprises insulating web 110e and buss 114e extending through web 110e from top surface 115e to bottom surface 117e. Buss 114e extends in a length direction similar to buss 114b of the FIG. 28 embodiment. Buss 114e comprises electroplateable material. In addition, article 80e includes structural patterns 112e slightly overlapping and extending outward from buss 114e over the surface of insulating web 110e. Structural patterns 112e comprise electroplateable material that may differ from the electroplateable material of buss 114e. FIG. 33 shows the result of passing the structure depicted in FIG. 32 through a process such as that depicted in FIG. 22. It is seen in the sectional view of FIG. 33 that conductive electrodeposit 120e now coats the exposed surface of electroplateable material forming at least a portion of the originally exposed surface of structural patterns 112e. Conductive electrodeposit 120e also coats the originally exposed surface of the electroplateable material associated with buss 114e.

The embodiment shown in FIG. 32 differs from the embodiment of FIG. 30A. In the case of the FIG. 30A embodiment, conductive electrodeposited buss 114d comprises a pre-existing, conductive electrodeposit 120d which minimizes the effect of IR drop associated with conveying electroplating current from structural patterns 112d and buss 114d to contacts 96 and/or 98 of FIG. 22. The article 80e of FIG. 32 has no such preexisting conductive electrodeposit. Nevertheless the embodiment of FIG. 32 may yet have advantages when compared to an embodiment such as that of FIG. 23. For example, the embodiment of FIG. 32 can be processed according the to process depicted in FIG. 6 and/or FIG. 9. Buss 114e of FIG. 32 could have increased cross section (therefore higher current carrying capacity) than buss 114a of FIG. 23. Finally, the buss structures depicted in FIGS. 27 through 33 allow formation of structural patterns such as 112a-e on both, opposite sides of insulating web 10a-e.

FIGS. 34 through 40 are presented to continue teachings involving the embodiment first introduced in FIG. 23. FIG. 34 is a sectional view taken substantially from the perspective of lines 34-34 of FIG. 23. FIG. 34 is one form of embodiment of FIG. 23 and depicts a web like structure having thickness Z-23. In many cases, thickness Z-23 is considerably smaller than width W-23 or length L-23 so that Article 80a can be characterized as being generally planar in nature. It is seen in FIGS. 23 and 34 that the sectional view in FIG. 34 is taken through selective structural patterns 112a, finger 116a and buss 114a. In the FIG. 34 embodiment, selective structural pattern 112a, finger 116a, and buss 114a are all formed from the same electroplateable material and is thus shown as continuous in section. This is not necessarily the case. Also structural patterns 112a, buss 114a, and fingers 116a can be formed at different times and by different processing. Insulating substrate 110a serves as a support web for the electroplateable material.

FIG. 35 is a sectional view taken substantially from the perspective of lines 35-35 of FIG. 23.

FIG. 36 is a view similar to FIG. 34 following the step of exposing the FIG. 34 structure to an electroplating process such as that depicted in FIG. 22. Electrodeposit 120a now coats the originally exposed surfaces of the electroplateable materials supported by insulating substrate 110a. It is understood that electrodeposit 120a can comprise multiple layers of electrodeposit.

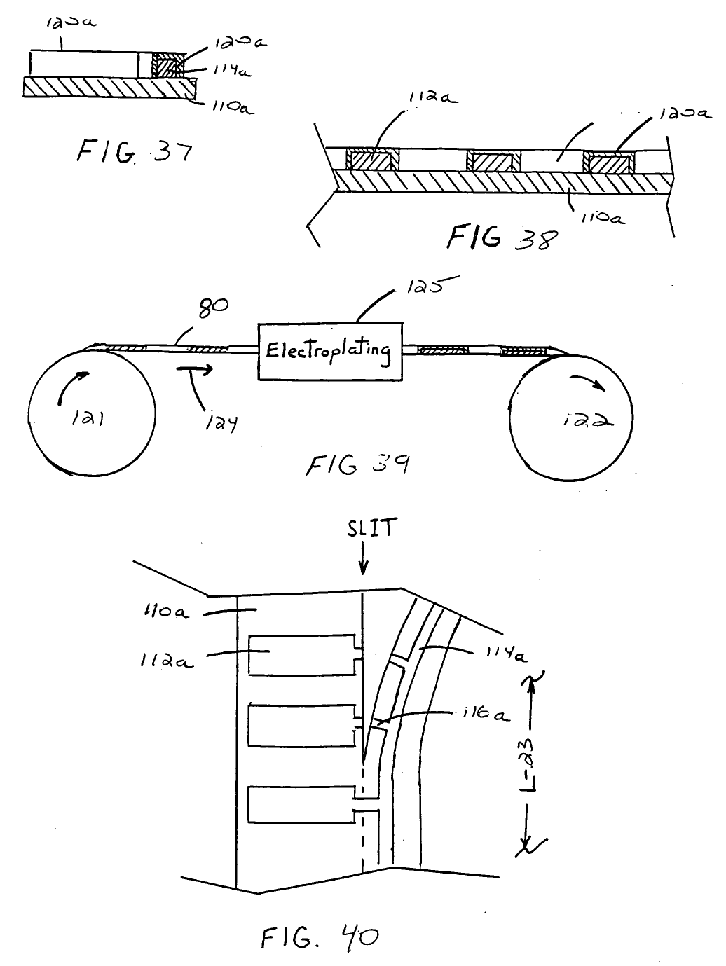

FIG. 37 is a view similar to FIG. 35 following the step of exposing the FIG. 35 structure to an electroplating process such as that depicted in FIG. 22. As with FIG. 36, FIG. 37 shows electrodeposit 120a coating the originally exposed surface of electroplateable materials supported by insulating substrate 110a.

FIG. 38 is a sectional view of the FIG. 36 structure taken from the perspective of lines 38-38 of FIG. 36.

FIG. 39 depicts one form of process by which the electroplating of FIGS. 36 through 38 is achieved in a continuous fashion. FIG. 39 depicts a roll-to-roll process. Substrate structure as depicted in FIGS. 34 and 35 is unwound from feed roll 121 and travels in the direction of arrow 124 to electroplating process 125. Upon exiting electroplating process 125, the structure has now been transformed to that as indicated in FIGS. 36 through 38. FIG. 38 is of course a magnified view of this exit structure. The exit structure is then rewound onto takeup roll 122. Electroplating process 125 can be similar, for example, to that depicted by FIG. 22.

FIG. 40 indicates an optional step in the continuous processing of the web following the electroplating process 125. It is shown in FIG. 40 that buss 114a and optionally a portion or all of fingers 116a are removed by slitting along length L-23 leaving individual selectively electroplated structural patterns 112a on the remainder of insulating support 110a.

FIGS. 41-51 show alternate structure and method for continuously producing selectively electroplated patterns on a continuous web-like substrate. FIGS. 41-51 teach the use of a buss positioned on the opposite side or backside of the articles, structures, or items intended to be electroplated. FIG. 41 is a top plan view of an article generally designated by 151. Article 151 has a length L-41 and width W-41. In many cases L-41 is considerably larger than W-41 and article 151 can generally be characterized as being “continuous” in the direction of L-41. Article 151 comprises selective patterns of individual islands or traces 152 comprising electroplateable material positioned on the top of insulating web substrate 154. Holes 156 extend from the top surface 164 to the bottom surface 162 of article 151. Additional structure shown in phantom in FIG. 41 is positioned on the opposite (bottom) side of insulating web 154.

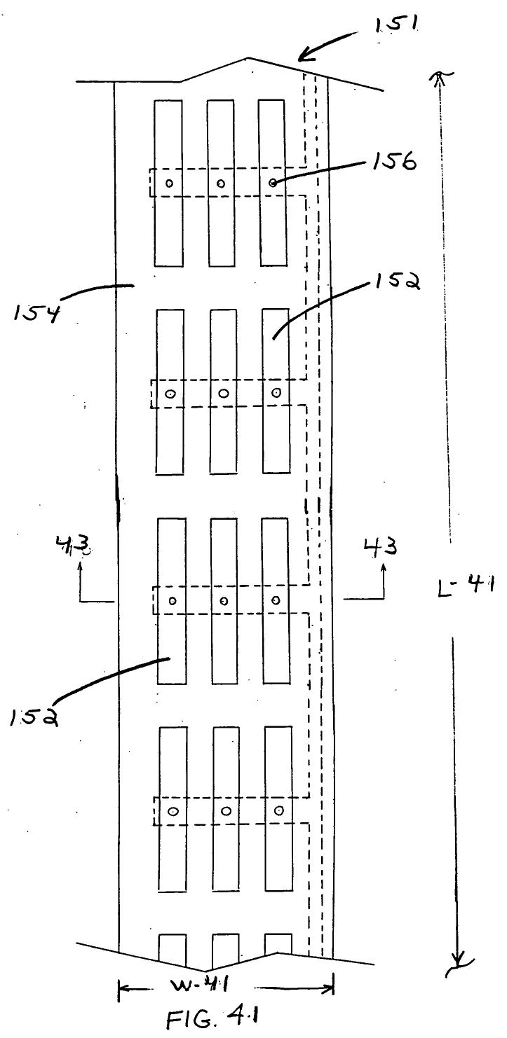

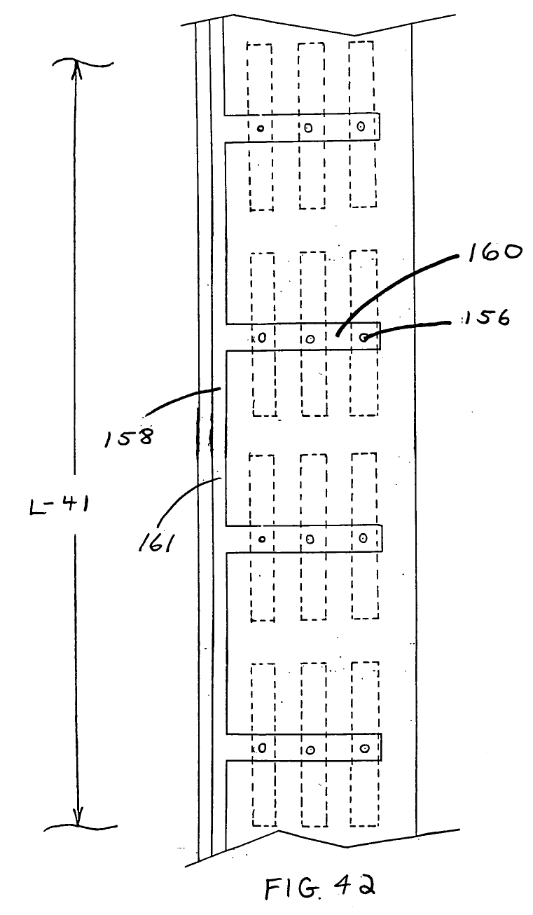

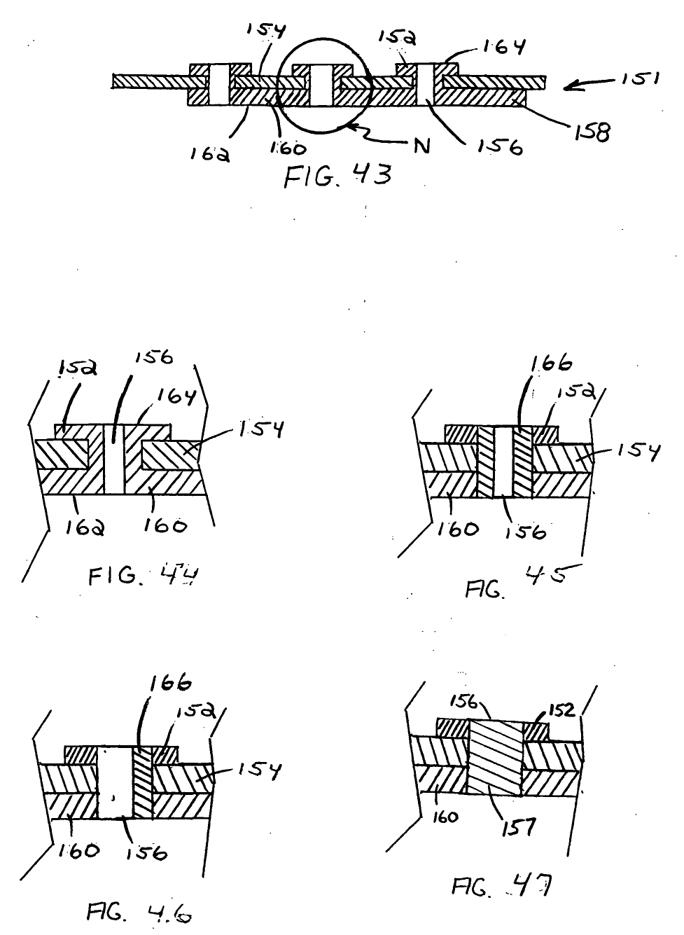

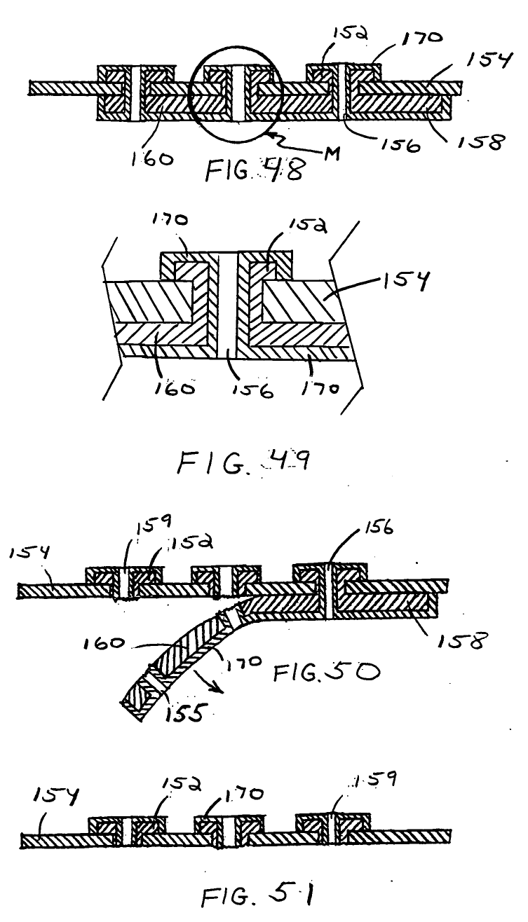

The bottom structure is best shown in the bottom plan view of FIG. 42. In the FIG. 42 view, there is shown buss structure 158 having a linear portion 161 extending in the length L-41 direction and lateral arms or extensions 160 extending laterally from the linear portion 161 in the width direction at positions overlapping holes 156. The function of buss structure 158 is to convey electroplating current from the source of cathodic potential. Buss structure 158 may comprise an electroplateable surface. However, one will recognize that some materials such as aluminum form surfaces which while conductive may not be considered readily electroplateable. Nevertheless, aluminum could be a choice for a material to form a “disposable” buss structure because of its relatively low cost, high conductivity and application characteristics. Thus in some instances the surface of buss structure 158 may be prevented from coming into contact with the electroplating solution. For example, aluminum could be coated with an insulating material. The materials for islands or traces 152 and buss 158 do not all have to be the same. It is further contemplated that the material for lateral arms 160 may be different than the material used for the linear portion 161 of buss 158.

FIG. 43 is a sectional view of one embodiment taken substantially from the perspective of lines 43-43 of FIG. 41. In the embodiment of FIG. 43, islands 152, lateral arms 160, and buss 158 all comprise the same electroplateable material.

FIG. 44 is an expanded sectional view of the structural detail contained within circle N of FIG. 43. It is seen in FIG. 44 that the electroplateable material forming buss structure 158 extends through hole 156 to islands 152 thereby establishing communication between these structural details.

FIG. 45, a view similar to FIG. 44 shows an alternate embodiment wherein conductive material 166 extends through hole 156 to join structure 152 and 160. As indicated by the sectional view of FIG. 45, materials forming structures 152 and 160 and material 166 extending through hole 156 may all be different. Furthermore, they may be applied to or positioned on web 154 at different times. In this embodiment, materials forming structures 152 and 160 and material 166 extending through hole 156 are all “electroplateable.” Those skilled in the art will quickly recognize the advantages forthcoming by choosing directly electroplateable resins (DER) to form buss 158, islands 152 and/or “through hole material” 166 in this embodiment.

One will recognize that if hole 156 is a relatively short length, the desired through hole conductive electrodeposit can be formed even if the conductive material coating the hole is not typically considered electroplateable material. For example, materials having resistivity characteristic of a semi-conductor could suffice to accomplish this short through hole electrodeposition.

In order for conductive electrodeposited material to extend through hole 156 one will recognize that a portion of original hole 156 must remain unplugged with material 166 as shown. In the FIG. 45 embodiment, material 166 is indicated as extending entirely around the circumference of hole 156. This does not need to be the case as shown in FIG. 46. In FIG. 46 material 166 is shown to cover only a portion of the circumferential area defined by original hole 156. One will recognize that even with the partial coverage shown in FIG. 46 subsequent electrodeposition will cause the conductive electrodeposit to extend continuously from arms 160 through hole 156 and onto the surface of islands 152.

FIG. 47 shows yet another embodiment to achieve through hole electrical communication. In FIG. 47 it is seen that electrically conductive material 157 extending through hole 156 completely fills hole 156.

The function of the electrically conductive material in FIGS. 41-47 extending through holes 156 is to convey current between islands 152 and arms 160 of buss 158. Numerous alternate methods may be considered to accomplish this conveyance function. For example, solid metal such as a wire or rivet could extend thru holes 156 to establish electrical communication. Similarly a conductive metal filled ink could suffice. Even materials having relatively low conductivity such as carbon filled inks may suffice since the linear distance required for transport of current is relatively small. Also, the consequent voltage drop associated with current transport over this distance may be manageable.

While the embodiments of FIGS. 41-47 show and teach islands 152 comprising electroplateable material it will be clear that the structure as shown generally by article 151 would allow appropriate alternate processing of many other materials receptive to electrically induced change. Effectively buss 158 serves as an effective opposite side electrode.

It was previously noted in reference to FIG. 45 that materials forming islands 152, through hole 156, and lateral arms 160 of buss 158 can constitute different materials. In addition, the electrical processing associated with each of these materials may be different and accomplished at different times. For example, buss 158 and through hole material 166 could be electroplated to form a highly conductive path to which material forming islands 152 could be subsequently joined with electrical communication. Thus in this way islands 152 could be subjected to electrical processing such as electrocleaning etc.

FIG. 48 is a sectional view similar to FIG. 43 following an additional processing step. In FIG. 48 it is shown that electrodeposit 170 coats the entire exposed surface of islands 152, through holes 156, and buss 158.

FIG. 49 is a expanded view of the structure contained within circle “M” of FIG. 48 clearly showing the structural detail therein.

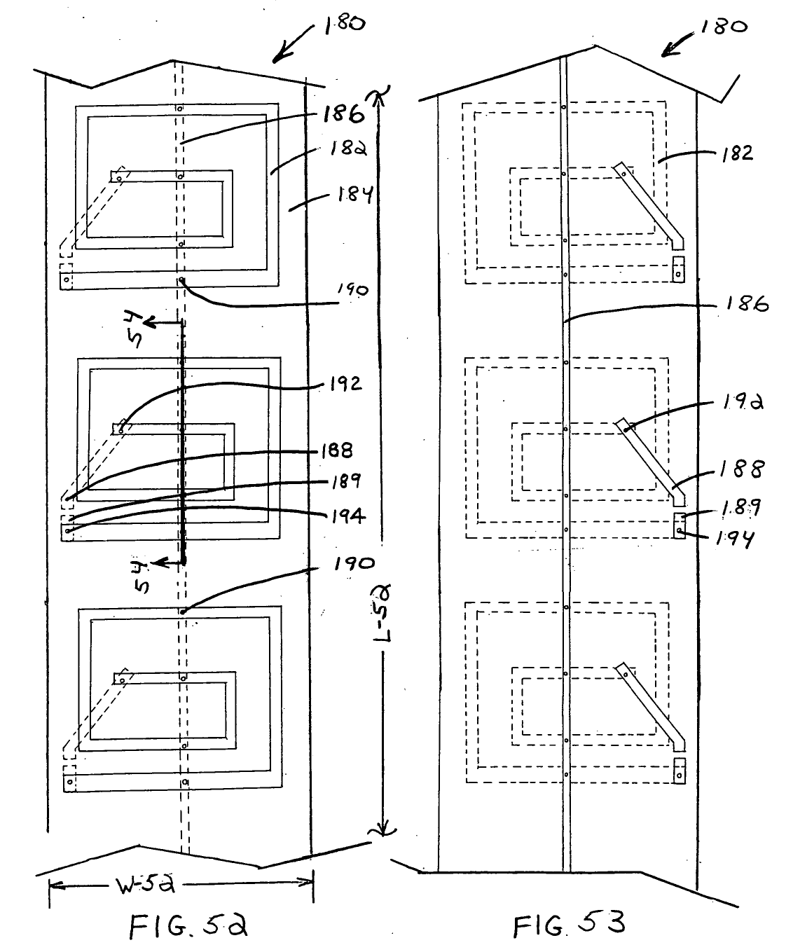

FIG. 50 is a depiction of the action accomplished thru an additional optional processing step carried out on the FIG. 48 structure. In FIG. 50, it is seen that the arm 160 and a portion of the hole structure identified as 155 and their associated electrodeposit has been partially peeled from insulating web 154, islands 152, and the remainder of original hole 156 now identified as 159. The stress concentrating nature of original holes 156 may facilitate this removal. A portion of arm 160 remains attached as well as the remainder of buss 158. Continuing the operation indicated in FIG. 50 will result in complete removal of buss 158, and the associated attached electrodeposit 170. Thus the structure shown in section in FIG. 51 remains. In FIG. 51 it is shown that the entire bottom side electrical structure (electroplated arms, holes, and linear buss portion) have been removed to leave individual electroplated islands 152/170 along with residual hole portions 159.

It is recognized that the operation depicted in FIG. 50 suffices to sever electrical communication originally established through holes 156 and between discrete islands 152. One will recognize that this severing of electrical communication could also be accomplished by simply severing or disrupting buss and/or lateral arm communication at selective spots in which case the backside buss including its arms would not need to be completely removed. Such severing of electrical communication could be accomplished by mechanical drilling, etching, slitting etc.

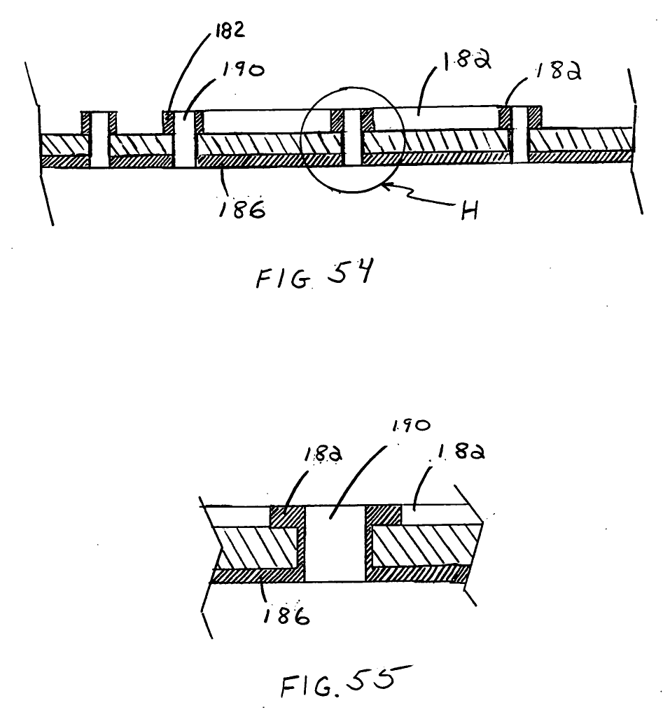

FIGS. 52 through 59 illustrates structure in the production process for another embodiment of the backside buss structure introduced in FIGS. 41-51. FIG. 52 shows a top plan view of an article generally designated as 180. Article 180 comprises coil like patterns 182 selectively positioned on insulating web 184. Article 180 has length L-52 and width W-52. Shown in phantom in FIG. 52 are buss pattern or structure 186, pattern extension 188, and pad 189. Holes 190, 192, and 194 extend from the top surface of article 180 to the bottom surface of article 180. Hole 190 extends between buss pattern 186 and coil pattern 182. Hole 192 extends between coil pattern 182 and pattern extension 188. Hole 194 extends between coil pattern 182 and pad 189.

FIG. 53 is a bottom plan view of article 180 more clearly showing buss pattern 186 and pattern extension 188. Coil pattern 182, buss pattern 186 and pattern extension 188 may typically comprise electroplateable materials. Mixtures of electroplateable materials such as pure metals and electroplateable polymers are clearly within the scope of this teaching. However, materials forming these structures, may not necessarily be electroplateable in the conventional sense as discussed previously.

FIG. 54 is a view taken substantially from the perspective of lines 54-54 of FIG. 52. It is seen in FIG. 54 that coil pattern 182 communicates with buss pattern 186 via holes 190. As previously taught with reference to FIGS. 44-47 the through hole electrical communication associated with holes 190, 192, and 194 can assume multiple various forms.

FIG. 55 a magnified sectional view of the structure contained within circle “H” of FIG. 54 shows this communication in greater detail. In FIG. 55 it is seen that material forming coil pattern 182 extends through hole 190 and continues to form buss pattern 186. As will be clear from the discussion of the embodiments of FIGS. 44-47, coil pattern 182, buss pattern 186, pattern extension 188, and pad 189 can be different materials. In addition, the material extending through hole 190 and joining coil pattern 182 and buss pattern 186 can differ from the materials of 182 and 186 in a fashion similar to that taught in FIG. 48. Pattern extension 188 connected to coil pattern 182 through holes 192 can comprise yet another material. The material extending through hole 192 can differ from that material extending through holes 190. Similarly material extending through hole 194 joining pad 189 with coil pattern 182 can also be different from the various materials referred to above. For purposes of simplicity in teaching the current invention the embodiments shown in FIGS. 52-59 will employ a single material forming coil pattern 182, buss pattern 186, pattern extension 188, pad 189 and material joining them through holes 190, 192, and 194.

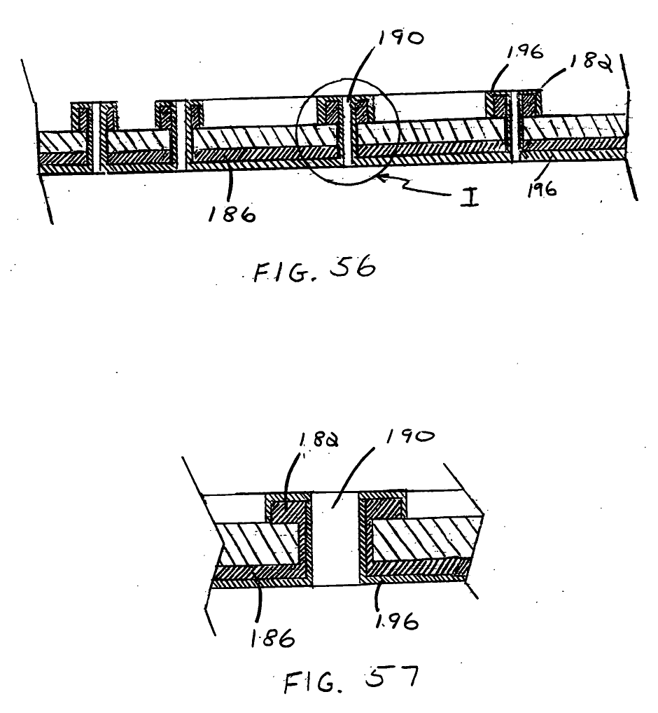

FIG. 56 is a sectional view similar to FIG. 54 but following an additional processing step of exposing the FIG. 54 structure to an electroplating process. In FIG. 56 it is seen that electrodeposit 196 coats coil pattern 182 and buss pattern 186. Electrodeposit 196 further extends through hole 190 to establish continuous electrodeposit communication between coil pattern 182 and buss pattern 186. It will be understood that similar electrodeposit communication is established through holes 192 and 194.

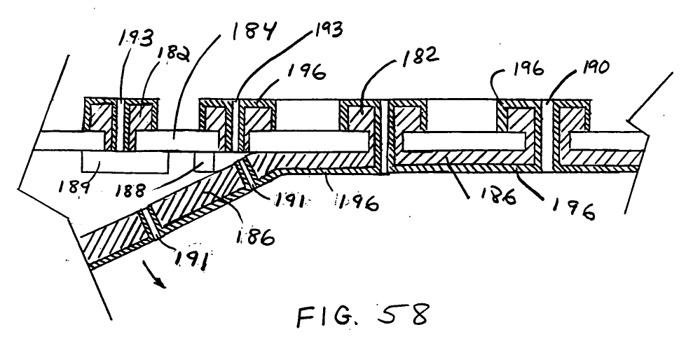

FIG. 57 is a magnified view of the sectional structure shown within the circle “I” of FIG. 56. FIG. 57 clearly shows the electrodeposit 196 covering the originally exposed surface of coil pattern 182, extending through hole 190 to the originally exposed surface of buss pattern 186.

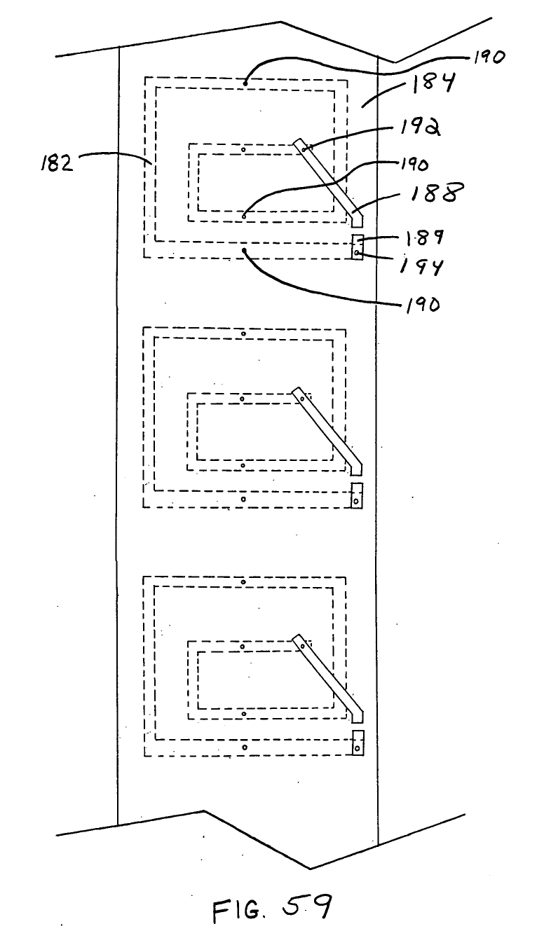

FIG. 58 is a depiction of the action accomplished thru an additional optional processing step carried out on the FIG. 56 structure. In FIG. 58 it is seen that buss pattern 186 and a portion of the original two holes 190 (now identified as 191) and the associated conductive electrodeposit 196 has been partially peeled from insulating web 184, coil pattern 182, and the remainder of the two holes 190 (now identified as 193). In FIG. 58 a portion of buss pattern 186 and its associated conductive electrodeposit 196 remains attached at this point in the operation. Completing the operation indicated in FIG. 58 will result in complete removal of buss pattern 186 and its associated electrodeposit. Thus the structure shown in the bottom plan view of FIG. 59 results. It is understood that the severing of electrical communication accomplished by the actions of FIG. 58 can also be accomplished by other severing techniques as discussed above in reference to FIG. 50.

In the bottom plan view of FIG. 59, pattern extension 188 and pad 189 remain and electrical communication through holes 192 and 194 to topside coil pattern 182 also remains. Coil pattern 182 now comprising a electrodeposit also remains. Insulating substrate 184 continues to support the various electrical structural traces.

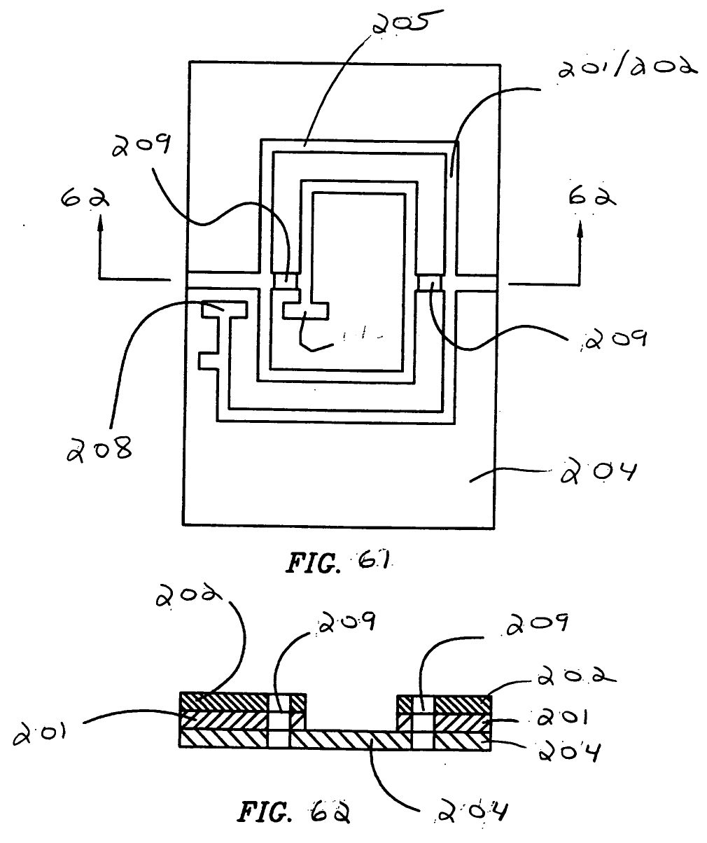

An important feature of the resulting structure depicted in FIG. 59 is the close positioning of electrical pad 189 and pattern extension 188 separated only by the insulating surface of support 184. This permits electrical joining of the contacts of an electrical device to the corresponding surfaces of extension 188 and pad 189 without requiring bridging of an intermediary conductive trace as would be necessary for example in the following embodiment of FIG. 61.

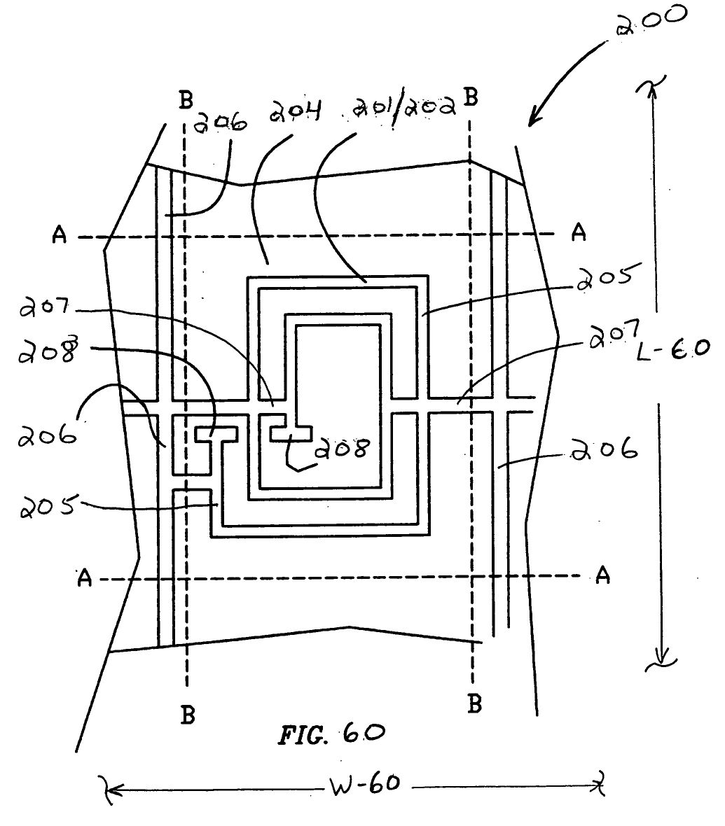

FIGS. 60 through 62 illustrate a method and structure for the continuous production of selectively electroplated multiple loop traces. Such a loop may form for example an antenna. FIG. 60 is a top plan view of an article generally designated as 200. Article 200 comprises a trace pattern 205 supported on insulating material 204. Trace pattern 205 comprises a laminate structure of electroplateable material 201 covered with electrodeposit 202, as is shown in FIG. 62. It is seen in FIG. 62 that the trace pattern is typically characterized as “low profile.” Thus, the electroplateable material of the trace is often deposited by a printing operation. For the reasons stated previously, a directly electroplateable (DER) ink often is an excellent choice as the electroplateable material 201 of the trace pattern.

Article 200 also includes buss pattern or structure 206, whose function was previously discussed. Buss pattern 206 may comprise structure and materials different from that associated with trace pattern 205. In addition, buss pattern 206 can be fabricated in a different operation than that forming the trace pattern, as was discussed in conjunction with the embodiments of FIGS. 27 through 33. Article 200 also includes mounting pads 208. Buss pattern 206 and/or mounting pad 208 may comprise a DER. The embodiment of FIG. 60 has length L-60 and width W-60. L-60 is often larger than W-60 such that article 200 can be processed in a continuous manner. Buss pattern 206 is in electrical communication with trace pattern 205 via lateral arms or pattern extension 207. Lateral arms 207 may extend to multiple loops of trace pattern 205 as shown. However, this is not a requirement. The reason for this communication among the various loops of the pattern is to minimize the time required to cover the entire pattern with conductive electrodeposit. In many embodiments buss pattern 206 comprises the same materials as trace pattern 205 and can be simultaneously applied for example with a printing operation. However, this is not a requirement. The buss pattern 206 can comprise materials different from those of the trace pattern 205.

FIG. 61 is a top plan view of the article produced by removing portions of the structure of FIG. 60. The structure of FIG. 61 is produced by slitting or otherwise cutting the web along the lines generally indicated by the dashed lines A and B of FIG. 41. One appreciates that holes 209 suffice to sever the electrical connection between inner and outer loop portions of the coil pattern. This effect of holes 209, to sever electrical connections, can be achieved by any number of methods such as laser cutting, ablation, grinding, punching etc.

FIG. 62, a sectional view taken from the perspective of line 62-62 of FIG. 61, further illustrates the structural arrangement following the slitting and punching operations.

Referring now to FIG. 63, the starting material for yet another embodiment is illustrated in plan view. Material 210 comprises a web, mesh or fabric and is characterized by having a width W-63 and length L-63. It is contemplated that length L-63 is greater than width W-63 such that material 210 can be processed in a continuous fashion.

FIG. 64, a greatly magnified plan view of a portion of the structure of FIG. 63, shows the material 210 comprising fibrils 211 interwoven to form a sturdy structure. Holes 212 are present among the interwoven fibrils. It is understood that the fibrils need not be actually interwoven as shown. Equivalent structures comprising fibrils and holes, such as polymeric non-woven fabric or adhesively bonded fibril mats, can be employed.

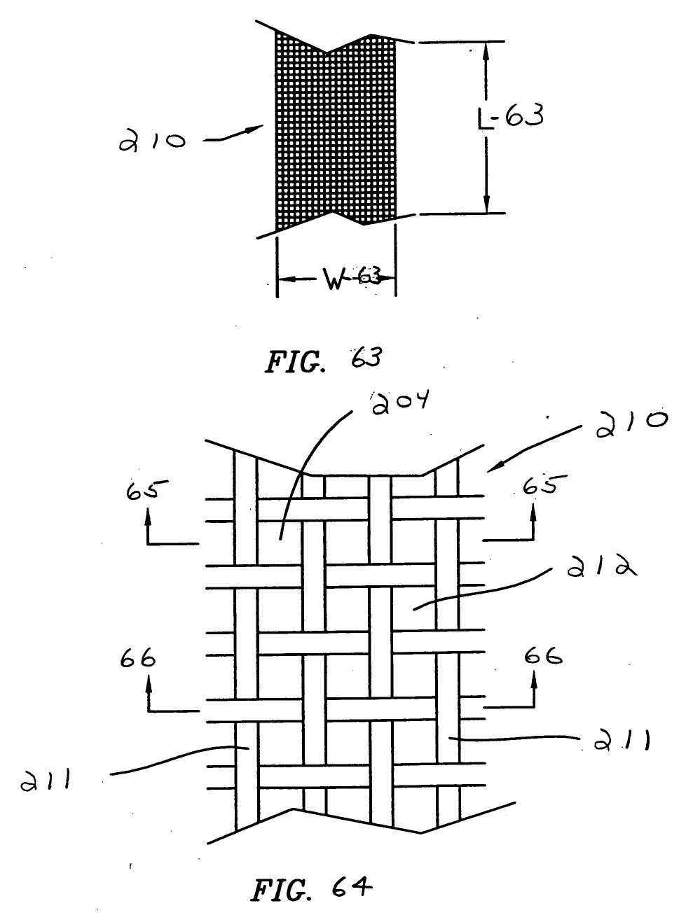

FIGS. 65 and 66 are sectional views of the embodiment of FIG. 64 taken substantially along line 65-65 and line 66-66 of FIG. 64 respectively.

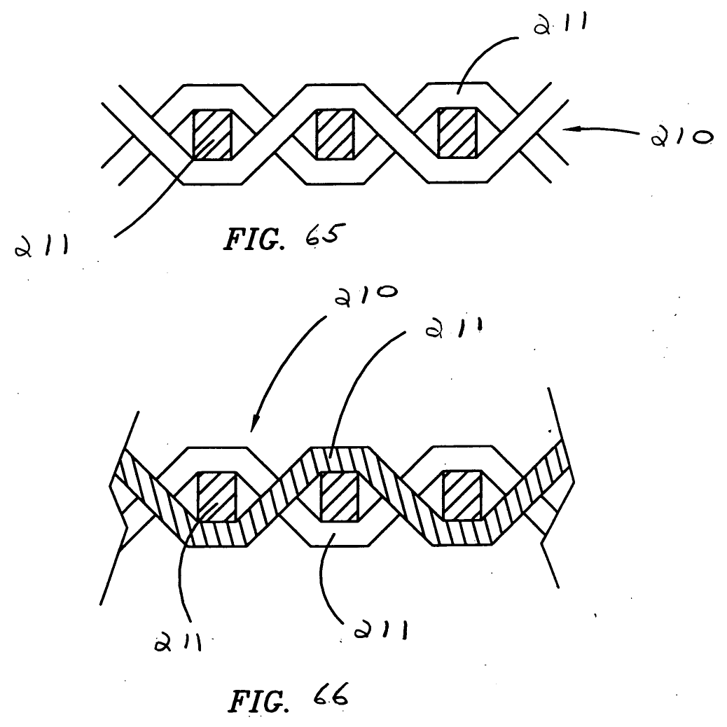

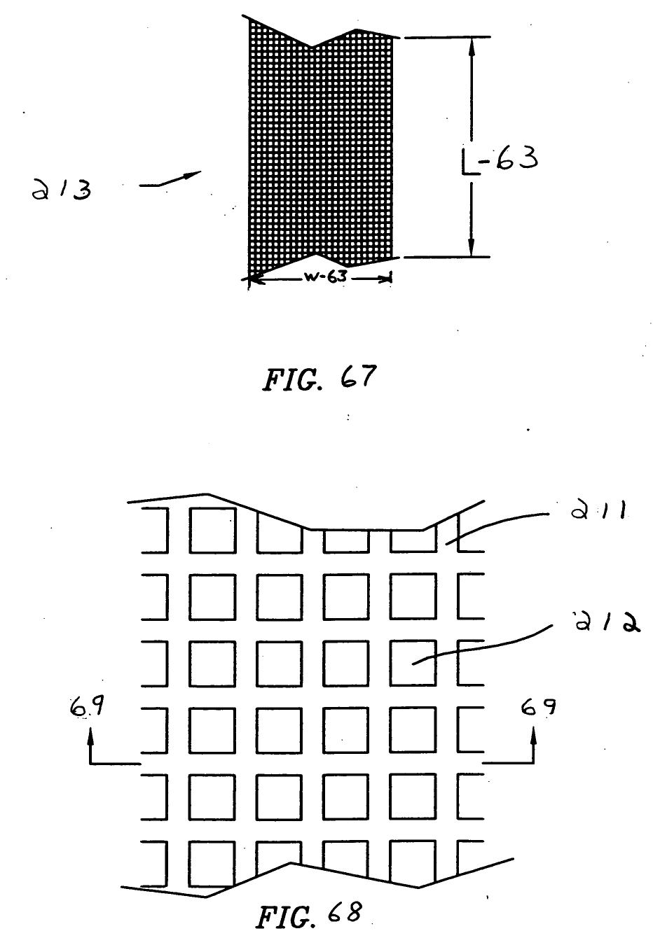

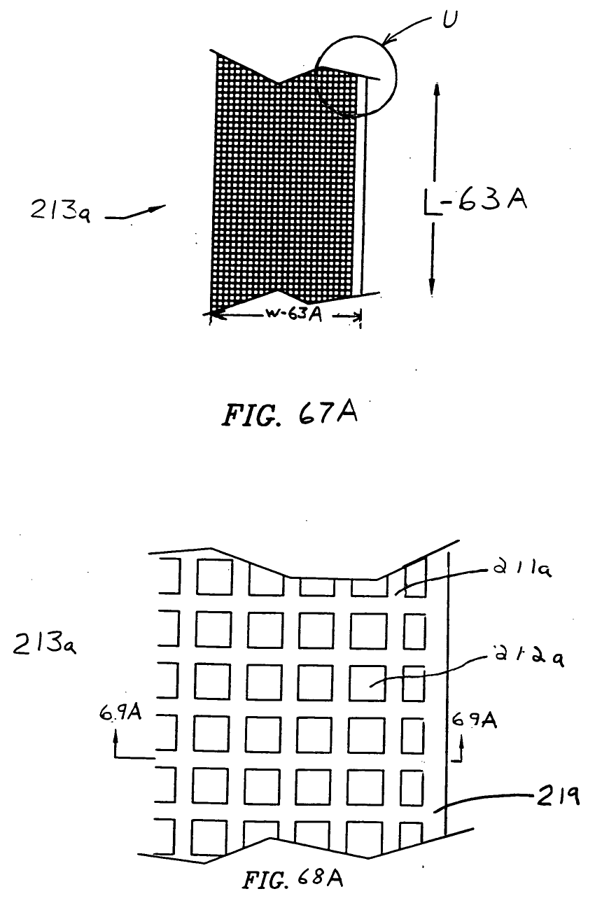

Referring now to FIG. 67, there is shown the material of FIG. 63 following an additional processing step. The material is now generally designated as 213 to indicate this additional process step.

FIG. 68 is a greatly magnified plan view of a portion of the FIG. 67 structure. In contrast to the plan view shown in FIG. 64, the structure of FIG. 68 appears continuous in the two-dimensional plan view. This continuity results from coating the fibrils with an electrically conductive coating. The structure of the coated fibrils is best shown in the sectional view of FIG. 69, which is a view taken substantially along line 69-69 of FIG. 68. In FIG. 69, fibrils 211 have been coated with electrically conductive coating material 214. It is anticipated that coating 214 and the deposition process for applying coating 214 can be chosen from any number of suitable techniques. Included in such techniques are painting, dipping, or printing of conductive inks, laminating, and masked chemical or vapor deposition of metals or other conductive materials. In the case of a temperature resistant fabric such as fiberglass, deposition of a low melting point metal such as solder could be employed. The important feature of the structure of FIG. 69 is that through-hole electrical communication extends from the top surface 215 to the bottom surface 218. This situation is readily achieved by using the coated fabric approach of the present embodiments.

One will recognize that a particularly advantageous material for coating 214 is an electrically conductive polymer. In a preferred embodiment coating 214 comprises a DER ink, paint, or paste. DER's are relatively inexpensive, and can be readily formulated and applied from solution form. A further advantage of DER's is that they can be formulated using materials, such as elastomers, which are flexible and tough. Thus, cracking of the coating, especially at fiber junctions, is reduced while the fabric remains flexible and pliable. It is also understood that the fabric itself could be completely or partially made out of thermoplastic DER fibers which would eliminate the need to coat the material.

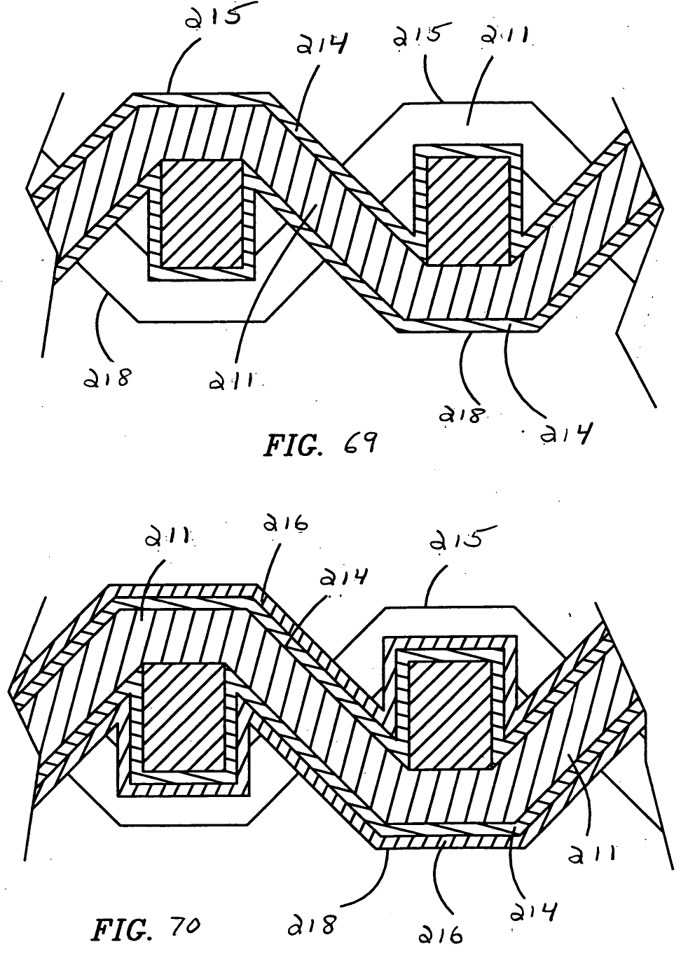

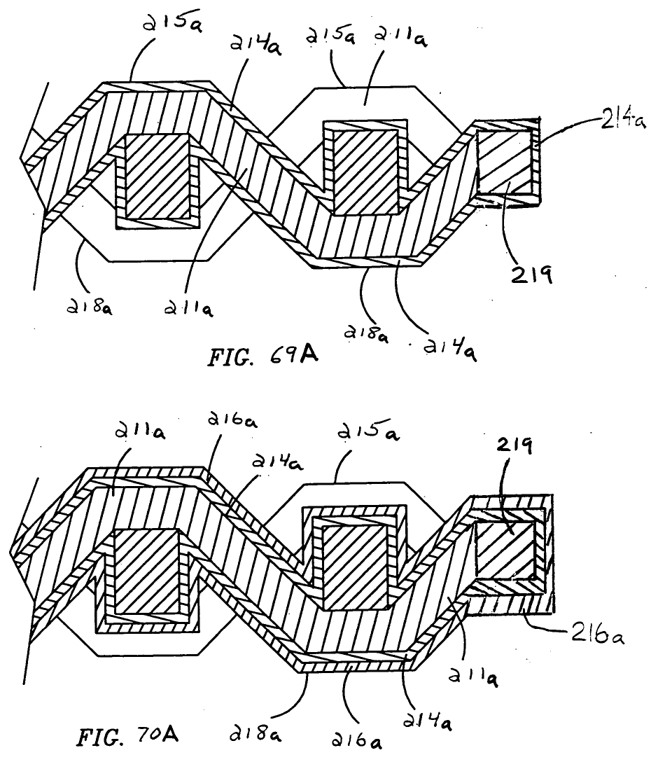

FIG. 70 is a sectional view similar to FIG. 69 following an additional optional process step. In FIG. 70, the electrical conductivity and mechanical and environmental integrity of the structure is further enhanced by applying an additional highly conductive coating 216 overlaying coating 214. This subsequent coating 216 can be conveniently applied by metal electrodeposition. The structure of FIG. 70 gives highly conductive communication equivalent to a metal screen from top surface 215 to bottom surface 218 by virtue of the through-hole electrodeposition.

While not necessary, for reasons discussed above it may be advantageous to electroplate material or fabric 213 in a continuous manner such as that depicted in FIG. 22. In this case, a buss structure according to those previously taught may facilitate coverage and web processing speed. This is shown in the embodiments of FIGS. 67A through 70A. In FIGS. 67A through 70A there is shown structure similar to that originally shown in FIGS. 67 through 70 with the addition of buss structure identified as 219. It is seen particularly in FIGS. 69A and 70A that buss structure identified as 219 may comprise material different than that comprising original fibrils 211/211a. Thus material comprising buss 219 can facilitate electrodeposition and current carrying requirements by being for example highly conductive and/or rapidly electroplateable. As shown in previous embodiments buss 219 may be removed after electroplating.

One will understand that when electroplating a fabric in a continuous manner, for reasons discussed above it may be advantageous to employ fabrics comprising DER inks or coatings or DER fibers. One will also recognize that insulating surface portions can be combined with conductive surface portions to achieve selective electrodeposition on a fabric. In this case DER's would represent a very suitable material from which to fabricate at least a portion of the conductive surface portions.

One will also recognize that electroplated fabrics could be used for a wide variety of applications including but not limited to EMI shielding, antennas, and electrical circuits for clothing.

The teachings presented here in conjunction with the embodiments of FIGS. 3 through 70A take advantage of the unique suitability of electrically conductive resins for use with continuous electrochemical processing, especially electroplating of web-like articles. Specifically, electrically conductive resins can be formulated as conductive inks to produce low profile items on the support web which can be subsequently electroplated. Moreover, these electrically conductive resin inks can be formulated using resins having good adhesion to the web substrate. Conductive resin patterns will electroplate selectively with the insulating substrate remaining unplated.

Particularly suitable conductive resin formulations for items intended to be electroplated in a continuous process are DER'S. With regard to continuous web processing, DER's have many advantageous characteristics. DER's can be formulated from very inexpensive materials using a wide range of resins. Thus, not only will excellent adhesion of electrodeposit to the DER surface be readily achieved, but the adhesive characteristics of a DER to a substrate can be tailored to suit a particular requirement. For example, should it be desired to remove the electroplated DER item from the web, the adhesion of the DER material to the web material can be appropriately adjusted. Alternatively, DER's can be formulated to have excellent adhesion to the substrate, thereby allowing relatively thick electrodeposits without curling or pulling away from the substrate. DER's can be formulated to be very flexible and tough, thereby preventing delamination or cracking during web handling and transport. DER's can be electroplated in a repeatable and low cost manner. Electroplating is relatively fast and very simple, often with as little as a single electroplating bath. This fact reduces the complications involved in web transport through the process. DER's can be formulated to be insensitive to pretreatments that may be necessary for other components intended to be electroplated along with the DER component. Finally, DER structure can be produced in a variety of material forms using multiple fabrication techniques. Thus, DER's can be applied to a web either as a low profile form by, for example, printing or extrusion or in more complicated structure by, for example, injection molding.

Many of the approaches for continuous electrically induced treatment of items include a buss structure to communicate an electrical characteristic such as current or potential between a source of the characteristic and the surface being treated. Herein, electrically induced treatment refers to a physical or chemical process generated by an electrical characteristic such as current or potential including, but not limited to, processing such as electroplating, anodizing, cleaning, electrostatic coating and electrocoating. As prior embodiments and teachings of this specification have shown, a buss structure can be separately prepared prior to attachment of items intended for electrically induced treatment. The buss structure can comprise materials different than the items intended to be treated. The buss structure can be used in conjunction with a supporting web. It is frequently advantageous to form buss structures comprising electrically conductive resins. Electrically conductive resins can be formulated as inks which can be printed to result in low profile electrical paths. When applied to an insulating substrate, the electrically conductive resin will selectively be electroplated. In addition, a conductive ink can be applied to give through hole conductivity which can be employed to give through hole electrodeposition. This is of course desirable should electrodeposition of appended items on both sides of a web article be desired or if the buss is to be positioned on the web face opposite the items to be plated.

A buss comprising an electrically conductive resin formulated as a directly electroplateable resin (DER) is often particularly advantageous. Due to the inclusion of an electrodeposit growth rate accelerator, in many cases DER's do not have to be highly conductive to form an initial buss pattern. A rapidly covering metal-based electrodeposit serves to greatly augment the electrical transport characteristics of the pattern originally defined by the DER. In this case, the DER can be thought of as a “pre-bass” whose function is to define the structure of the eventual metal-based electrodeposit.

The fact that DER's do not have to exhibit high conductivity to form this important function in buss creation is significant. Low cost conductive fillers can be selected for DER's at reduced loadings and the polymer matrix can be chosen from a wide variety of choices. Thus, buss structures defined by DER's can be fabricated by a number of different techniques, including extrusion, co-extrusion, injection molding and printing of DER formulations in the form of inks. This permits formation of buss structures, including complicated two and three-dimensional structures, which could be difficult to achieve using other conducting materials and forms. Moreover, DER's may be formulated using low cost fillers and simply and inexpensively electroplated with relatively low cost metals, which is an important advantage considering that the buss structure will often be removed from the final plated item and possibly discarded. In addition, DER's can be formulated to produce various adhesive characteristics to a selected substrate. Formulations having “good” adhesion to the substrate can be chosen to prevent curling or delaminating of the buss structure during processing. Alternatively, should it be desirable to remove the buss through a “peeling” action following electrochemical treatment of a web, the DER can be formulated having reduced adhesion to the substrate and yet be tough and flexible to allow such “peeling”.

Finally, DER materials can withstand many possible pretreatments which may be necessary for materials connected to the buss and intended to be electroplated. Also, should a plated DER buss be chosen for use in treating items by electrochemical processing other than electroplating, the metal-based electrodeposit covering a DER buss can be chosen appropriately.

FIGS. 71 through 75 show yet another embodiment of the current invention. FIG. 71 is a top plan view of an article generally depicted as 220 having length L-71, and width W-71. It is contemplated that length L-71 is greater than width W-71 such that article 220 can be processed in a continuous fashion.

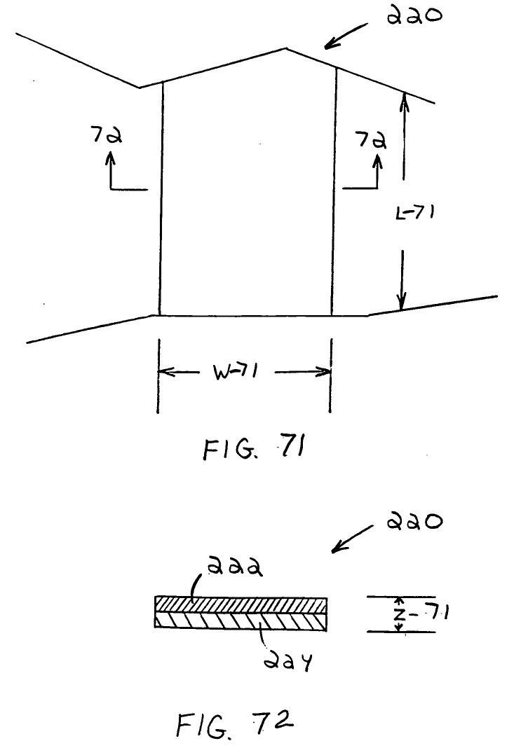

FIG. 72 is a sectional view taken substantially from the perspective of lines 72-72 of FIG. 71. It is seen that article 220 can be generally characterized as having a sheet-like structure of width W-71 and length L-71. Thickness Z-71 is such that article 220 is suitable to be subsequently processed in a plastic thermoforming or stamping operation. Article 220 is seen to be in this embodiment a laminate of layers 222 and 224. However, this is not a requirement. Layer 222 comprises a directly electroplateable resin (DER). In this embodiment layer 224 comprises an insulating resin possibly chosen in consideration of the subsequent thermoforming operation or other functional characteristics.

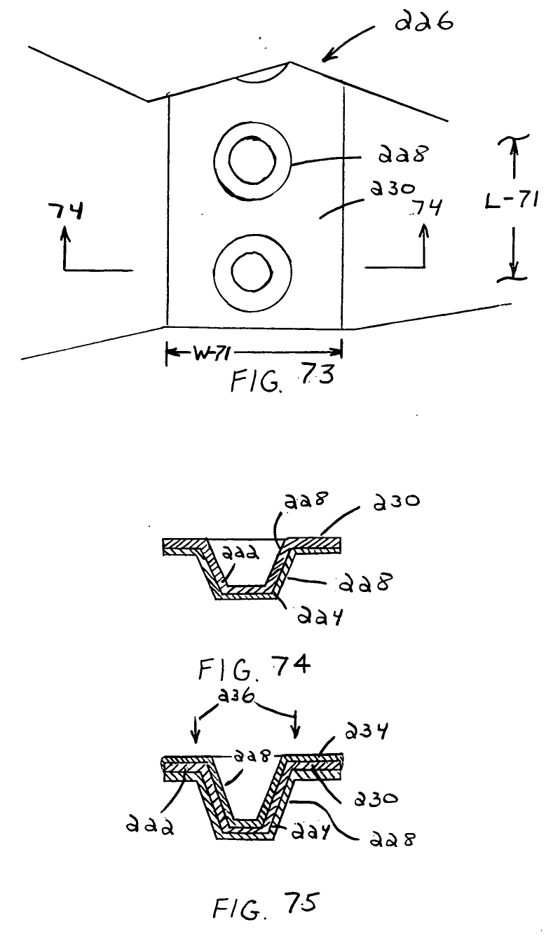

FIG. 73 is a top plan view of the article 220 following an additional thermoforming processing step. Considering this additional step the article is now referred to as 226 in FIG. 73. In FIG. 73, it is seen that additional structure 228 has been introduced into the original sheet like structure by the thermoforming operation. The plastic thermoforming operation typically consists of pre-heating the original sheet like stock 220 to a formable state and forming a portion of this heated sheet to conform to the surface of a die. The process of thermoforming is well known in the art. Formed structure 228 in FIG. 73 remains supported by unaltered residual support web 230.

FIG. 74 is a sectional view taken substantially from the perspective of lines 74-74 of FIG. 73. In the FIG. 74 embodiment, it is seen that a portion of original sheet 220 has been formed into a generally cup like structure 228 still attached to unaltered support web 230.

FIG. 75 is a sectional view similar to FIG. 74 following exposure of the FIG. 74 structure to an electroplating process. It is clear that article 226 can be electroplated continuously by transport of the formed structures 228 and unaltered web 230 through the plating process as for previous embodiments. It is seen that conductive electrodeposit 234 has coated the entire exposed surface of DER layer 222 including both that material associated with residual support web 230 and cup like structure 228. Following the electroplating operation cup like structures 228 can be separated from support web 230 along a path such as that indicated by arrows 236 of FIG. 75. Multiple separation techniques to achieve this removal are known in the art. The fact that the individual structures 228 remain attached to the web 230 until separated as indicated in FIG. 75 makes thermoforming an eminently suitable approach for producing articles having an electroplated surface layer. Specifically in this particular case the unaltered web portion 230 forms a convenient macroscopic buss and positioning rack for the electroplating of cup like structure 228. This is especially advantageous when one is considering continuous electroplating.

In the embodiments of FIGS. 71-75 only a single side of the original sheet like structure 220 is formed from directly electroplateable resin 222. Thus the article as depicted in article 75 receives conductive electrodeposition only on the single side formed by the exposed surface of DER layer 222. Should the conductive electrodeposit be required on the opposite second surface of such thermoformed articles, one could eliminate insulating layer 224 or substitute additional layers of directly electroplateable resin supplanting or overlapping layer 224.

DER is an eminently suitable material for the production of continuously electroplated thermoformed structures. Polyolefins are often the preferred material for the thermoforming process. DER's can be easily formulated using olefinic materials. Whether based on polyolefins or other materials, DER's can be inexpensively and simply extruded into a sheet like structure to start the process. DER is less dependent on surface morphology than many other plateable resins, allowing the actual thermoforming operation to be simply and conveniently carried out. In addition, it is well known in the electroplating art that electroplating discrete plastic articles normally involves considerable labor and tooling costs for racking. It is clear from the teachings above that the thermoforming operation allows the production of discrete electroplated plastic articles while eliminating the expense of racking. This is accomplished by the natural positioning of the formed articles on the residual, unaltered web. The original unaltered web functions not only as a positioning rack but also as the macroscopic buss to convey electroplating current between the source of cathodic potential and the article to be plated. A plated and discarded web is less of a concern due to the low-cost associated with electroplating DER.

While the embodiments have been directed towards a thermoforming process, one skilled in the art will recognize that the teachings can be extended to similar operations such as molding or stamping. It is also understood that web 230 could be removed prior to plating and individual thermoformed articles could be subsequently electroplated in a non-continuous manner.

Should selective electroplating be desired one could consider employing a buss structure similar to that shown in prior figures. The buss can be formed extending in the length of sheet L-71 of structure 220 rather than having directly electroplateable resin extending over the entire top surface. In this case directly electroplateable resin or otherwise conductive traces could emanate from the buss to DER material intended to be shaped by thermoforming and subsequently electroplated.

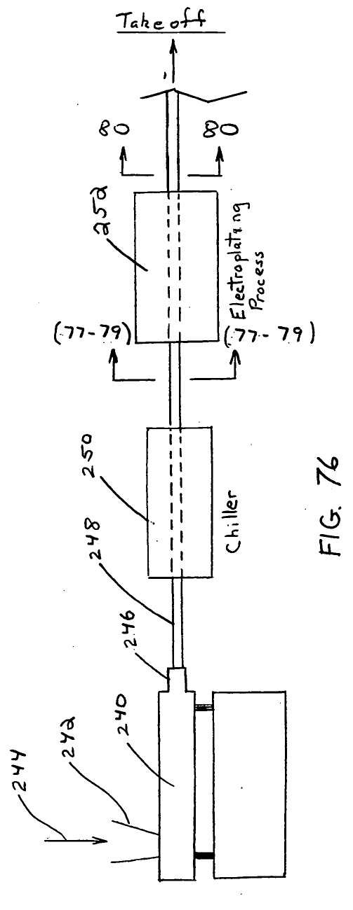

FIG. 76 shows yet another embodiment of the current invention. In FIG. 76 resin is fed to extruder 240 from hopper 242 as indicated by directional arrow 244. Such a plastic extrusion process is well known in the art. Materials used in this operation can be either thermoplastic or curable depending on the desired end characteristics. While a single extrusion machine is depicted in FIG. 76, those skilled in the art will readily appreciate in light of the following teachings that multiple extruders and other complimentary techniques can be used to accomplish the novel teachings of the current invention.

Returning now to FIG. 76, the extrusion process broadly envisions heating the resin fed at hopper 242 to a molten state within extruder 240. The molten resin is forced (extruded) through a forming die at 246. Exiting die 246 is semi-molten material 248. Typically material 248 is fed through some sort of cooling operation 250 to solidify the desired structure although this is not a requirement of the present invention. The formed article exiting the cooling operation can be gathered in a convenient way for storage prior to eventual electroplating. Alternatively, as shown in FIG. 76 the formed article can be fed continuously to an electroplating process indicated as 252.

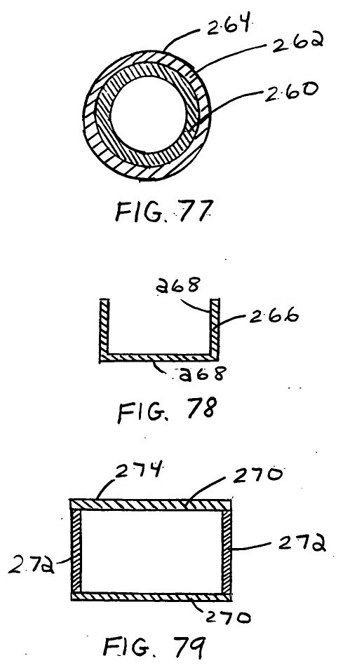

FIGS. 77 through 79 are sectional views of various possible forms taken substantially from the perspective of lines 77-79 to 77-79 of FIG. 76. It will be recognized that many other forms in addition to those shown are possible. In FIG. 77, a two material form is shown. Inner tube 260 can comprise an insulating material chosen perhaps for structural or processing characteristics. Optional additional structure could be contained within tube 260 such as a conductive wire. Exterior annular jacket 262 comprises a directly electroplateable resin having exposed exterior surface 264.

In FIG. 78, there is shown a single component “U” shaped profile. This “U” shaped profile comprises directly electroplateable resin 266 having exposed surfaces 268.

In FIG. 79, there is shown a hollow rectangular form generated by two-component profile extrusion. The hollow rectangular form has walls 272 comprising insulating material. Connecting opposite walls 272 are walls 270 with exposed surface 274 comprising a directly electroplateable resin.

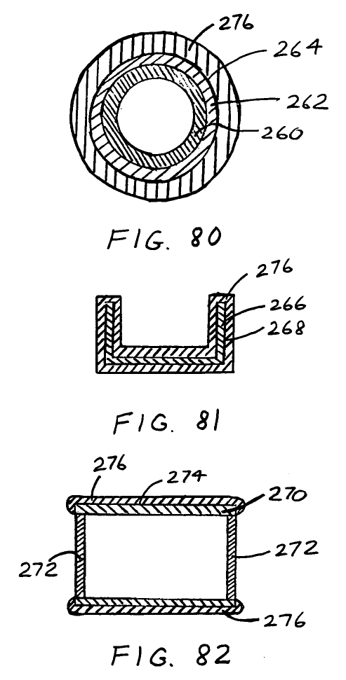

FIGS. 80 through 82 show the results of exposing the FIGS. 77 through 79 structures to an electrodeposition process as indicated by numeral 252 of FIG. 76. In FIGS. 80 through 82 it is shown that an electrodeposit 276 has now coated the originally exposed surfaces of the electroplateable materials (264 of FIG. 80, 268 of FIG. 81, and 274 of FIG. 82).

While FIGS. 80 and 81 show an electrodeposit on the entire exterior surface of the article, FIG. 82 shows the exterior surface of the article being selectively electroplated. The ability to selectively electroplate a co-extruded material form in a low-cost, consistent, and continuous manner is a significant advantage of DER's. Furthermore, as discussed previously DER's offer a number of advantages when considering the continuous electroplating of an extruded structure or article. One recognizes that in plating elongated or continuous extruded forms it may be advantageous to consider specialized movable contacts such as brushes or rollers as is known in the art.

One will also recognize that electroplated extruded articles or structures could be used for a wide variety of applications including but not limited to waveguides or coaxial cables.

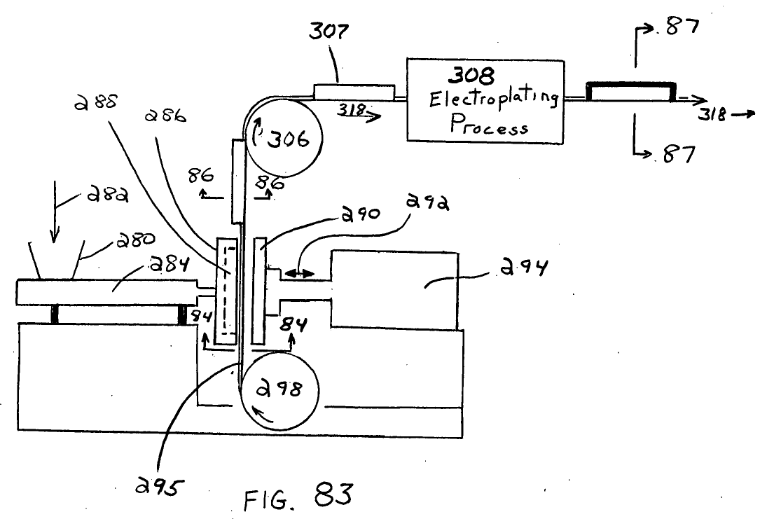

FIGS. 83 thru 87 present yet another embodiment of an article of the current invention. In FIG. 83 a plastics processing operation generally referred to as injection molding is depicted. The injection molding process is well know in the art. In this process, polymer resin is fed to hopper 280 as indicated by directional arrow 282. The resin material is heated to achieve a fluid state in cylinder 284. First mold component 286 includes cavity 288 depicted in phantom. Second mold component 290 is moved in a reciprocating fashion as indicated by directional arrows 292. The mechanism accomplishing this reciprocating motion is well known in the art and is generally indicated in FIG. 83 by 294. A material form 295 is fed from feed role 298 in an intermittent fashion coordinated with the open/close sequence of the mold and passed over exit roll 306. As will be shown below, in some embodiments this feed material 295 may be eliminated.

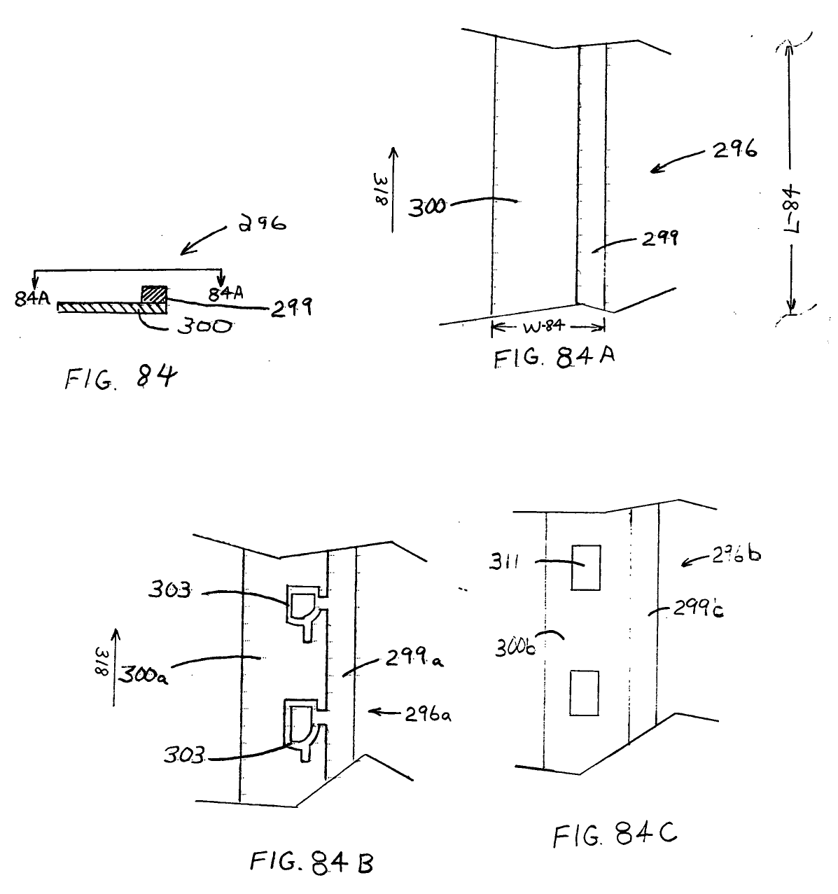

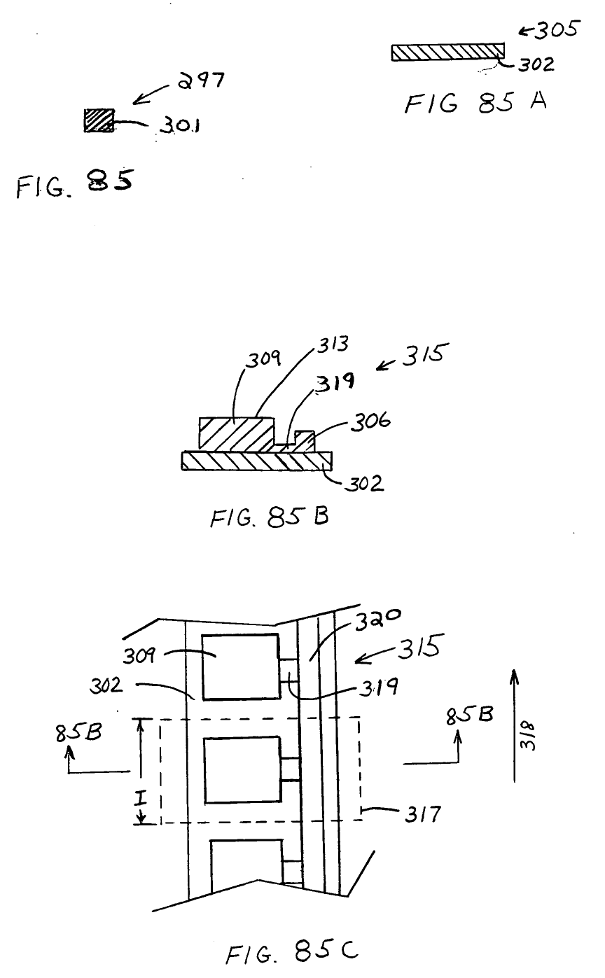

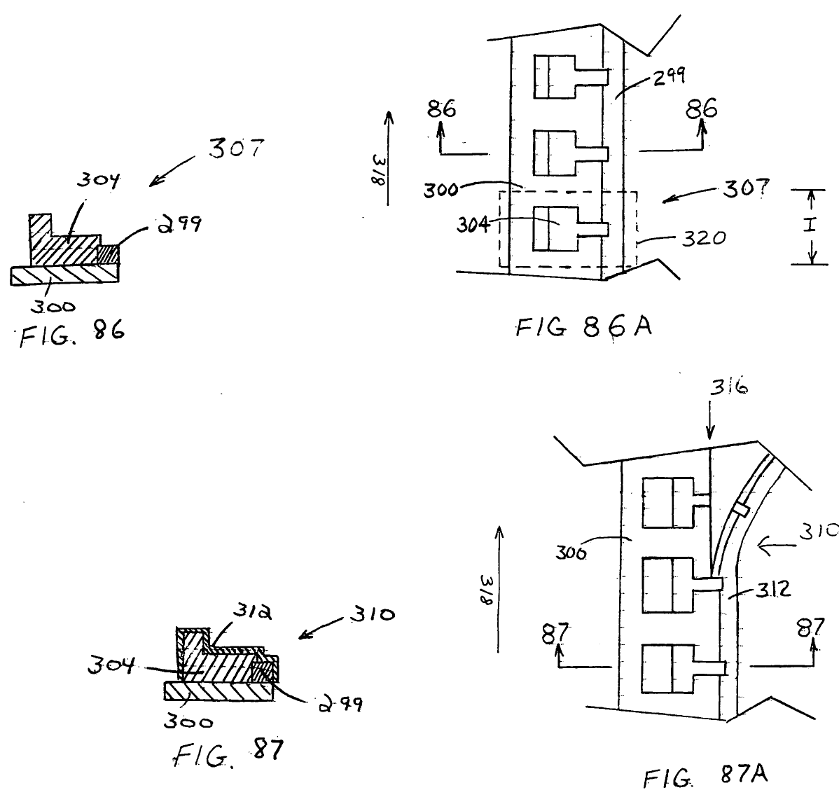

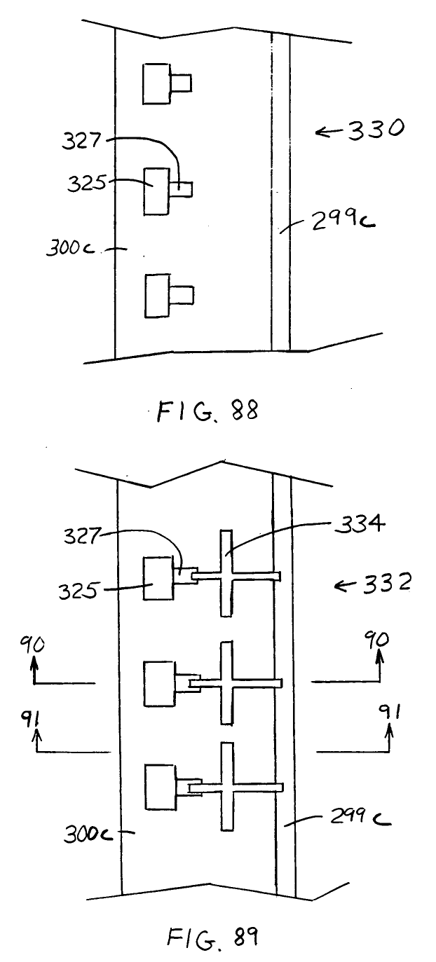

FIG. 84, a sectional view taken substantially from the perspective of lines 84-84 of FIG. 83, is one embodiment of material form 295. The specific FIG. 84 embodiment is referenced there as article 296. This embodiment is also shown in top plan view in FIG. 84A which is a view taken substantially from the perspective of lines 84A-84A of FIG. 84. In the embodiment of FIG. 84, electrically conductive material 299 is supported on insulating material 300. Electrically conductive material 299 can be formed by a variety of operations known in the art such as printing, extrusion etc. Furthermore, material 299 can comprise a DER.

While shown as simply rectangular in structure, electrically conductive material 299 can assume many forms. For example, FIGS. 84B and 84C show top plan views similar to FIG. 84A but comprising structure in addition to the simple rectangular strip 299 of FIGS. 84 and 84A. In FIG. 84B, an article generally designated as 296a comprises additional structure 303, possibly comprising an electrically conductive material adjacent rectangular material 299a. Structure 303 can comprise materials different than that of 299a. In addition structure 303 can be produced by a process different than that used to produce 299a. In FIG. 84C, an article generally designated as 296b comprises additional structure 311 positioned on insulating material 300b. Structure 311 can comprise any number of electrically conductive or non-conductive materials.

An alternate embodiment is shown in FIG. 85. In FIG. 85, the material form 295 embodied is designated as article 297. Article 297 simply consists of electrically conductive material 301. Material 301 for example could comprise a simple metal wire, or a DER.

Yet another embodiment of material form 295 is depicted in FIG. 85A. The FIG. 85A embodiment is referenced as article 305. Article 305 is simply a sheet or film of insulating material 302.

In light of the following teachings, one skilled in the art will recognize that many material forms chosen from electrically conductive or insulating materials used either alone or in combination may be appropriate for material form 295.

During the injection molding operation mold component 290 is moved laterally according to directional arrows 292 to clamp the mold shut and also to retain a portion of material form 295 positioned within mold cavity 288. When the mold 286/290 is closed, fluid resin material within cylinder 284 is forced under pressure (injected) into mold cavity 288 and consequently into desired contact with material form 295. Following a period of cooling, the mold components 286 and 290 are separated freeing the molding, now attached to the material form 295. Material form 295 is then indexed or moved vertically in the direction shown in FIG. 83. This movement of course brings fresh material form 295 into position to be employed during the next molding cycle.

FIG. 86 is a sectional view of one embodiment taken substantially from the perspective of lines 86-86 of FIGS. 83 and 86A when using the material form embodiment 296. The embodiment of FIG. 86 is also shown in top plan view in FIG. 86A. The embodiments of FIGS. 86 and 86A show an article generally depicted as 307. In FIGS. 86 and 86A it is seen that structures 304 have been formed by the injection molding process. While shown in simplified rectangular form it is understood by one skilled in the art that injection molding can provide highly detailed three-dimensional structures. In FIGS. 86 and 86A structures 304 are shown to slightly overlap electrically conductive material 299. In this particular embodiment structures 304 comprise electroplateable material. However, it will be appreciated that in other embodiments the structure produced by the injection molding operation may not be electroplateable. For example, it may form an insulating portion of a structure that is eventually exposed to an electrochemical process such as electroplating. It will also be understood that additional structure can be produced on article 307 between the injection molding operation and the electroplating operation. This additional structure can be produced by many techniques known in the art including an additional injection molding operation.

FIG. 87 is a sectional view taken substantially from the perspective of lines 87-87 of FIG. 83. The article 310 of FIG. 87 is also shown in top plan view in FIG. 87A. FIG. 87 shows additional structure produced on the FIG. 86 embodiments by the electroplating process 308 depicted in FIG. 83. In FIG. 87, it is seen that the exposed surfaces of the electroplateable material associated with structure 304 as well as electrically conductive material 299 have covered with electrodeposit 312 and the individual structures 304 now plated remain supported on insulating material 300.

In the embodiments of FIGS. 86 and 87, electrically conductive material 299 constitutes a continuous buss for conveyance of electroplating current during the continuous plating operation. FIG. 87 shows material 299 attached to the electroplated article 304. One skilled in the art will quickly recognize that this does not have to be the case. For example, as shown in FIG. 87A the electrically conductive material 299 and its associated overlapping conductive electrodeposit can be severed along line 316 to leave individual electrically isolated structures positioned on insulating material 300. This severing can be accomplished by any number of techniques well known to the art. It will also be appreciated that insulating web 300 could be a surrogate support for buss 299 and structures 304 during forming and electroplating. In this case, insulating material 300 could be separated from structures 304 and 299 following the electroplating process.

In the embodiments of FIG. 83 the article 307 with its supporting material 300 is shown to be fed continuously in-line from the injection molding operation to the electroplating process 308. This of course need not be the case. Alternately, one could collect the 307 article onto a takeup roll or other suitable means of intermittent storage.

The embodiments of FIGS. 86, 86A, 87 and 87A employed a feed material 295 as shown generally by article 296 of FIGS. 84 and 84A. Article 296 included a strip 299 of electrically conductive material as a pre-existing buss form. Another embodiment of feed form is depicted in the sectional view of FIG. 85A. In FIG. 85A it is seen that feed form 305 comprises simply an insulating web 302. FIG. 85B is a sectional view of the article following the indexed injection molding process, and is there referenced as article 315 to reflect the change accomplished by the injection molding. FIG. 85B is a view taken from a perspective similar to that of FIG. 86. A top plan view of article 315 is shown in FIG. 85C. It is seen from FIGS. 85B and 85C that structures 309, 319 and portions of strip structure 320 have been produced in repetitive fashion onto the surface of insulating material 302. These structures are electroplateable resins in this embodiment.

In FIG. 85C, the linear distance in the direction 318 moved by article 315 with each injection molding shot is represented by the letter “I”. The dashed box 317 indicates the area of the original web being treated during each injection molding shot. The indexing is such that each injection molding shot produces a portion of strip 320, which extends to join to a terminal end of the portion of strip 320 formed by the previous shot. In this way, a continuous electrical path is produced between the repetitive structures 309, 319 also produced with each shot. One recognizes that strip 320 can serve as an electrical buss during subsequent electrochemical processing such as electroplating.

In light of the advantages of DER materials discussed above, one will recognize the unique suitability of DER materials for the indexed injection molding teachings herein.

FIGS. 88 through 91A show yet another embodiment of the combination injection molding/electroplating process as generally depicted in FIG. 83. FIG. 88 is a top plan view of a material form generally designated there as article 330. Article 330, comprises insulating support web 300c upon which electrically conductive strip 299c is positioned in a fashion similar to that shown in FIG. 84. Items 325 which may comprise electrical devices are seen as being positioned in a repetitive fashion on insulating support web 300c. Emanating from items 325 are electrical leads 327.

As is known in the art, an electrical lead or circuit of a device is a conductor which facilitates or through which an electrical connection is made to another electrical device or circuit. An electrical lead can take many forms. The simplest is a metallic projection in the form of a dot or extending wire. Often, electrical leads are produced to supply an extended surface such as a pad that facilitates electrical joining to other electrical devices, elements, or components. In this case, the electrical leads can comprise materials such as electrically conductive resins or metal filled paints or inks in addition to the essentially pure metallic material as is known in the art. For purposes of this specification and claims an electrical lead includes extended surfaces such as a pad designed to facilitate electrical joining.

FIG. 89 is a top plan view of the FIG. 88 article following an indexed injection molding process as depicted in FIG. 83. In FIG. 89, additional structure 334 has been applied by the injection molding process. Original article 330 is now designated as 332 in FIG. 89 to reflect this additional step. The details of the 334 structure are expanded in the sectional views of FIGS. 90 and 91. In FIG. 90, a sectional view taken substantially from the perspective of lines 90-90 of FIG. 89, it is seen that the 334 structure includes material extending between and slightly overlapping electrical lead 327 and strip 299c. Electrical lead 327 has remaining exposed surface 340 and strip 299c has remaining exposed surface 344. In this embodiment, material forming structure 334 is electroplateable and has exposed surface 342.

Reference to FIG. 91 further describes the 332 article. FIG. 91 is a sectional view taken substantially from the perspective of lines 91-91 of FIG. 89. In FIG. 91 it is seen that structure 334 also extends laterally over the surface of article 332. This lateral extension could form for example a pattern for an antenna or other such electrically conductive traces.

FIGS. 90A and 91A show the FIGS. 90 and 91 structure plus additional structure imparted an the electroplating process such as that depicted in FIG. 83. It is seen in FIGS. 90A and 91A that conductive electrodeposit 336 extends over the originally exposed surfaces of electrical lead 327, structure 334 and strip 299c. Thus a robust and secure connection is achieved between electrical lead 327 and structure 334. One will recognize that a slitting operation as generally depicted in FIG. 87A will result in separate items 325 electrically joined to residual structure 334 now electroplated having good ohmic joining.

FIGS. 92 through 117A are used to illustrate various embodiments of the electrical joining through electrodeposition introduced in this specification in the embodiments of FIGS. 88 through 91A. One will recognize that in most cases this electrical joining is intended to be permanent for at least a period of time following the plating process.

FIGS. 92 through 94 illustrates another embodiment of the current invention. The top plan view of FIG. 92 shows structure 370 separated from structure 371. Electroplateable material 374 bridges the separation between structures 370 and 371. Structures 370 and 371 have surfaces 372 and 373 respectively. Surfaces 372 and 373 are electrically conductive. In this embodiment surfaces 372 and 373 comprise electroplateable material.

FIG. 93 is a sectional view taken substantially from the perspective of lines 93-93 of FIG. 92. FIG. 93 shows structures 370 and 371 having top surfaces 372 and 373 respectively. Electroplateable material 374 is shown to partially overlap top surfaces 372 and 373.

FIG. 94 shows the result of an electroplating process step employing the structure shown in FIG. 93. In FIG. 94 it is seen that electrodeposit 375 has coated the originally exposed surface of electroplateable bridge material 374 and extends over the originally exposed surfaces 372 and 373. Thus a robust, low-resistance electrical connection is achieved between structures 370 and 371. It is understood that while FIG. 94 shows electrodeposit 375 coating the entirety of the originally exposed surface of electroplateable bridge material 374, it may suffice to have electrodeposit 375 coat only a portion of bridge material 374.

In the embodiments illustrated in FIGS. 92 through 94 exposed surfaces 372 and 373 comprise electroplateable material. Thus electrodeposit 375 extended over these exposed surfaces of structures 370 and 371. It is noted however that should surfaces 372 and/or 373 comprise material which would not be considered electroplateable in a conventional sense for example aluminum or other material which may not be compatible with standard electroplating baths the entire surface 372 and/or 373 could be coated with electroplateable bridge material 374. Electroplateable bridge material 374 being electrically conductive and electroplateable would cover with electrodeposit as expected. In this case however electrical joining between the electrodeposit and structures 370 and/or 371 would be achieved through a thickness of electroplateable bridge material 374.

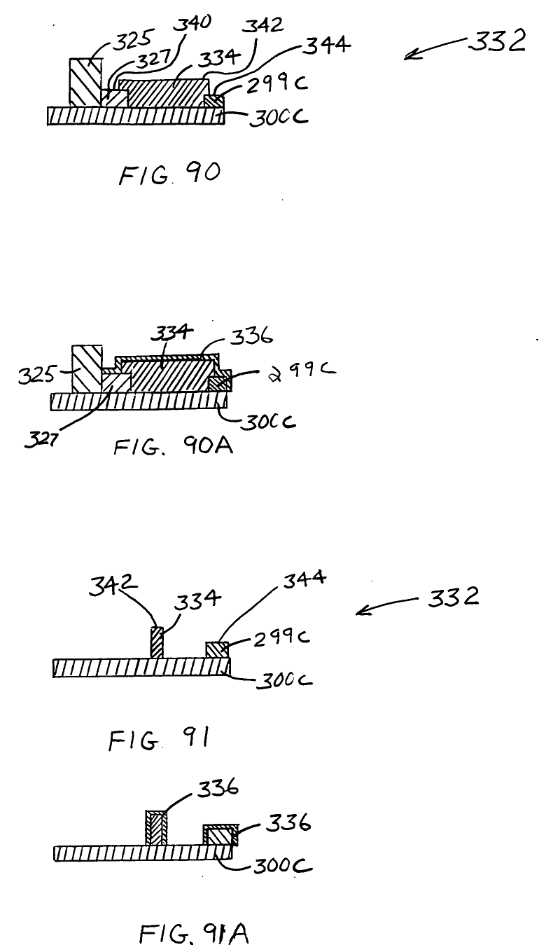

FIGS. 95 through 97 show one embodiment of an electrodeposited connection technique. In FIG. 95 there is shown item 355 which may comprise an electrical device with electrical lead 357 supported on insulating substrate 360. FIG. 95 also shows a portion of additional structure 362. In this embodiment structure 362 comprises an electroplateable material.

FIG. 96 shows the embodiment of FIG. 95 plus additional structure 364 extending between and slightly overlapping electrical lead 357 and structure 362. Lead 357 and structure 362 have remaining exposed surfaces 358 and 359 respectively. Additional structure 364 comprises an electroplateable material which can be applied by any number of processes well known in the art such as injection molding, printing, extrusion, etc. It is understood that structures 362, 364, and lead 357 may all comprise different materials.

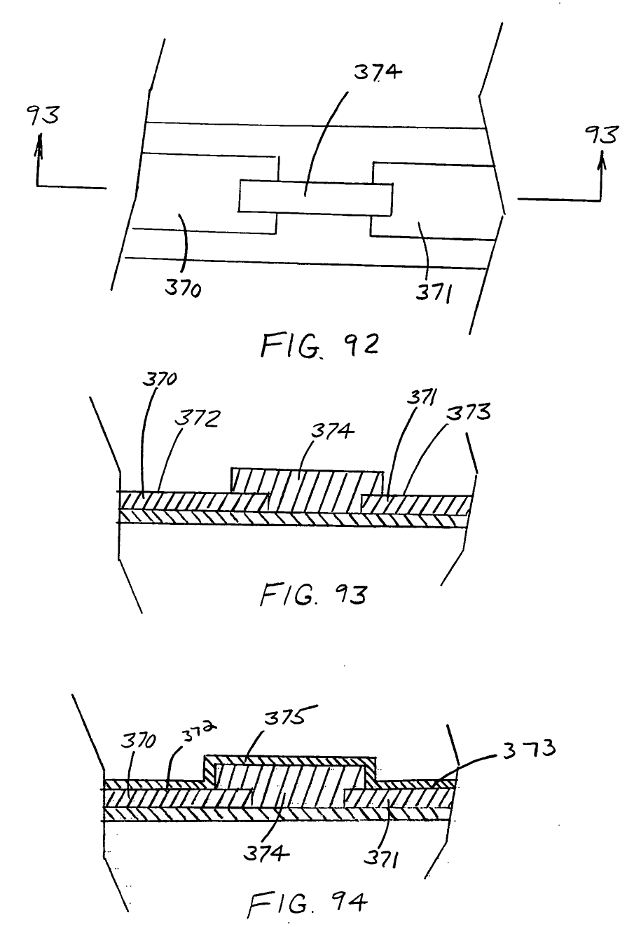

FIG. 97 shows a sectional view of the FIG. 96 structure following electrodeposition of conductive electrodeposit 366 covering the originally exposed surfaces of electrical lead 357 and structures 362 and 364. Thus, a continuous low resistance connection is achieved through the conductive electrodeposit 366 from electrical lead 357 to structure 362.

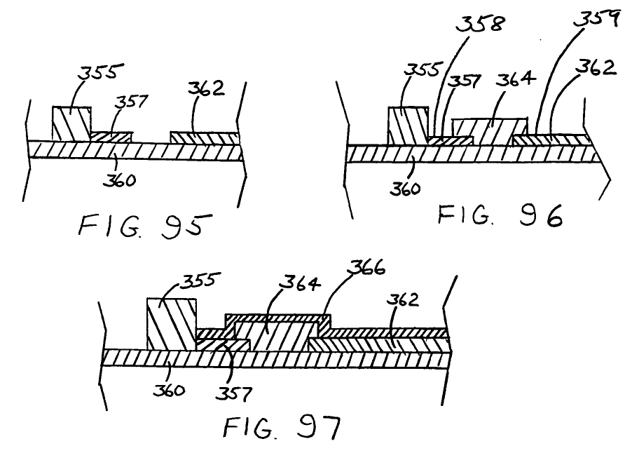

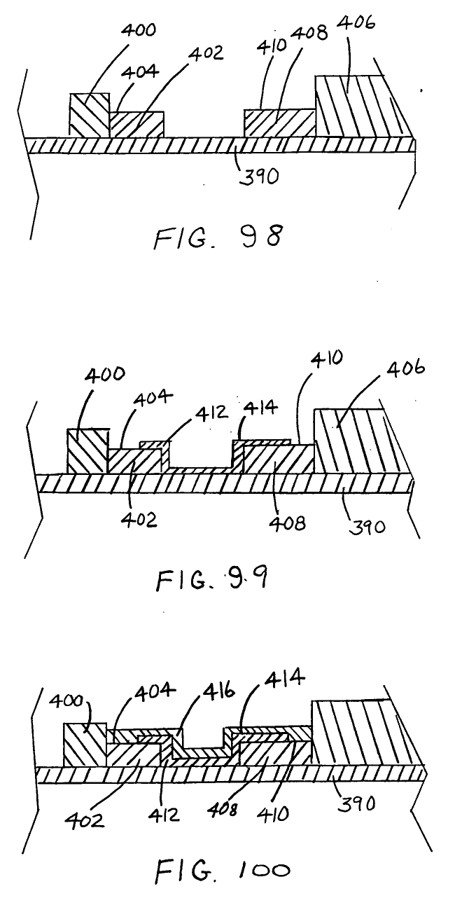

FIGS. 98 through 100 show an additional application employing electrodeposited connections. FIG. 98 is a sectional view showing the starting structure of another embodiment. In FIG. 98 item 400 which may comprise an electrical device has electrical lead 402 supported on insulating web 390. In addition item 406 and electrical lead 408 is supported on insulating surface 390. Electrical leads 402 and 408 have exposed surfaces 404 and 410 respectively.

FIG. 99 is a sectional view similar to FIG. 98 following the process step of applying electroplateable material 412 extending between and overlapping electrical leads 402 and 408. Electroplateable material 412 has exposed surface 414. It is seen in FIG. 99 that electroplateable material 412 can be relatively thin such as may result from printing an electroplateable ink.

FIG. 100 shows the result of exposing the FIG. 99 structure to an electroplating process. In FIG. 100 it is seen that conductive electrodeposit 416 covers originally exposed surfaces 404, 414, and 410 thereby establishing electrical communication between electrical lead 402 and electrical lead 408. One realizes that mechanical or chemical surface modifications such as etching or cleaning may be advantageous to promote adhesion of electrodeposit 416 to the exposed surface of lead 402. In addition, lead 402 may comprise structure designed to increase surface area or to supply interlocking contact with the electrodeposit.

In the embodiments of FIGS. 98 through 100 it is seen that electroplateable material 412 is deposited to cover only a portion of surfaces 404 and 410. This partial overlap while sometimes beneficial is not always necessary or indeed advantageous. FIGS. 101 and 102 show an embodiment wherein exposed surfaces 404a and 410a of electrical leads 402a and 408a respectively are completely covered with electroplateable material 412a. FIG. 102 shows the result of an electrodeposition process using the embodiment of FIG. 101. In FIG. 102 it seen that conductive electrodeposit 416 completely covers the exposed surface 414a of electroplateable material 412a. This technique of completely coating the original exposed surface of electrical leads 402a and/or 408a can be advantageous in some circumstances. For example, if electrical leads 402a or 408a were to be relatively small it may be difficult to selectively coat a portion of the electrical lead with electroplateable material 412a. Another example would be if the electrical leads are incompatible with the electroplating process. An aluminum surface for example would generally be non-receptive to a conventional direct electrodeposition process. Other surfaces such as stainless steel may result in insufficient adhesion of the conductive electrodeposit. In these cases electroplateable material 412a can act as a protective or intermediate plateable adhesive. As stated above, adhesion to the lead material can possibly be enhanced by mechanical or chemical surface modifications. In addition, the thickness of the electroplateable material 412a as suggested in FIG. 101 can be minimized. Thus the ohmic loss through the material can be minimized.

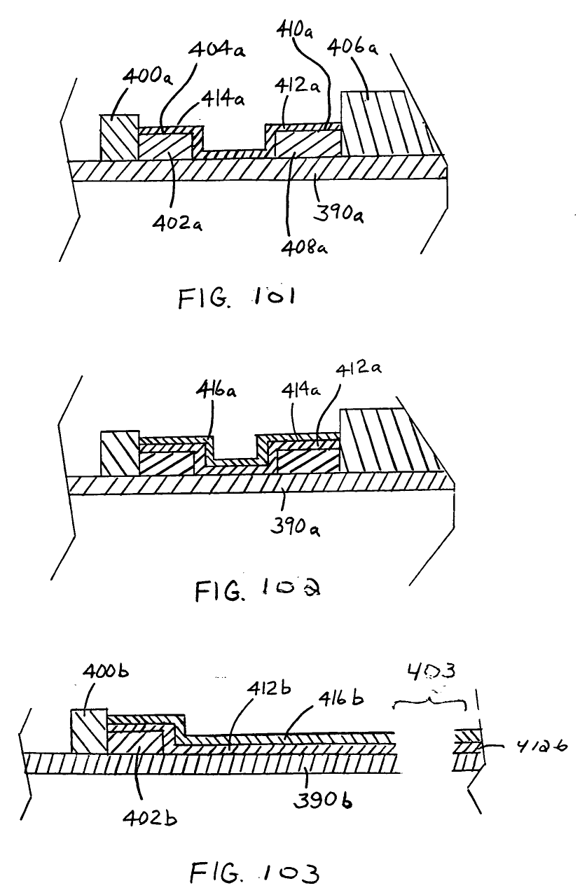

FIG. 103 shows a sectional view of a different embodiment. In FIG. 103, item 400b has electrical lead 402b supported on substrate 390b. In the FIG. 103 embodiment electroplateable material 412b extends and coats the entire surface of lead 402b as was the case in FIGS. 101 and 102 but further extends to form a pattern of an electrical trace generally indicted by 403. It will be understood that the electrical trace 403 could comprise electroplateable materials other than that of 412b. It will also be understood that while in this embodiment electroplateable material 412b coats the entire surface of 402b this does not need to be the case as shown above. It will also be understood that electroplateable material contacting lead 402b and that forming trace 403 can be different and/or applied by different techniques at different times. Conductive electrodeposit 416b not only forms an ohmic connection to electrical lead 402b but also participates in the electrical demands of electrical trace 403. The exact nature of electrical trace 403 can comprise any number of forms as suggested by the bracket shown in the FIG. 103 description. For example, electrical trace 403 could form an antenna pattern. One will understand that it may be particularly advantageous to electroplate electrical trace 403 at essentially the same time as material 412b covering lead 402b.

FIG. 104 shows a sectional view similar to FIG. 103 but of a different embodiment. In the FIG. 104 embodiment electroplateable material 412c does not extend to overlap lead 402c. It is understood that electroplateable material 412c could comprise an electrodeposit itself Rather additional material 401 is positioned to overlap 402c and 412c. Material 401 is shown to be different than that comprising 412c. Material 401 is electrically conductive. Electrodeposit 416c is seen to extend from material 412c over the surface of material 401 and onto the surface of lead 402c. Material 401 may be advantageously chosen for adhesive and conductivity characteristics.

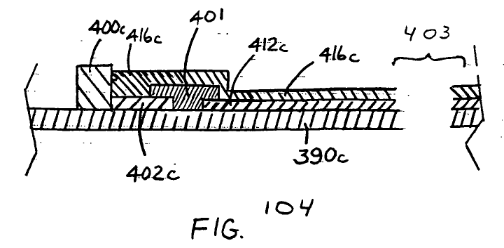

FIGS. 105 through 106 show yet another embodiment of achieving electrical connection via electrodeposition. FIG. 105 is a side view of an additional embodiment. In FIG. 105 item 400d has electrical lead 402d in contact with electroplateable material 412d. Lead 402d has exposed surface 404d. Item 400d, electrical lead 402d and electroplateable material 412d are supported by substrate 390d.

The sectional view of FIG. 106 taken substantially from the perspective of lines 106-106 of FIG. 105 shows electrical lead 402d embedded in electroplateable material 412d.

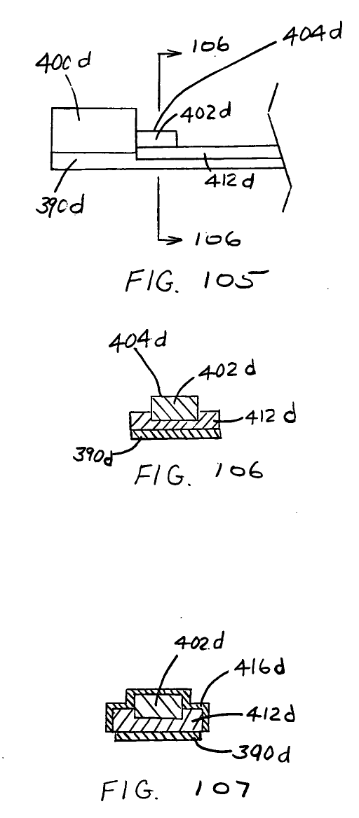

FIG. 107 is a sectional view showing the results of exposing the FIG. 106 structure to an electroplating process. In FIG. 107 it is seen that conductive electrodeposit 416d coats the entire originally exposed surfaces of electrical lead 402d and electroplateable material 412d. A robust, low resistance contact between electrical lead 402d and electroplateable material 412d is thus achieved.

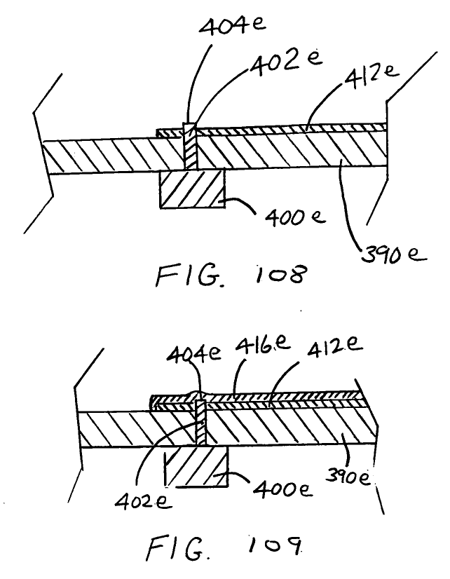

FIG. 108 along with FIG. 109 teaches another embodiment of the electrodeposit electrical connections of the current invention. In FIG. 108 a sectional view depicts an item 400d with electrical lead 402e. Lead 402e has exposed surface 404e. Insulating material 390e supports electroplateable material 412e. As shown, lead 402e penetrates through materials 390e and 412e.

FIG. 109 shows the result of exposing the FIG. 108 structure to an electroplating process. The result is electrodeposit 416e coating the electroplateable material 412e and the originally exposed surface 404e of lead 402e. Thus a robust and low-resistance connection is achieved between lead 402e and electrodeposit 416e.

FIGS. 110 through 113 show another embodiment of the current invention. FIG. 110 shows a top plan view of an article generally designated as 418. FIG. 111 shows a structural view taken substantially from the perspective of lines 111-111 of FIG. 110. Taken in conjunction FIGS. 110 and 111 show a number of structural features as follows. Insulating support film or web 419 supports an insulating device receptacle structure 407. Also shown as supported by web 419 are structures 425. Structures 425 are shown in FIGS. 110 and 111 to be originally distinct and separate from receptacle structure 407. Receptacle structure 407 consists of depression 417 into which device 415 is placed. Vias 421 extend from top surface 405 of receptacle structure 407 to a locale below top surface 405 as shown. Encapsulant material 409 covers the upper surface of device 415 and extends over a portion of top surface 405. Electrically conductive material 422 extends over the top surface of receptacle structure 407 forming a pad and further extends into vias to the contact surfaces 420 of device 415. It is understood that the electrically conductive material associated with the vias does not necessarily have to be the same as that forming the pad. Thus electrically conductive material 422 forms an extended surface lead pad for device 415. Electrically conductive material 422 may comprise and electrically conductive polymer. In some applications 422 may comprise a DER.

Structures 425 comprise conductive material but are electrically disconnected from material 422 and device 415 as shown in FIGS. 110 and 111. The exposed surfaces of structures 425 are electroplateable and may comprise a DER.

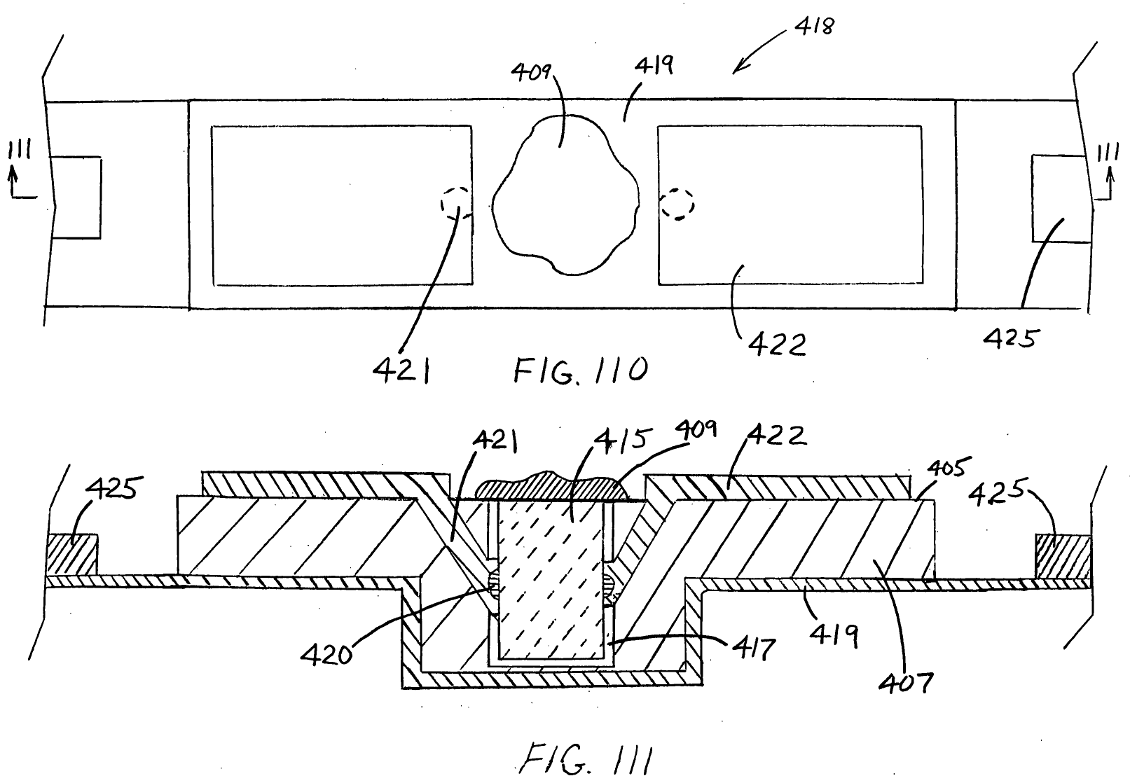

FIG. 112 is a sectional view similar to that of FIG. 111 but showing additional structure resulting from a process step. In FIG. 112 it is seen that material 423 has been deposited to overlap a portion of material 422 and also structure 425. Material 423 forms an exposed surface which is electroplateable. Thus material 423 forms a bridge between the exposed surface of material 422 and the exposed surface of structure 425.

FIG. 113 is a sectional view showing the result of exposing the FIG. 112 embodiment to an electroplating step. It is seen that the electroplating step has produced electrodeposit 424 extending over the originally exposed surfaces of material 422, bridge material 423, and structures 425. Thus a robust, low-resistance electrical connection is achieved between material 422 and structures 425 and consequently between device contacts 420 and structures 425.

As shown in FIG. 113, electrodeposit 424 extends to close proximity to via 421. This close proximity between the highly conductive electrodeposit and the via may be important when considering material selection for material 422.

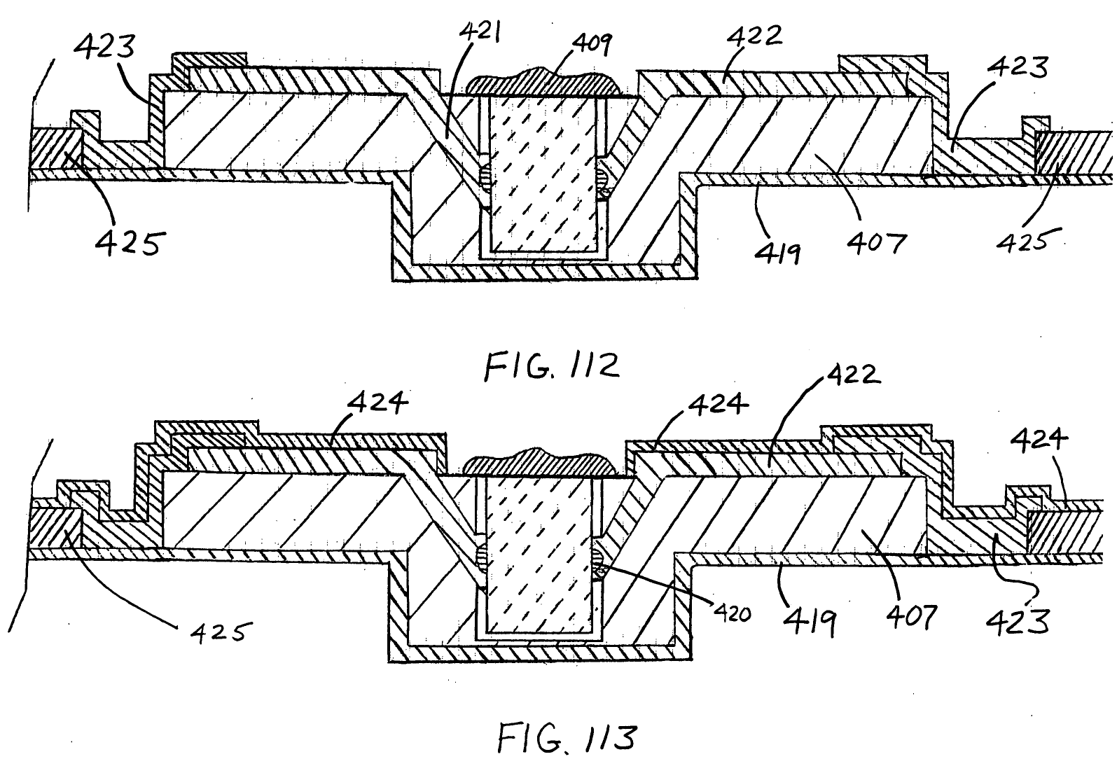

FIGS. 114 through 117 show yet another embodiment of the current invention. FIG. 114 shows an article generally designated as 490. FIG. 114A is a sectional view taken substantially from the perspective of lines 114A-114A of FIG. 114. Taken in conjunction FIGS. 114 and 114A show that Article 490 comprises insulating web material 492 upon which are positioned strips of electroplateable material 494. Article 490 has length L-114 and width W-114 and thickness Z-114. It is normal that length L-114 is considerably greater than width W-114 such that continuous processing in the L-114 direction can be contemplated. Z-114 is relatively small as is normal for web processing but is sufficiently thick to allow the forming operations contemplated by the following FIGS. 115 and 115A.

FIG. 115 shows the result of a forming step performed on the FIG. 114 structure. FIG. 115 taken in conjunction with the sectional view of FIG. 115A shows that depressions have been formed in the original article 490 to form the article now labeled as 496 in FIG. 115. FIG. 115A is a slightly magnified view showing the details of the depressions formed. It is seen in FIG. 115A that depressions 498 have a generally trapezoidal cross section. Material 492 forms the base of the trapezoidal depression and has a top surface 493. Electroplateable material 494 extends up to opposite walls of the trapezoidal depression and further extends to an area remaining unformed.

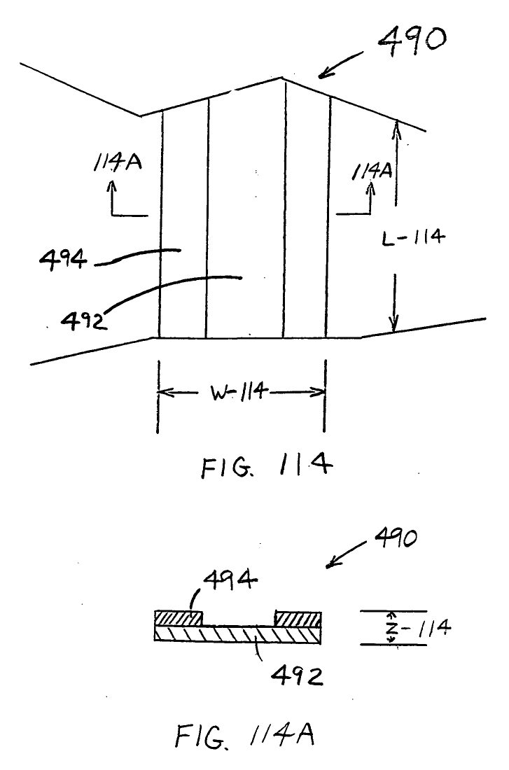

FIG. 116 shows the result of exposing the article 496 to an electroplating process. The electroplating process accomplishes deposition of electrodeposit 500 over the exposed surfaces of electroplateable material 494. However, as indicated by FIG. 116 the portion of the base of the trapezoidal depression formed by material 492 remains insulating.

FIG. 117 shows an insertion of a device into the receptacle formed by the electroplated depression shown in FIG. 116. Device 502 has a complimentary trapezoidal form such that it conforms to the electroplated depression in an advantageous manner. The trapezoidal structure of FIG. 117 is but one of a myriad of forms suitable for such complimentary registration. It is seen in FIG. 117 that good contact to device 502 can be achieved along the tapered side walls of the close fitting device and the electrodeposit 500 extension to the unformed surface areas forms a convenient extended lead surface. It is understood that separation of the depressions 498 now filled with devices 502 would give individual devices 502 having improved handling and electrical joining characteristics. It is further understood that a hole in that portion of insulating material 492 forming the base of depression 498 may facilitate the assembly of device 502 into depression 498.

It is understood that in the prior embodiments demonstrating electrodeposited connections the conductive electrodeposit extends to very close proximity to the items shown. In some cases the electrodeposit can thus contribute to the conductivity of the resulting composite lead structure. This may be allow the leads to be fabricated from a wider variety of material choices such as materials having reduced conductivity.

The electroplated connections taught herein offer a number of advantages compared to conventional electrical joining techniques. Many conventional electrical joining techniques involve soldering or the use of certain conductive adhesives which may require high temperature processing which limits material choices. Mechanical joining such as pressure contacts often deteriorate over time due to corrosion, vibration etc. Contacts using mechanical pressure or conductive adhesives often are characterized by a distinct contact resistance. Conductive adhesives moreover may suffer from less than optimal conductivity.

The current teaching provides methods and structures to achieve highly conductive and robust electrical connections. The unique connections offer solutions to many of the previously mentioned problems associated with the current art. It has also been shown how unique and novel electrical connections can be readily accomplished using continuous processing. However, while eminently suitable for continuous processing it is understood that the electrical connections techniques taught in the current invention can also be used in a batch process.

In light of the advantages of DER materials discussed above, one will recognize the unique suitability of DER materials for the electrical connections taught herein.

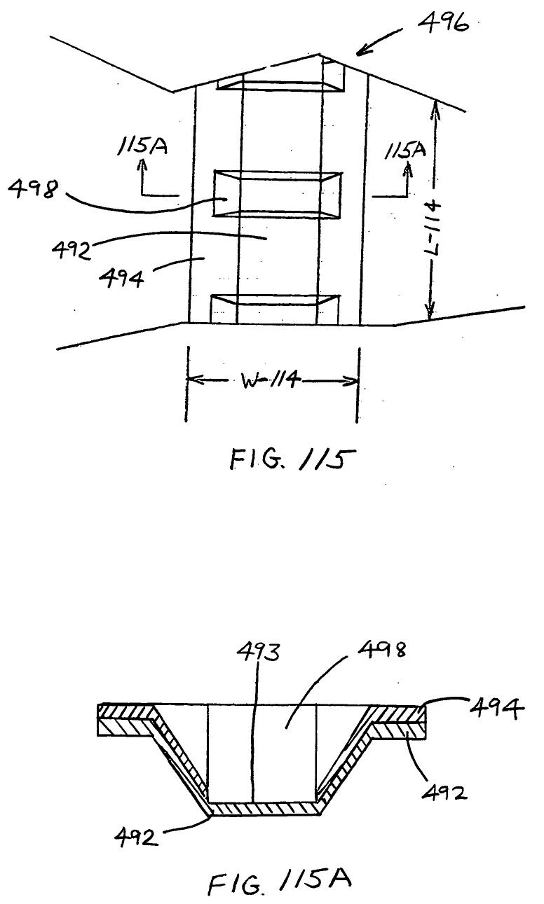

FIGS. 118 through 124 show an additional process and structure by which a specific electrical component such as a resistor can be fabricated in a low-cost and continuous manner using the teachings of the current invention. FIG. 118 is a top plan view of a starting structure for this process and structure. FIG. 119 is a sectional view taken substantially from the perspective of lines 119-119 of FIG. 118 further clarifying the article identified generally as 426 in FIG. 118. It is seen from FIGS. 118 and 119 that electroplateable materials 427 and 429 are positioned as strips extending in the length direction 428 of article 426. In this embodiment strips 427 and 429 comprise electroplateable materials supported on insulating support web 431. However, this does not need to be the case and in some instances strips 427 and 429 may simply comprise an electrically conductive material.

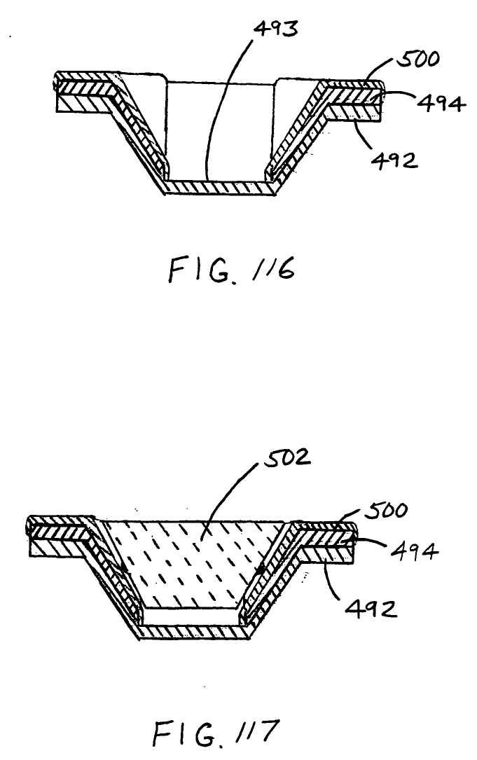

FIGS. 120 and 121 are embodiments from a similar perspective as FIGS. 118 and 119 respectively after an additional process step. The process step to produce the article of FIGS. 120 and 121 includes depositing strips of electrically conductive material 433 connecting electroplateable material 427 and 429.

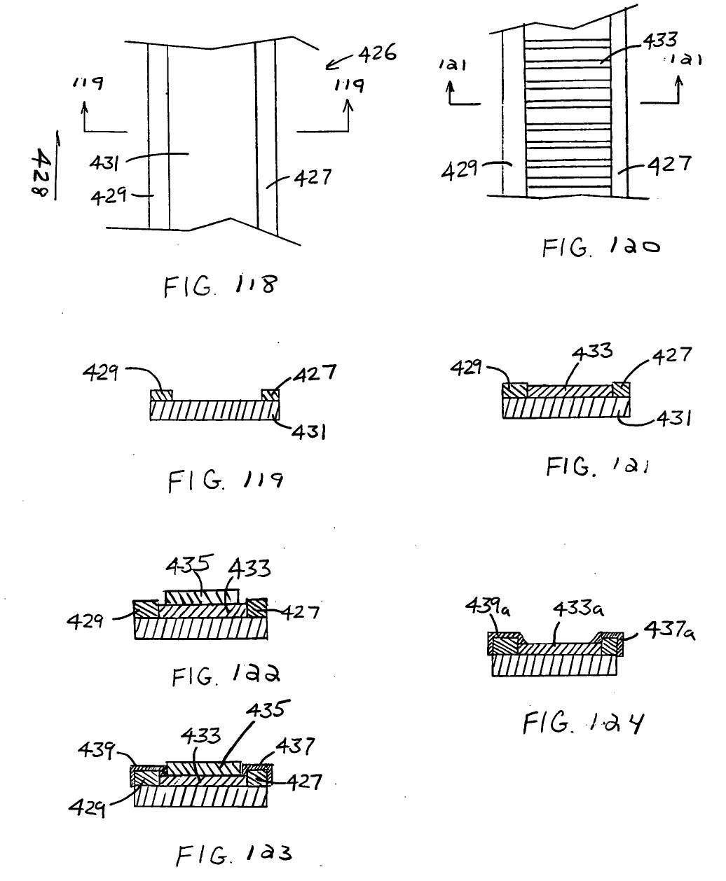

The sectional view of FIG. 122 shows the result of an additional process step employing the FIG. 121 structure. In FIG. 122 it is seen that insulating material 435 has been applied to mask a majority of the originally exposed surface of strips 433.

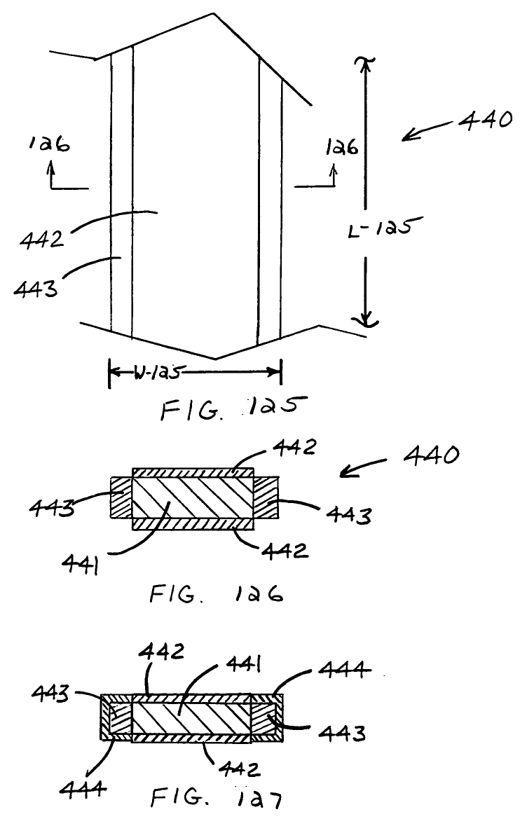

FIG. 123 shows the result of exposing the structure of FIG. 122 to an electroplating process such as that depicted in FIG. 22. FIG. 123 shows that electrodeposit 437 and 439 coats the originally exposed surfaces of stripes 427 and 429 as well as the residual surfaces of electrically conductive strips 433 remaining exposed after coating with insulating material 435. Since electrically conductive material 433 can be formulated to have electrical resistivities characteristic of resistive materials, the resulting structure shown in FIG. 123 can be designed as a resistor. In addition it is known that the resistivity of certain carbon loaded materials increases dramatically at certain defined temperatures. Thus the structures shown in FIGS. 123 and 124 could also be contemplated for use as electrical fuses or temperatures switches.

An alternate path, to continuously achieve such as resistive structure is shown in FIG. 124. In FIG. 124 strips 433a remain exposed to the electroplating bath. However, strips 433a are formulated to be resistive in electrical characteristics and do not cover with conductive electrodeposit rapidly since they are absent any growth rate accelerator characteristic of a directly electroplateable resin. Thus, while the conductive electrodeposit as indicated by 437a and 439a covers strips 427 and 429 the electrodeposit does not grow laterally to a significant extent over the surface of 433a. This thereby results in a structure generally equivalent in electrical performance to that shown in FIG. 129. It will be understood that a preferred material for use as electroplateable materials 427 and 429 would be DER's.

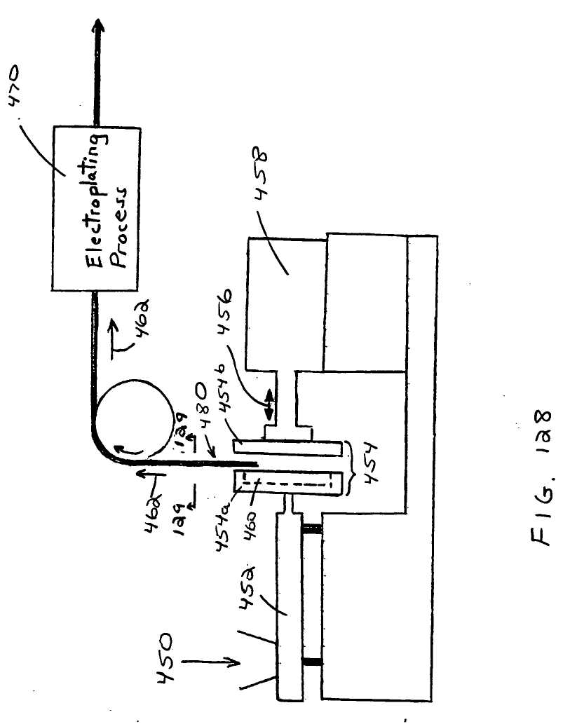

FIG. 125 through 127 illustrate yet another embodiment of unique resistive structure achieved through the continuous electroplating of the current invention. FIGS. 125 and 126 define the structural characteristics of article 440. Article 440 comprises a web having length L-125 and width W-125. As in prior embodiments L-125 is often envisioned to be greater than W-125 such that article 440 can be processed in a continuous manner.

FIG. 126 further illustrates the structural details of article 440. It is seen in FIG. 126 that article 440 comprises a laminate structure of electrically conductive material 441 overlaid by insulating material 442. Appended to the sides of material 441 is electroplateable material 443.

FIG. 127 shows the result of exposing the structure presented in FIGS. 125 and 126 to an electroplating process such as that depicted in FIG. 22. It is seen in FIG. 127 that electrodeposit 444 now coats the originally exposed surfaces of electroplateable material 443. Electrically conductive material 441 remains unplated because of its coating by insulating material 442. While shown as separate materials it is understood that electrically conductive material 441 and electroplateable material 443 may be the same.

It will be appreciated regarding the embodiment of FIG. 127 that electrically conductive material 441 can be formulated to have electrical resistivities over a very wide range. Electrodeposits 444 offers a convenient conductive structure separated by resistive structure. One skilled in the art will recognize suitable applications for such a structure such as the production of resistive heating tape. For example, the electrical resistivity of many filled polymers is know to increase dramatically at certain defined temperatures. Thus material 441 can be chosen to produce a self regulating heating device.

Because of the unique metal placement possibilities associated with DER materials it is recognized that many known or useful electrical articles in addition to resistors could be manufactured using the current teachings. These include but are not limited to, many electrical circuits, electrical traces, circuit boards, antennas, capacitors, induction heaters, connectors, switches, inductors, batteries, fuel cells, coils, signal lines, power lines, radiation reflectors, coolers, diodes, transistors, piezoelectric elements, photovoltaic cells, emi shields, biosensors and sensors.

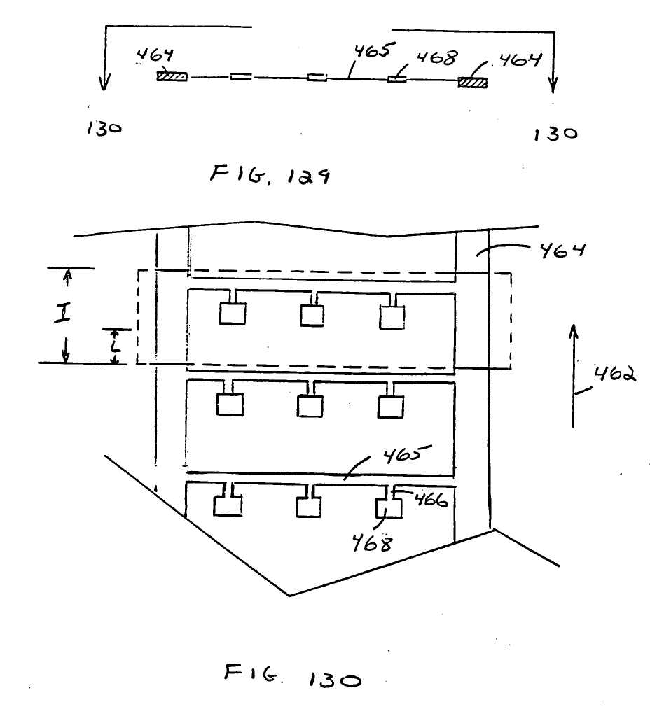

In FIG. 128 there is shown yet another embodiment of the continuous electroplating of the invention. As discussed previously, the injection molding process is well known in the art. In FIG. 128 an electrically conductive material formulated as an injection moldable composition is fed to plasticating chamber 452 as indicated by directional arrow 450. The electrically conductive material is plasticated or made molten in chamber 452 in preparation for eventual injection into mold 454. Mold 454 comprises stationary portion 454a having cavity 460 shown in phantom. Movable mold component 454b reciprocates in a generally horizontal direction as indicated by directional arrow 456. This motion is accomplished by any number of numerous mechanisms well known in the art designated by 458.

As is understood by those familiar with the art, when mold components 454a and 454b are moved into a clamped position contacting each other molten conductive material within chamber 452 is forced under pressure (injected) into the cavity defined by 460. Upon mold opening to separate mold components 454a and 454a, the mold article comprising electrically conductive material generally designated in the drawing by structure 480 is moved a defined distance in the direction of arrows 462. This movement causes a portion of the molded structure to be removed from the mold leaving a residual portion of the molded structure within the footprint of the mold. This residual portion remaining within the footprint of the mold is positioned to be contacted and adhered to molten conductive material associated with the next injection cycle. Thus a continuous integral structure comprising conductive material is formed by the indexed molding of the conductive material.

A typical embodiment of the structure produced by such a process is shown in the sectional view of FIG. 129. FIG. 129 is a sectional view taken from the perspective of lines 129-129 of FIG. 128 at a selected point along the length of the 480 structure produced by the injection molding operation.

FIG. 130 is a top plan view of the structure as seen from the perspective of lines 130-130 of FIG. 129. In conjunction FIGS. 129 and 130 show the structure of one embodiment emanating from the injection molding operation in FIG. 128. In FIGS. 129 and 130 it is shown that conductive material forms continuous bands 464 extending in the direction 462. Positioned between and integral with bands 464 are arms 465 also comprising conductive material. Joined to arms 465 at connections 466 are items 468. Items 468 comprise conductive material. The index length associated with each injection cycle of the process depicted in FIG. 108 is indicated by the length “I” in FIG. 110. Typically and for purposes of illustration a residual length portion of bands 464 indicated by “L” in FIG. 110 remains in the mold to be joined to the material forming another portion band 464 of the subsequent injection cycle of conductive material. In this way, bands 464 form a continuous support and indexing structure for injected arms 465 and items 468.

The conductive structural arrangement depicted in FIGS. 129 and 130 may be suitable for electrochemical processing. For example it may be desired to electroplate the structure as suggested in FIG. 128. In this case one recognizes that DER's may be eminently suitable as a material choice for the electrically conductive material.

In the electroplating process 470 of FIG. 128 the exposed surfaces of bands 464, arms 465 and items 468 will be coated with conductive electrodeposit. One observes that bands 464 serve as an inexpensive continuous buss structure to convey the electrical current necessary to electroplate the positioned items 468. Many of the advantages of DER in its use as a buss are realized.

One can recognize a number of unique applications for the teachings taught in conjunction with FIGS. 128 through 130. For example, in many cases items 468 as depicted in FIGS. 129 and 130 could be very small articles, articles having complicated geometries, or articles which are not susceptible to convenient racking. An example may be a shielded connector housing. The array shown in FIGS. 129 and 130 incorporates a convenient positioning rack and current buss. One will understand that items 468 may be separated from arms 465 and bands 464 following electroplating. However, in some instances it may be desired to retain portions or even all of arms 465 and bands 464.

With regard to small items 468 it may be beneficial via conventional practice to barrel plate articles of such size. However, with plastic materials barrel plating is often difficult or impossible. The complications associated with conventional processes for plating on plastics often make barrel plating of plastics unfeasible. With regard to DER's the specific gravity of the material tends to minimize contact pressures between parts. This combined with the relatively low conductivity of many DER's makes initial coverage of DER's in a conventional barrel plating process very difficult. However, articles produced by the process depicted in FIG. 128 have now been conveniently coated with the highly conductive initial electrodeposit. Therefore following removal from arms 465 and bands 464 they could conveniently subjected to additional barrel plating.

### EXAMPLE

The following solid ingredients were weighed out:
1. 33 grams of Kraton (Kraton 1450—Kraton Polymers)
2. 16.5 grams of carbon black (Vulcan XC-72—Cabot Corporation)
3. 0.5 grams of elemental sulfur

These solid ingredients were mixed and dissolved in approximately 10 ounces of a xylene solvent. This produced a fluid ink/coating formulation which, after drying, consisted of:
1. Kraton—66%
2. Carbon Black—33%
3. Sulfur—1%

A length of PET film was coated with this ink/coating solution in the form of a 1 inch wide buss stripe pattern. The stripe pattern was allowed to dry and then was immersed as a cathode in a standard Watts nickel plating bath similar to that depicted in FIG. 22C. The PET film was pulled through the bath at a rate of approximately 3 inches per minute. The stripe pattern covered quickly with nickel electrodeposit. At an applied contact potential of 3 volts, the electrodeposit growth front maintained its position approximately 6 inches upstream from the emergence point of the film from the plating bath.

Although the present invention has been described in conjunction with preferred embodiments, it is to be understood that modifications, alternatives and equivalents may be included without departing from the spirit and scope of the invention, as those skilled in the art will readily understand. Such modifications, alternatives and equivalents are considered to be within the purview and scope of the invention and following claims.

1. An electrical connection between two electrically conductive surfaces, said connection comprising an electrically conductive resin extending between and contacting both said surfaces, and an electrodeposit coating at least a portion of said electrically conductive resin.
